(19) United States
(12) Patent Application Publication
(10) Pub. No.: US 2026/0165354 A1
(43) Pub. Date: Jun. 18, 2026

(54) FORMULATED TASTANT COMPOSITIONS

(71) Applicant: VitaKey Inc., Washington, DC (US)

(72) Inventors: Aaron C. Anselmo, Chapel Hill, NC (US); Anant S. Balijepalli, Durham, NC (US); Emily E. Bonacquisti, Chapel Hill, NC (US); Andrew D. Christenson, Raleigh, NC (US); Joshua K. DeGennaro, Cary, NC (US); Seo Yeon Kim, Apex, NC (US); Kevin M. Luo, Raleigh, NC (US); James D. Sievert, Pittsboro, NC (US); Andrea Stamp, Brookline, MA (US); Ana Jaklenec, Lexington, MA (US); Catherine B. Reynolds, Mountain Brook, AL (US); Robert S. Langer, Newton, MA (US)

(21) Appl. No.: 19/122,359

(22) PCT Filed: Oct. 19, 2023
(86) PCT No.: PCT/US23/35551

§ 371 Date: Apr. 18, 2025

Related U.S. Application Data
(60) Provisional application No. 63/417,677, filed on Oct. 19, 2022.
(60) Provisional application No. 63/459,574, filed on Apr. 14, 2023.

(51) Int. Cl. A23L 27/00; A23L 29/00; A23L 33/125; A23L 33/17; A23L 33/20

(52) U.S. Cl. CPC A23L 27/72; A23L 27/88; A23L 29/06; A23L 33/125; A23L 33/17; A23L 33/20

(57) ABSTRACT

A formulated tastant composition includes a carrier component and a payload component, the payload component being encapsulated in the carrier component, the carrier and/or payload component including at least one taste modulator designed to confer at least one nutritional and/or health benefit.

### CROSS-REFERENCE TO RELATED APPLICATIONS

The present application claims priority to U.S. Provisional Patent Application No. 63/417,677, filed on Oct. 19, 2022; and U.S. Provisional Patent Application No. 63/459,574, filed on Apr. 14, 2023. Each of the above-referenced applications are herein incorporated by reference in their entirety.

### TECHNICAL FIELD

The present disclosure is generally related to tastant compositions (e.g., formulated tastants) and technologies (e.g., methods of preparation, use, etc.) relating thereto.

### BACKGROUND

The taste, and/or flavor of formulated foods, formulated beverages, formulated supplements, and their nutritional constituents as experienced by mammals such as humans have been studied for several decades. However, in many cases, the challenges associated with controlling the taste and/or flavor of formulated meals and/or formulated foods and/or formulated beverages and/or formulated supplements and/or their nutritional constituents remain unsolved. As such, tastants in meals and/or foods and/or beverages and/or supplements and/or their nutritional constituents have yet to realize their full potential.

### SUMMARY

A tastant compositions (e.g., formulated tastants) can be included in a supplement, a food, a supplemented (i.e., fortified) food product, a beverage, a supplemented (i.e., fortified) beverage product, a powder, or a supplemented (i.e., fortified) powder product intended to confer health benefits and/or induce pleasurable tastes and/or flavors.

Popular tastant compositions (e.g., formulated tastants) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, candy, chewing gum, fermented foods and beverages (e.g., yogurt, beer, etc.); for example, MREs, Gatorade, Truly, Ensure, PKU Sphere Liquid, etc.

In some embodiments, the present disclosure provides technologies (e.g., tastant compositions, such as formulated tastants) that provide one or more advantages for tastants (e.g., sugars, salts, carbohydrates, fats, proteins, vitamins, minerals, etc.) such as extending retention time in the oral cavity, controlling release rate, controlling adsorption and/or absorption rates, controlling spatial interactions and concentrations within the oral cavity and specific areas (e.g. tongue, throat, nasal cavities, mucosa, epithelium, taste buds, microvilli, taste bud cell, etc.), facilitating passage through selective barriers and components (e.g. enzymatic components (ATPases), physical components (zonula occludens), molecular components (chondroitin, heparan sulfates, glycosaminoglycans, proteoglycans)), controlling binding of to taste receptors, etc.

In some embodiments, the present disclosure provides technologies and/or tastant compositions (e.g., formulated tastants) that involve utilizing energy sources (e.g., macronutrients, ketones) such as proteins, carbohydrates, fats, and ketones to confer taste benefits.

In some embodiments, the present disclosure provides technologies (e.g., and/or tastant compositions, such as (e.g., formulated tastants) in which one or more tastants, which in some embodiments may be or comprise one or more amino acids, polypeptides (e.g., peptides or proteins), elements, lipids (e.g., fats, fatty acids, short-chain fatty acids, etc), saccharides (e.g., a mono- or poly-saccharide, such as sugars, a carbohydrates, etc, which may in some embodiments be or comprise dietary fiber such as prebiotic fiber), minerals (e.g., electrolytes, salts, etc), carotenoids, ketone bodies, polyphenols (e.g., flavonoids), vitamins, probiotics (bacteria, yeast, etc.), postbiotics (e.g., short-chain fatty acids, lactic acid, etc.), etc., are provided as a preparation that is compatible, for example, with an ingestible source such as a supplement, and/or a food or nutrient, and/or a beverage, consumed by a human or an animal (e.g., a chicken, a cow, a dog, etc.).

Disclosed herein, among other things, are compositions and methods for manufacture, maintenance (e.g., storage, stability, etc.), incorporation (e.g., addition to food, addition to beverages, addition to supplements, addition to products, etc.) and/or use (e.g., administration or delivery) of tastant compositions (e.g., formulated tastants).

In some cases, the tastant compositions (e.g., formulated tastants) is or comprises, for example, one or more antioxidants, macronutrients, micronutrients, polyphenols, fatty acids, ketones, minerals, electrolytes, prebiotics, probiotics, vitamins, or combinations thereof.

In some embodiments, provided tastant compositions (e.g., formulated tastants) are characterized by one or more of the following advantages: (i) improved absorption and/or adsorption of payloads, (ii) improved shelf-life and resistance to degradation at decreased temperatures (e.g., −80° C., −20° C., and/or 4° C.), elevated temperatures (e.g., 22° C., 25° C., 30° C., 35° C., and/or 40° C.), in food and/or food products, in beverages and/or beverage products, in supplements, in dry powders, in the presence of high relative humidity (e.g., up to 100%) or moisture, or a combination thereof; (iii) prolonged residence time or transit time in the mouth and proximal areas (nasal cavity, esophagus, etc.) and their sub-components (mucosa, epithelium, taste buds, cells, etc.), (iv) controlled release or sustained release of payload components in the mouth and proximal areas (nasal cavity, esophagus, etc.) and their sub-components (mucosa, epithelium, taste buds, cells, etc.), (v) controlled spatial distribution of payloads in the mouth and proximal areas (nasal cavity, esophagus, etc.) and their sub-components (mucosa, epithelium, taste buds, cells, etc.), (vi) controlled concentration of payloads in the mouth and proximal areas (nasal cavity, esophagus, etc.) and their sub-components (mucosa, epithelium, taste buds, cells, etc.), (vii) improved shelf-life in food or beverage matrices (e.g., protein bars, dry powders, milk powders, whey powders, yogurt, drinkable yogurt, candy, chewing gum, water, etc.); (viii) improved compatibility with other components of nutraceutical products and/or compositions that include them (e.g., supplements, foods, drinks, or other edible materials), (ix) stability of particles and payload in an aqueous liquid against heat, acid, protons, salt, light, water, oxidation, and/or elevated temperatures; (x) improved payload resistance to losses during manufacturing processes such as pasteurization, shear mixing, elevated pressurized processes, elevated temperature processes, etc.; (xi) stability of payloads in, or as, a dry powder against heat, acid, protons, salt, light, water, moisture, humidity, oxidation, antimicrobial peptides, and/or elevated temperatures; (xii) tunable properties including size, coating thickness, morphology, geometry, loading, dose, interactions with the surrounding environment, and release conditions, etc.; (xiii) improved anti-caking, anti-clumping, anti-agglomerating, and/or anti-aggregating functionality at elevated temperatures; (xiv) maintenance and preservation of composition morphology (e.g., particle geometry) when exposed to typically degrading conditions, such as: decreased temperatures (e.g., −80° C., −20° C., and/or 4° C.), elevated temperatures (e.g., 22° C., 25° C., 30° C., 35° C., and/or 40° C.), in foods and/or food products, in beverages and/or beverage products, in supplements, in dry powders, in the presence of high relative humidity (e.g., up to 100%) or moisture, or a combination thereof; (xii) mitigation of changes to taste, texture, or scents upon addition, storage, or ingestion of the tastant compositions (e.g., formulated tastants); (xiii) reduction of salt content in a tastant composition without altering and/or changing the taste and/or texture of a tastant composition; (xiv) reduction of sugar content in a tastant composition and/or food without altering and/or changing the taste and/or texture of a tastant composition; (xiv) reduction of fat content in a tastant composition and/or food without altering and/or changing the taste and/or flavor of a tastant composition.

As disclosed herein, tastant compositions (e.g., formulated tastants) may be used to confer taste and health benefits in a human or animal. For example, tastant compositions (e.g., formulated tastants) may be administered to a human or animal to control intensity of taste, control duration of taste, control onset of taste, control physiological reflexes, etc.

As disclosed herein, tastant compositions (e.g., formulated tastants) may be used to confer taste and health benefits in a human or animal. For example, tastant compositions (e.g., formulated tastants) may be administered to a human or animal to reduce salt and/or sugar and/or fat content in tastant compositions without changing the taste and/or flavor of a tastant composition.

Without being bound by any theory, tastant compositions (e.g., formulated tastants) confer taste benefits, may do so by extending retention time in the oral cavity, controlling release rate, controlling adsorption/absorption rates, controlling spatial interactions and concentrations within the oral cavity and specific areas (e.g. tongue, throat, nasal cavities, mucosa, epithelium, taste buds, microvilli, taste bud cell, etc.), facilitating passage through selective barriers and components (e.g. enzymatic components (ATPases), physical components (zonula occludens), molecular components (chondroitin, heparan sulfates, glycosaminoglycans, proteoglycans)), controlling binding of to taste receptors, etc.

Alternatively or additionally, in some embodiments, provided tastant compositions (e.g., formulated tastants) may be used to accelerate, extend, and/or control the onset of absorption/adsorption of tastants. Controlling tastant composition (e.g., formulated tastants) absorption/adsorption time in the mouth and proximal areas (nasal cavity, esophagus, etc.) and their sub-components (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological reflexes, etc.).

Still further alternatively or additionally, in some embodiments, tastant compositions (e.g., formulated tastants) may be used to accelerate, extend, and/or control the residence time of tastants. Controlling tastant composition (e.g., formulated tastants) residence time in the mouth and proximal areas (nasal cavity, esophagus, etc.) and their sub-components (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to control the surface area or volume that tastants have access to. Controlling tastant composition (e.g., formulated tastants) spatial interactions with host-tissues in the mouth and proximal areas (nasal cavity, esophagus, etc.) and their sub-components (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g. formulated tastants) may be used to control the rate of release of tastants and/or payloads. Controlling tastant and/or payload release rate from tastant composition (e.g., formulated tastants) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to control the concentration of tastants and/or payloads in localized areas (mucosa, epithelium, taste buds, cells, etc.). Controlling the concentration of tastants and/or payloads in localized areas (mucosa, epithelium, taste buds, cells, etc.) may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to facilitate payload passage through selective barriers and components (e.g. enzymatic components (ATPases, etc.), physical components (zonula occludens, etc.), molecular components (chondroitin, heparan sulfates, glycosaminoglycans, proteoglycans, etc.). Facilitating payload passage through selective barriers and components may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

Still further alternatively or additionally, in some embodiments, tastant compositions (e.g., formulated tastants) may be used to control binding of tastants to taste receptors. Controlling binding of tastants and/or payloads to taste receptors may confer taste and health benefits in a human or animal (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.).

The present disclosure provides an insight that one challenge in using tastant compositions (e.g., formulated tastants) may be achieving tastant and/or payload stability after host ingestion due to tastant and/or payload sensitivity (e.g., chemical degradation) in various physiological conditions (e.g., saliva, low pH etc.), which may (i) reduce tastant and/or payload amount, (ii) reduce benefits outlined above (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.), or both (i) and (ii).

The present disclosure further provides an insight that one challenge in using tastant compositions (e.g., formulated tastants) may be achieving sufficient control over taste and/or payload release, absorption, adsorption, residence time, spatial interactions, etc. within the mouth and proximal areas, which may (i) reduce tastant and/or payload amount, (ii) reduce control over taste and/or payload absorption/adsorption, (iii) reduce benefits outlined above (e.g controlled/enhanced taste, reduction of salt in a tastant composition and/or food and/or beverage, reduction of in a tastant composition and/or food and/or beverage, controlled duration of taste, controlled onset of taste), or (i), (ii), and/or (iii) and combinations thereof.

The present disclosure further provides an insight that one challenge in using tastant compositions (e.g., formulated tastants) may be achieving sufficient taste and/or payload dose in various supplement, food and/or beverage formats (e.g., a sufficient number of tastes to confer taste benefits in a host) in conditions that these products are often stored in (e.g., high water activity, high humidity, high moisture, high temperatures, high oxygen, etc.), tastant compositions (e.g., formulated tastants), which may (i) reduce tastant and/or payload amount, (ii) reduce control over taste and/or payload absorption, (iii) reduce benefits outlined above (e.g controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste), or (i), (ii), and/or (iii) and combinations thereof.

The present disclosure further observes that some or all of these challenges are often presented together in a tastant composition (e.g., formulated tastants) that has been stored in an unfavorable condition, and is then subsequently ingested by the consumer/host. A tastant composition (e.g., formulated tastants) will face multiple challenges in series and/or in parallel that reduce tastant and/or payload stability and reduce control over tastant and/or payload release, spatial interactions with host-tissues, absorption, adsorption, residence time, etc.

The present disclosure provides technologies that address these challenges, e.g., that can preserve and maintain these features (individually and/or in combination) throughout the lifetime of a tastant composition (e.g., formulated tastant).

The present disclosure appreciates that preserving tastant and/or payload stability in tastant compositions (e.g., formulated tastants) can be important at least because many of the beneficial functions provided by tastants require their stability.

When considering ideal conditions for tastant compositions (e.g., formulated tastants) that can withstand challenges encountered throughout the lifetime (e.g., as ingredients, during processing, during manufacturing, incorporation into consumer products, shelf-storage, ingestion, digestion, etc.), the present disclosure appreciates that effective technologies desirably confer prevention, limitation, mitigation, and/or control interactions with the surrounding environment (which may change throughout the lifetime of the tastant composition).

When considering surrounding environments with which a tastant composition (or components thereof) may interact, possibilities include the food and/or beverage itself (e.g., a particular unit or portion of a composition is exposed to and/or in contact with other units or portions of the composition), the tastant and/or tastants itself, one or more particular constituents of the tastant composition, shelf-storage conditions, manufacturing conditions, the environmental conditions after the food and/or beverage is unsealed/opened, physiological environment within a host that ingests the composition, etc.

The present disclosure further appreciates that tastant and/or payload stability can impact certain tastant compositions (e.g., formulated tastants) functions (e.g., extending retention time of payload in the oral cavity, controlling payload release rate, controlling payload adsorption/absorption rates, controlling payload spatial interactions and concentrations within the oral cavity and specific areas (e.g. tongue, throat, nasal cavities, mucosa, epithelium, taste buds, microvilli, taste bud cell, etc.), facilitating payload passage through selective barriers and components, controlling binding of payload to taste receptors, etc.) that confer tastant composition taste and health benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.) in some cases, tastant compositions may comprise promoters that increase payload stability, modulate the environment to favor payload stability, or combinations thereof.

The present disclosure provides an insight that including sufficient amounts of provided tastant composition(s) (e.g., formulated tastants) in consumer products, or otherwise delivering them to a host, can have beneficial impacts (e.g., extending payload absorption time, extending payload retention time, controlling payload spatial interactions within the host, controlling payload release rate, increasing or decreasing payload absorption, increasing or decreasing payload concentrations within the host, etc.), some or all of which may confer taste benefits.

In some embodiments, attributes of certain provided technologies tastant compositions (e.g., formulated tastants), including specifically performance (e.g. controlled retention time, controlling release rate, controlling adsorption/absorption, controlling concentration, facilitating passage through selective barriers and components, controlling binding of payload to taste receptors, etc.) following ingestion provide important benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.) not otherwise achieved.

In some embodiments, the present disclosure provides tastant compositions (e.g., formulated tastants) that are or comprise a particle preparation, wherein the particles of the particle preparation comprise (i) an encapsulant component; and (ii) a payload component, wherein the encapsulant component comprises a protein, carbohydrate, fat, or other tastant that is compatible with supplement, food, beverage, and/or physiological fluid/environments (e.g., mouth, saliva, etc.); and the payload component comprises a tastant and wherein the preparation enables: (i) protection (maintenance/preservation of tastant stability) of the payload in supplements, foods, beverages, and/or physiological fluids/environment (e.g., mouth, saliva, etc.), and/or processing/manufacturing environments (e.g., high pressure pasteurization, high temperature pasteurization, etc.); (ii) delivery functions (e.g., extending payload absorption time, extending payload retention time, controlling payload spatial interactions within the host, controlling payload release rate, increasing or decreasing payload absorption, increasing or decreasing payload concentrations within the host, etc.) that confer tastant composition taste benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.). In some such embodiments, the composition and/or the preparation is characterized in that the payload component shows increased stability (e.g., is protected against one or more of degradation, oxidation, pressure, other physical and/or chemical changes) when exposed to one or more environmental conditions such as, for example, heat, acid, protons, pasteurization, shear, high pressure, salt, light, water, oxidation, antimicrobial peptides, elevated temperatures, and/or in the context of a complex material. Alternatively or additionally, in some such embodiments, the compositions and/or the particle preparation is characterized in that it enables controlled release of the payload component in the). Alternatively or additionally, in some such embodiments, the compositions and/or the particle preparation is characterized in that it enables sustained release of the payload component in the host's). Alternatively or additionally, in some such embodiments, the compositions and/or the particle preparation is characterized in that it retention time of the payload component in the host's gastrointestinal tract is controlled (e.g., esophagus, stomach, small intestine, large intestine, etc.). Alternatively or additionally, in some such embodiments, the compositions and/or the particle preparation is characterized in that payload absorption in the host's Alternatively or additionally, in some such embodiments, the compositions and/or the particle preparation is characterized in that payload spatiotemporal association within the host's gastrointestinal tract is controlled (e.g., esophagus, stomach, small intestine, large intestine, etc.). Alternatively or additionally, in some such embodiments, the compositions and/or the particle preparation is characterized in that it controls the payload concentration in the host's gastrointestinal tract (e.g., esophagus, stomach, small intestine, large intestine, etc.). Alternatively or additionally, in some such embodiments, the compositions and/or the particle preparation is characterized in that it facilitates payload passage through selective barriers and components (e.g. enzymatic components (ATPases, etc.), physical components (zonula occludens, etc.), molecular components (chondroitin, heparan sulfates, glycosaminoglycans, proteoglycans, etc.). Alternatively or additionally, in some such embodiments, the compositions and/or the particle preparation is characterized in that it controls binding of tastants and/or payloads to taste receptors.

In certain embodiments, the present disclosure provides human and/or animal consumable compositions (e.g., supplement products, food products, powder products, beverage products, liquid products, etc.) comprising disclosed tastant compositions (e.g., formulated tastants), at least one tastant, or a combination thereof. In some instances, tastant compositions (e.g., formulated tastants) further comprise at least one nutraceutical.

In some cases, humans may be a prenatal human, infant, toddler, child, teenager, adolescent, young adult, adult, geriatric, medical patient, athlete, student, etc.

In some cases, animals may be an agricultural animal (e.g., a horse, a cow, a camel, a goat, a sheep, a fish, a crab, etc.), a pet (e.g., a dog, a cat, a fish, a duck, etc.), and/or a wild animal (e.g., a raccoon, a deer, a moose, a bear, a whale, an ant, a bee, a wasp, etc.).

In many embodiments, provided compositions are edible (i.e., consumable by eating). In some aspects, an edible composition may be a powder or slurry that is mixed with food (e.g., a freshly prepared meal, a pre-prepared meal, etc.) prior to consumption.

In many embodiments, provided compositions are drinkable (i.e., amenable to consumption by drinking). In some aspects, a drinkable composition may be a powder or slurry that is mixed with a beverage (e.g., water, a protein shake, etc.) prior to consumption.

In some aspects, consumable compositions comprising tastant compositions (e.g., formulated tastants) may be drinkable. In some aspects, an edible composition may be a powder or slurry that is mixed with a beverage (e.g., water, a protein shake, etc.) prior to consumption.

In some aspects, the present disclosure provides methods for preparing a tastant and/or tastant payload component. In some such embodiments, a provided method may comprise steps of: (i) formulation (e.g., encapsulation, association, and/or complexation with materials); (ii) post-formulation processing (e.g., drying, characterization, additions of excipients, etc.); (iii) storage (e.g., bagging in aluminum sachets, addition of nitrogen or vacuum environments, etc.); (iv) combination with or as supplements and/or foods and/or beverages; (v) methods to ingestions (e.g., swallowing as a capsule, addition to other existing food and/or beverages); or (vi) a combination of (i), (ii), (iii), (iv), and (v).

In some aspects, the disclosure provides tastant compositions (e.g., formulated tastants) and/or tastant payloads, which may in some embodiments have been prepared by a method described herein.

In some aspects, the present embodiments are directed to tastant compositions (e.g., formulated tastants) comprising a carrier component and a payload component, wherein the payload component is associated with (e.g., encapsulated in, adhered to, dispersed in) the carrier component; and wherein the payload component comprises: (i) a taste component; (ii) a component that the payload utilizes for functional performance (e.g., extending retention time of payload in the oral cavity, controlling payload release rate, controlling payload adsorption/absorption rates, controlling payload spatial interactions and concentrations within the oral cavity and specific areas (e.g. tongue, throat, nasal cavities, mucosa, epithelium, taste buds, microvilli, taste bud cell, etc.), facilitating payload passage through selective barriers and components, controlling binding of payload to taste receptors, etc.) within the host; (iii) a component that modulates the environment (e.g., food matrix, liquid environment, physiological fluid, tissue/organ such as mouth, esophagus, epithelium, etc.) to preserve or maintain taste stability and/or delivery functions; (iv) one or more other payload component(s), or (v) a combination of (i), (ii), (iii), or (iv).

In some embodiments, provided tastant compositions (e.g., formulated tastants) are or comprise particles (e.g., microparticles) that include a matrix component (e.g., a polymer component) and a payload component (e.g., tastants, nutrients, macronutrients, micronutrients, proteins, carbohydrates, fats, vitamins, minerals, ketones, polyphenols, etc.). In some instances, one or more layers of matrix components are present.

In some embodiments, a matrix component is or comprises a hydrophobic component. In some instances, a hydrophobic component is or comprises a sugar, a polysaccharide, a carbohydrate, an oil, a fat, a wax, a protein, or a combination thereof. In some instances, a matrix component comprises a salt (e.g., calcium carbonate). In some instances, a matrix component comprises a surfactant (e.g., sodium dodecyl sulfate). In some instances, a matrix component comprises a polymer (e.g., polyvinyl alcohol). In some instances, one or more layers of payload components are present.

In some embodiments, a matrix component is or comprises a hydrophilic component. In some instances, a hydrophilic component is or comprises a sugar, a polysaccharide, a carbohydrate, an oil, a fat, a wax, a protein, or a combination thereof. In some instances, a matrix component comprises a salt (e.g., sodium chloride). In some instances, a matrix component comprises a surfactant (e.g., sodium dodecyl sulfate). In some instances, one or more layers of payload components are present.

In some embodiments, a matrix component is or comprises an amphiphilic component. In some instances, an amphiphilic component is or comprises a sugar, a polysaccharide, a carbohydrate, an oil, a fat, a wax, a protein, or a combination thereof. In some instances, a matrix component comprises a salt (e.g., sodium chloride). In some instances, a matrix component comprises a surfactant (e.g., sodium dodecyl sulfate). In some instances, one or more layers of payload components are present.

In some instances, a matrix component comprises a biocompatible material. In some instances a biocompatible material is or comprises a sugar, a polysaccharide, a carbohydrate, an oil, a fat, a wax, a lipid, a protein, an amino acid, a peptide, or a combination thereof. In some instances, a matrix component comprises a salt (e.g., calcium carbonate). In some instances, a matrix component comprises a surfactant (e.g., sodium dodecyl sulfate).

In some cases, a matrix component further comprises one or more nutrient (e.g., antioxidants, flavonoids, polyphenols, vitamins, minerals, micronutrients, prebiotics, electrolytes) payloads.

The present disclosure provides technologies for making and/or characterizing matrix components comprising encapsulants described herein, and/or compositions that include them. In some embodiments, the disclosed processes and methodologies to generate matrices include extrusion, granulation, extrusion-based methods, melt processing, shear-based granulation methods, lyophilization, atomization, prilling, spray chilling, and/or spray congealing methods.

In some embodiments, the carrier component comprises at least one carbohydrate, at least one polymer, and/or at least one lipid.

In some embodiments, the disclosed food component comprises a tastant selected from the group consisting of: a naturally-occurring tastant, and a tastant prepared by any method described herein; a commercially-available tastant, and a tastant prepared by any method described herein; a commercially-available tastant preparation (e.g., freeze-dried, or already-formulated tastants), and a tastant prepared by any method described herein. As such, in some embodiments according to the present disclosure, the disclosed food component comprises a commercially-available tastant powder that includes a carrier or matrix component that is then further encapsulated in a carrier, as described herein. In such embodiments, an inner carrier containing the tastant is itself encapsulated in one or more outer encapsulant layers or carriers.

In some embodiments, a provided composition may be or comprise one or more particles; typically, a population of particles. In some embodiments, a particle or population thereof is characterized by its diameter (e.g., average diameter). A particle “diameter” (i.e., a particle size) is the longest distance from one end of the particle to another end of the particle. In some embodiments, tastant compositions (e.g., formulated tastants) are or comprise particles with a distribution of particle diameters (e.g., D[3,2], D[4,3], etc.). In some embodiments, tastant compositions (e.g., formulated tastants) are or comprise particles with a distribution of particle diameters (e.g., D[3,2], D[4,3], etc.) of up to about 1 nm, up to about 100 nm, up to about 500 nm, up to about 1 μm, up to about 10 μm, up to about 100 μm, up to about 500 μm, up to about 1 mm, up to about 1 mm, up to about 10 mm, or up to about 50 mm.

In some embodiments, tastant compositions (e.g., formulated tastants) may include particle preparations that include any shape or form, for example, having a cross-section shape of a circle, an oval, a triangle, a square, a hexagon, or an irregular shape. In some embodiments, tastant compositions (e.g., formulated tastants) comprise particles (e.g., nanoparticles, microparticles), wherein a majority of particles have a common shape. In some embodiments, tastant compositions (e.g., formulated tastants) are or comprise particles of various such shapes in combination.

In some embodiments, tastant compositions (e.g., formulated tastants) may include individual constituents that self-assemble into particle preparations upon exposure to a specific environment (e.g., food matrix, beverage matrix, physiological fluid, stomach acids, bile salts, temperature, etc.). tastant compositions (e.g., formulated tastants) that self-assemble into particle preparations upon introduction into specific environments include any shape or form, for example, having a cross-section shape of a circle, an oval, a triangle, a square, a hexagon, or an irregular shape. In some embodiments, tastant compositions (e.g., formulated tastants) comprise particles (e.g., nanoparticles, microparticles), wherein a majority of particles have a common shape. In some embodiments, tastant compositions (e.g., formulated tastants) are or comprise particles of various such shapes in combination.

In some embodiments, provided tastant compositions (e.g., formulated tastants) are characterized by having a layered structure, e.g., wherein adjacent layers have different chemical structures.

In some embodiments, provided tastant compositions (e.g., formulated tastants) are characterized by having multiple polymer components, wherein the tastant compositions (e.g., formulated tastants) may be additionally encapsulated with a separate polymer component.

In some embodiments, the compositions (e.g., formulated tastants) provided by the present disclosure include, a first layer that is or comprises a tastant and/or a second tastant and a second layer that is or comprises a different tastant and/or the same tastant. For example, in some particular embodiments, a tastant material may be or comprise proteins and/or carbohydrates; in some embodiments, the protein may be encapsulated within the carbohydrate; in some embodiments, the carbohydrate may be encapsulated within the protein; in some embodiments, the carbohydrate may be encapsulated within the same or a distinct carbohydrate. In some embodiments, the carbohydrate may be encapsulated within a mixture of protein and carbohydrates. In some embodiments, the layers are reversed.

In some such embodiments, the composition and/or the preparation is characterized in that the payload component shows increased stability (e.g., is protected against one or more of degradation, oxidation, pressure, other physical and/or chemical changes) when exposed to one or more environmental conditions such as, for example, heat, acid, protons, pasteurization, shear, high pressure, salt, light, water, oxidation, antimicrobial peptides, elevated temperatures, and/or in the context of a complex material.

Tastant compositions (e.g., formulated tastants) comprising enhanced stability provides benefits over existing comparable products, among other things because enhanced stability will extend shelf-life.

In some embodiments, the present disclosure provides technologies for manufacturing provided tastant compositions (e.g., formulated tastants) that increase payload stability during and/or following manufacturing (thereby minimizing payload losses in food and/or beverage products). Thus, the present disclosure provides technologies with a variety of advantages.

In some embodiments, the present disclosure provides technologies for manufacturing provided tastant compositions (e.g., formulated tastants) that increase shelf-life following manufacturing (thereby minimizing payload losses in food and/or beverage products). Thus, the present disclosure provides technologies with a variety of advantages.

Tastant compositions (e.g., formulated tastants) comprising enhanced shelf-life provides benefits over existing products, among other things because extended shelf-life will provide longer-duration of product lifetime.

In some embodiments, the present disclosure provides technologies for manufacturing provided tastant compositions (e.g., formulated tastants) that increase shelf-life time following manufacturing (thereby minimizing payload losses in food and beverage products). Thus, the present disclosure provides technologies with a variety of advantages.

In some such embodiments, the compositions and/or the particle preparation is characterized in that it enables controlled release of the payload component in the host's oral cavity and specific areas (e.g. tongue, throat, nasal cavities, mucosa, epithelium, taste buds, microvilli, taste bud cell, etc.

Tastant compositions (e.g., formulated tastants) comprising controlled release of payloads have benefits over existing products, among other things because controlled payload release will provide methods to improve or control taste.

In some embodiments, the present disclosure provides technologies for manufacturing provided tastant compositions (e.g., formulated tastants) that provide controlled release of payloads following manufacturing (thereby ensuring that products containing compositions can provide controlled delivery of tastants). Thus, the present disclosure provides technologies with a variety of advantages.

In some such embodiments, the compositions and/or the particle preparation is characterized in that it enables sustained release of the payload component in the host's oral cavity and specific areas (e.g. tongue, throat, nasal cavities, mucosa, epithelium, taste buds, microvilli, taste bud cell, etc.

In some embodiments, tastant compositions (e.g., formulated tastants) comprising sustained release of payloads have benefits over existing products, among other things because sustained payload release will provide methods to improve or control taste.

In some embodiments, tastant compositions (e.g., formulated tastants) that provide methods to improve or control taste have benefits over existing products, among other things because controlled taste can enable reduction of salt and/or sugar and/or fat in tastant compositions.

In some embodiments, the present disclosure provides technologies for manufacturing provided tastant compositions (e.g., formulated tastants) that provide sustained release of payloads following manufacturing (thereby ensuring that products containing compositions can provide sustained taste). Thus, the present disclosure provides technologies with a variety of advantages.

In some such embodiments, the compositions and/or the particle preparation is characterized in that it enables extended retention time of the payload component in the host's oral cavity and specific areas (e.g. tongue, throat, nasal cavities, mucosa, epithelium, taste buds, microvilli, taste bud cell, etc.).

Tastant compositions (e.g., formulated tastants) comprising extended retention time of payloads have benefits over existing products, among other things because extended retention of payloads will provide methods to improve or control taste.

In some embodiments, the present disclosure provides technologies for manufacturing provided tastant compositions (e.g., formulated tastants) that provide extended retention time of payloads following manufacturing (thereby ensuring that products containing compositions can provide sustained taste). Thus, the present disclosure provides technologies with a variety of advantages.

In some such embodiments, the compositions and/or the particle preparation is characterized in that payload absorption in the host's oral cavity and specific areas (e.g. tongue, throat, nasal cavities, mucosa, epithelium, taste buds, microvilli, taste bud cell, etc.) is controlled.

Tastant compositions (e.g., formulated tastants) comprising controlled payload absorption have benefits over existing products, among other things because controlled absorption of payloads will provide methods to improve or control taste.

In some embodiments, the present disclosure provides technologies for manufacturing provided tastant compositions (e.g., formulated tastants) that provide controlled absorption of payloads following manufacturing (thereby ensuring that products containing compositions can improve or control taste). Thus, the present disclosure provides technologies with a variety of advantages.

In some such embodiments, the compositions and/or the particle preparation is characterized in that payload spatiotemporal association within the host's oral cavity and specific areas (e.g. tongue, throat, nasal cavities, mucosa, epithelium, taste buds, microvilli, taste bud cell, etc.) is controlled.

Tastant compositions (e.g., formulated tastants) comprising controlled payload spatial association within the host's oral cavity and specific areas have benefits over existing products, among other things because controlled payload spatial association within the host's oral cavity and specific areas will provide methods to improve or control taste.

In some embodiments, the present disclosure provides technologies for manufacturing provided tastant compositions (e.g., formulated tastants) that provide controlled payload spatial association within the host's oral cavity and specific areas following manufacturing (thereby ensuring that products containing compositions can improve or control taste). Thus, the present disclosure provides technologies with a variety of advantages.

In some such embodiments, the compositions and/or the particle preparation is characterized in that it controls the payload concentration within the host's oral cavity and specific areas (e.g. tongue, throat, nasal cavities, mucosa, epithelium, taste buds, microvilli, taste bud cell, etc.).

Tastant compositions (e.g., formulated tastants) comprising controlled payload concentrations within and around the host's oral cavity have benefits over existing products, among other things because controlled payload concentrations within the host's gastrointestinal tract will provide methods to improve or control taste.

In some embodiments, the present disclosure provides technologies for manufacturing provided tastant compositions (e.g., formulated tastants) that provide controlled payload concentration within and around the host's oral cavity following manufacturing (thereby ensuring that products containing compositions can improve or control taste from foods and/or beverages). Thus, the present disclosure provides technologies with a variety of advantages.

In some such embodiments, the compositions and/or the particle preparation are characterized in that it facilitates payload passage through selective barriers and components (e.g. enzymatic components (ATPases, etc.), physical components (zonula occludens, etc.), molecular components (chondroitin, heparan sulfates, glycosaminoglycans, proteoglycans, etc.)).

Tastant compositions (e.g., formulated tastants) facilitating payload passage through selective barriers and components have benefits over existing products, among other things because facilitated passage will provide methods to improve or control taste.

In some embodiments, the present disclosure provides technologies for manufacturing provided tastant compositions (e.g., formulated tastants) that facilitate passage through selective barriers and components of payloads following manufacturing (thereby ensuring that products containing compositions can improve or control taste). Thus, the present disclosure provides technologies with a variety of advantages.

In some such embodiments, the compositions and/or the particle preparation are characterized in that it controls binding of payload to taste receptors.

Tastant compositions (e.g., formulated tastants) comprising control of binding of payload to taste receptors have benefits over existing products, among other things because controlled binding to taste receptors will provide methods to improve or control taste.

In some embodiments, the present disclosure provides technologies for manufacturing provided tastant compositions (e.g., formulated tastants) that provide controlled binding of payload to taste receptors following manufacturing (thereby ensuring that products containing compositions can improve or control taste). Thus, the present disclosure provides technologies with a variety of advantages.

In some embodiments, the present disclosure provides tastant compositions (e.g., formulated tastants) for stability in supplements, foods and/or beverages at elevated temperatures, water activities, humidity and/or moisture. This provides benefits over existing products, among other things because these conditions lead to rapid tastant degradation after incorporation with products and during shelf-storage. Thus, the present disclosure provides technologies with a variety of advantages.

In some embodiments, the present disclosure provides particular insight that identifies the source of a limitation associated with certain current tastant compositions (e.g., formulated tastants) in that tastant compositions do not provide control over: 1) retention time in the oral cavity; 2) payload release rate; 3) payload adsorption/absorption rate; 4) payload spatial interactions within and around the oral cavity; 5) payload passages through selective barriers and components; 6) binding of payload to taste receptors, which lead to limitations in being able to create and implement food and beverage products capable of controlling: 1) intensity of taste; 2) duration of taste; 3) onset of taste; 4) physiological reflexes.

Without wishing to be bound by theory, many presently available food and/or beverage products and/or tastants cannot achieve control over taste and/or flavor and therefore lack various benefits provided by the present disclosure. Technologies provided herein enable delivery and delivery functions when individually ingested, and/or when combined with or into a multitude of food and/or beverage and/or powder and/or tastant products in the areas of supplements, foods, tastants, and/or beverages.

In some cases, a temperature-responsive encapsulant is more readily processed at lower temperatures (e.g., glass transition temperature) through addition of payloads or plasticizers. In some embodiments, payloads alone can lower the glass transition temperature of temperature-responsive polymers. Collectively, this facilitates manufacturing and processing approaches at lower temperatures, since encapsulant component and payload component can more easily transition from flowable homogenous liquid states to solid states (e.g., particles).

In some instances, a provided tastant composition (e.g., formulated tastant) provides increased shelf-life in beverages at 4° C., 18° C., 25° C., 30° C., 35° C.

In some instances, a provided tastant composition (e.g., formulated tastant) provides increased shelf-life in dry powders at −20° C., 4° C., 18° C., 25° C., 30° C., 35° C.

In some instances, a provided tastant composition (e.g., formulated tastant) provides increased shelf-life in food matrices at −20° C., 4° C., 18° C., 25° C., 30° C., 35° C.

In some instances, a provided tastant composition (e.g., formulated tastant) provides increased shelf-life prior to incorporation into any matrix at −20° C., 4° C., 18° C., 25° C., 30° C., 35° C.

In some instances, a provided tastant composition (e.g., formulated tastant) provides increased shelf-life in capsules and/or tablets and/or pills at −20° C., 4° C., 18° C., 25° C., 30° C., 35° C.

In some embodiments, a provided tastant compositions (e.g., formulated tastants) may be or is effective at protecting payload components (e.g., tastant payload component) and/or encapsulant components (e.g., a tastant encapsulant) against a physical change, a chemical change, or both (e.g., degradation, oxidation, hydrolysis, isomerization, fragmentation, or a combination thereof).

In some embodiments, a provided tastant compositions (e.g., formulated tastants) may be or remain stable, e.g., to store for a particular period of time under particular conditions.

For example, in some embodiments, 99% of a payload and/or encapsulant component present in a provided composition at a particular point in time remains present, and/or one or more size characteristics (e.g., average diameter and/or one or more features of size distribution of a particle composition) remains stable throughout a period of time during which the composition is maintained under particular conditions. For example, a payload component present in a provided composition may remain stable in a dry powder form for a period of time. In some embodiments, a payload component present in a provided composition may remain stable for a period of time when dispersed within solid food (at chilled, room temperature, and/or elevated temperatures). In some embodiments, a payload component present in a provided composition may remain stable for a period of time when dispersed within a beverage (at chilled, room temperature, and/or elevated temperatures). In some embodiments, a payload component present in a provided composition may remain stable for a period of time when dispersed within an acidic solution (for example, at a pH <3).

In some embodiments, the period of time is at least 2, 3, 4, 5, 6, 7, 8, 9, 10, 11, 12, 13, 14, 15, 16, 17, 18, 19, 20, 21, 22, 23, 24 weeks or more, and/or at least about 1, 2, 3, 4, 5, 6, 7, 8, 9, 10, 11, 12 months or more, and/or at least about 1, 2, 3, 4, 5 years or more.

In some such embodiments, the particular conditions comprise ambient temperature. In some such embodiments, the particular conditions comprise elevated (above ambient) temperature. Alternatively or additionally, in some embodiments, the particular conditions comprise aqueous conditions (e.g., aqueous liquid conditions). In some embodiments, the period of time is at least two months and the particular conditions comprise ambient temperature.

In some embodiments, stability comprises mitigation, limitation, or prevention of chemical degradation of tastant payloads and/or tastant encapsulants.

In some embodiments, stability comprises maintenance of delivery functions (e.g., extending retention time of payload in the oral cavity, controlling payload release rate, controlling payload adsorption/absorption rates, controlling payload spatial interactions and concentrations within and around the oral cavity and specific areas (e.g. tongue, throat, nasal cavities, mucosa, epithelium, taste buds, microvilli, taste bud cell, etc.), facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.)), controlling binding of payload to taste receptors, etc.) of provided tastant compositions (e.g., formulated tastants) and/or tastant payloads and/or tastant encapsulants.

In some embodiments, stability comprises maintenance of conferred taste benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, control of physiological response, etc.) for tastant compositions (e.g., formulated tastants) and/or tastant payloads and/or tastant encapsulants.

In some embodiments, tastant compositions (e.g., formulated tastants) exhibit improved anti-caking, anti-clumping, anti-agglomerating, and/or anti-aggregating performance to enable incorporation into food and beverage products (e.g., food, liquid beverages, dry powders, etc.).

In some embodiments, a tastant composition (e.g., formulated tastants) may further comprise an excipient component (e.g., an anti-caking component, an anti-clumping component, a plasticizer, an anti-agglomerating component, and/or an anti-aggregating component [e.g., any of an excipient comprising microcrystalline cellulose, starches, calcium carbonate, etc.], wherein an excipient component is at least about 99 wt %, at least about 90 wt %, at least about 85 wt %, at least about 80 wt %, at least about 75 wt %, at least about 70 wt %, at least about 65 wt %, at least about 60 wt %, at least about 55 wt %, at least about 50 wt %, at least about 45 wt %, at least about 40 wt %, at least about 35 wt %, at least about 30 wt %, at least about 25 wt %, at least about 20 wt %, at least about 15 wt %, at least about 10 wt %, at least about 5 wt %, at least about 1 wt %, at least about 0.8 wt %, at least about 0.5 wt %, at least about 0.1 wt % of a particle preparation (i.e., a tastant composition).

The disclosed tastant composition (e.g., formulated tastants) may be particularly useful for stabilizing tastant payloads and/or encapsulant payloads and/or taste payloads, and maintaining delivery functions (e.g., extending retention time of payload in the oral cavity, controlling payload release rate, controlling payload adsorption/absorption rates, controlling payload spatial interactions and concentrations within and around the oral cavity and specific areas (e.g. tongue, throat, nasal cavities, mucosa, epithelium, taste buds, microvilli, taste bud cell, etc.), facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.)), controlling binding of payload to taste receptors), and enabling the associated taste and health benefits (e.g., controlled/enhanced taste, reduction of salt in a tastant composition and/or food and/or beverage, reduction of sugar in a tastant composition and/or food and/or beverage, reduction of fat in a tastant composition and/or food and/or beverage, controlled duration of taste, controlled onset of taste, etc.) in consumable compositions (e.g., a food product, a beverage product, an animal-consumable product, dry powders, supplements, etc.), where food components typically lose stability, delivery functions, and the associated taste benefits.

In certain embodiments, the present disclosure provides consumable compositions (e.g., a food product, a beverage product, an animal-consumable product, dry powders, a supplement, etc.)

In some aspects, consumable compositions comprising tastant composition (e.g., formulated tastants) may be edible. In some aspects, an edible composition may be a protein bar, a cereal, a protein powder, a milk powder, a salad dressing, a nutritional supplement, a baby formula, a smoothie, a yogurt, an ice cream, a sachet, a spice, a food additive, a candy, a sprinkle packet, and/or a pet food

In some aspects, consumable compositions comprising tastant composition (e.g., formulated tastants) are drinkable. In some aspects, a drinkable composition may be a sports drink, beer, wine, tea, coffee, milk, juice, water, yogurt, soda, carbonated water, or a liquid pharmaceutical formulation.

In some embodiments, enhanced stability, maintenance of delivery functions, and/or conferring taste and health benefits are maintained after storage (e.g., with or within a consumable composition) in a freezer (−85° C. to 0° C.), a refrigerator (1-10° C.), or atmospheric temperature (−10° C.-40° C.) for time periods between 0-1 week, 0-1 month, 0-1 year or 1-5 years.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

FIG. 1 shows, in a non-limiting example, a schematic of exemplary core-shell preparations which may comprise carrier components, payload components, excipient components, and combinations thereof.

FIG. 2 shows, in a non-limiting example, a schematic of exemplary core-shell particle preparations with multiple layers which may comprise food components, excipient components, or combinations thereof.

FIG. 3 shows, in a non-limiting example, a schematic of exemplary matrix preparations which may comprise food components, excipient components, or combinations thereof.

FIG. 4 shows, in a non-limiting example, photographs and brightfield micrographs of exemplary encapsulated sugar compositions comprising a core component (e.g., sucrose) and a shell component (e.g., zein).

FIG. 5 shows, in a non-limiting example, a schematic of a method used to apply a coating to a food and/or beverage composition, referred to herein as “coating”.

FIG. 6 shows, in a non-limiting example, a schematic of a method used to create a matrix food and/or beverage composition, referred to herein as “matrix”.

FIG. 7 shows, in a non-limiting example, a schematic of a method used to characterize dissolution and/or release of food and/or beverage composition, referred to herein as “dissolution” and/or “release”.

FIG. 8 presents, in a non-limiting example, 4 target (e.g., theoretical) release profiles (concentration of food component vs incubation period) of one or more food component(s) from one or more tastant composition(s).

FIG. 9 presents, in a non-limiting example, a plot of glucose release (mg/dL or mg/dL/min) over time, indicating release of sucrose payload from tastant compositions (e.g., with exemplary tastant compositions comprising encapsulated sucrose coated with 10% zein).

FIG. 10 presents, in a non-limiting example, a plot of glucose release (mg/dL or mg/dL/min) over time, indicating release of glucose payload from food and/or beverage compositions (e.g., with exemplary food and/or beverage compositions (10% zein, 2.5% glyceryl monostearate, 1% propylene glycol)) at 37° C. for 60 minutes.

FIG. 11 illustrates, in a non-limiting example, photographs of food and/or beverage compositions (e.g., alginate/sucrose beads, gelatin/sucrose beads, and/or sucrose/amylose beads) blended homogeneously with commercially available food product (e.g., MRE, Ensure), imparting minimal change to visible appearance (e.g., color and texture).

FIG. 12 illustrates, in a non-limiting example, brightfield micrographs of the stability of tastant compositions (e.g., alginate/sucrose beads, gelatin/sucrose beads, and/or sucrose/amylose beads) when blended homogeneously with water. Morphological changes are observed following a 1-hour incubation period.

FIG. 13 shows, in a non-limiting example, a comparison of unformulated carbohydrate powder and taste composition(s) comprising carbohydrate(s) as component(s) of matrix composition(s) and/or core-shell preparation(s). (A) Unformulated glucose; (B) sucrose-amylose matrix preparation(s) encapsulated in Zein; (C) 60% (w/v) glucose encapsulated in 2% (w/v) pectin; (D) 1% (w/v) inulin encapsulated in 2% (w/v) agarose; (E) 10% (w/v) calcium caseinate and 1% (w/v) inulin encapsulated in 2% (w/v) sodium alginate.

FIG. 14 shows, in a non-limiting example, a comparison of unformulated protein and taste composition(s) comprising protein(s) as component(s) of matrix composition(s) and/or core-shell preparation(s). (A) Unformulated whey protein isolate (WPI) powder; (B) 20% (w/v) whey protein isolate encapsulated in 80% (w/v) beeswax, (C) whey protein (5% w/v) encapsulated in 80% (w/v) fully hydrogenated soy oil and Tween 80 (15% w/v); (D) whey protein (10% w/v) encapsulated in 3% (w/v) agarose and 1% (w/v) chitosan.

FIG. 15 shows, in a non-limiting example, a comparison of unformulated lipid and taste composition(s) comprising lipid(s) as component(s) of matrix composition(s) and/or core-shell preparation(s). (A) Unformulated oleic acid (OLEA); (B) 80% (w/v) oleic acid in ethyl cellulose (20% w/v); (C) 80% (w/v) oleic acid in carnauba wax (20% w/v); (D) 80% (w/v) oleic acid in ethyl cellulose (20% w/v); (E) 80% (w/v) oleic acid in ethyl cellulose (20% w/v) with a polymeric coating.

FIG. 16 illustrates, in a non-limiting example, several exemplary release profiles of carbohydrate(s) encapsulated within one or more taste composition(s) in phosphate buffered saline, pH 7.4, 37° C. Taste composition(s) characterized as matrix preparation(s) are colored light grey, while those characterized as core-shell preparations wherein the core component(s) are further characterized as matrix preparation(s) are colored dark grey. (A) Release of glucose from taste composition(s) over time; each line represents an average of 3 dissolution experiments for a distinct taste composition (e.g., distinct component(s) and concentration(s)) comprising glucose. (B) First order release rates modeled from glucose release of distinct taste composition(s) sorted from fastest release (top) to slowest release (bottom).

FIG. 17 illustrates, in a non-limiting example, several exemplary release profiles of protein(s) encapsulated within one or more taste composition(s) in phosphate buffered saline, pH 7.4, 37° C. Taste composition(s) characterized as matrix preparation(s) are colored light grey, while those characterized as core-shell preparations wherein the core component(s) are further characterized as matrix preparation(s) are colored dark grey. (A) Release of whey from taste composition(s) over time; each line represents an average of 3 dissolution experiments for a distinct taste composition (e.g., distinct component(s) and concentration(s)) comprising whey. (B) First order release rates modeled from whey release of distinct taste composition(s) sorted from fastest release (top) to slowest release (bottom).

FIG. 18 illustrates, in a non-limiting example, several exemplary release profiles of lipid(s) encapsulated within one or more taste composition(s) in phosphate buffered saline, pH 7.4, 37° C. Taste composition(s) characterized as matrix preparation(s) are colored light grey. (A) Release of oleic acid from taste composition(s) over time; each line represents an average of 3 dissolution experiments for a distinct taste composition (e.g., distinct component(s) and concentration(s)) comprising oleic acid. (B) First order release rates modeled from oleic acid release of distinct taste composition(s) sorted from fastest release (top) to slowest release (bottom).

FIG. 19 illustrates, in a non-limiting example, a comparison of unformulated flavonoid (e.g., polyphenol) and formulated flavonoid (e.g., polyphenol) in taste composition(s) as components of matrix preparation(s) and/or core-shell preparation(s), as well as release profile(s) of encapsulated flavonoid(s). (A) Unformulated cyanidin chloride powder. (B) Matrix preparation comprising glucose. (C) core-shell preparation wherein core component(s) comprise glucose and shell component(s) comprise cyanidin chloride. (D) Release of cyanidin chloride from core-shell preparation in phosphate buffered saline, pH 7.4, 37° C.

FIG. 20 illustrates, in a non-limiting example, a comparison of unformulated carbohydrate and formulated carbohydrate in taste composition(s) as components of matrix preparation(s) and/or core-shell preparation(s), as well as release profile(s) of encapsulated carbohydrate(s). (A) Unformulated inulin powder. (B) Matrix preparation comprising inulin. (C) Release of inulin from matrix preparation in phosphate buffered saline, pH 7.4, 37° C.

### DETAILED DESCRIPTION OF CERTAIN EMBODIMENTS

Section headings used herein are for organizational purposes only and are not to be construed as limiting the subject matter described.

### A. Certain Terminology

Unless defined otherwise, technical and scientific terms used herein have the same meaning as is commonly understood to which the claimed subject matter belongs. In the event that there are a plurality of definitions for terms herein, those in this section prevail.

It is to be understood that the general description and the detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Definition of standard chemistry terms may be found in reference works, including but not limited to, Carey and Sundberg “Advanced Organic Chemistry 4th Ed.” Vols. A (2000) and B (2001), Plenum Press, New York.

As used herein, the symbol “<” means less than or fewer than. As used herein, the symbol “>” means more than.

As used herein, the term “about” or “approximately” means within 10%, preferably within 10%, and more preferably within 5% of a given value or range.

Ambient: The term “ambient”, as used herein, refers to a typical indoor (e.g., climate-controlled) temperature, usually within a range of about 18° C. to about 32° C., and/or typical indoor (e.g., climate-controlled) humidity, usually within a range of about 30% to 50%. In some embodiments, ambient temperature is within a range of about 20° C. to about 30° C. In some embodiments, ambient temperature is 25±5° C. In some embodiments, ambient temperature is approximately 21° C. In some embodiments, ambient temperature is 18° C. In some embodiments, ambient temperature is 19° C. In some embodiments, ambient temperature is 20° C. In some embodiments, ambient temperature is 21° C. In some embodiments, ambient temperature is 22° C. In some embodiments, ambient temperature is 23° C. In some embodiments, ambient temperature is 24° C. In some embodiments, ambient temperature is 25° C. In some embodiments, ambient temperature is 26° C. In some embodiments, ambient temperature is 27° C. In some embodiments, ambient temperature is 28° C. In some embodiments, ambient temperature is 29° C. In some embodiments, ambient temperature is 30° C. In some embodiments, ambient may be used to describe outdoor conditions, and may include temperatures ranging from about 15° C. to about 40° C., or from about 25° C. to about 40° C. In some embodiments, ambient humidity is within a range of about 35% to about 45%. In some embodiments, ambient temperature is 35%. In some embodiments, ambient temperature is 36%. In some embodiments, ambient temperature is 37%. In some embodiments, ambient temperature is 38%. In some embodiments, ambient temperature is 39%. In some embodiments, ambient temperature is 40%. In some embodiments, ambient temperature is 41%. In some embodiments, ambient temperature is 42%. In some embodiments, ambient temperature is 43%. In some embodiments, ambient temperature is 44%. In some embodiments, ambient temperature is 45%.

Beverage: As used herein, the term “beverage” is used to refer to a potable liquid (e.g., that can be ingested, swallowed, drunk, or consumed by a person or animal without material risk to the person or animal). For example, beverage can be or comprise beer, juice, milk, a sports drink, tea, water, soda, yogurt, etc. In some embodiments, a “beverage” may be or comprise a pharmaceutical formulation in liquid form.

Biocompatible: As used herein, the term “biocompatible” is used to describe a characteristic of not causing significant detectable harm to living tissue when placed in contact therewith e.g., in vivo. In certain embodiments, materials are “biocompatible” if they are not significantly toxic to cells, e.g., when contacted therewith in a relevant amount and/or under relevant conditions such as over a relevant period of time. In certain embodiments, materials are “biocompatible” if their addition to cells in vitro results in less than or equal to 20% cell death, and/or their administration in vivo does not induce significant inflammation or other adverse effects.

Comparable: As used herein, the term “comparable” refers to two or more agents, entities, situations, sets of conditions, etc., that may not be identical to one another but that are sufficiently similar to permit comparison therebetween so that one skilled in the art will appreciate that conclusions may reasonably be drawn based on differences or similarities observed. In some embodiments, comparable sets of conditions, circumstances, individuals, or populations are characterized by a plurality of substantially identical features and one or a small number of varied features. Those of ordinary skill in the art will understand, in context, what degree of identity is required in any given circumstance for two or more such agents, entities, situations, sets of conditions, etc. to be considered comparable. For example, those of ordinary skill in the art will appreciate that sets of circumstances, individuals, or populations are comparable to one another when characterized by a sufficient number and type of substantially identical features to warrant a reasonable conclusion that differences in results obtained or phenomena observed under or with different sets of circumstances, individuals, or populations are caused by or indicative of the variation in those features that are varied.

Degradation: As used herein, the term “degradation” refers to a change in chemical structure and often involves breakage of at least one chemical bond. To say that a chemical compound is degraded typically means that the chemical structure of the chemical compound has changed (e.g., a chemical bond is broken). Common mechanisms of degradation include, for example, oxidation, hydrolysis, isomerization, fragmentation, or a combination thereof.

Delivery: As used herein, the term “delivery” is used to refer to the carrying and/or deposition and/or moving of payloads and/or encapsulants to particular location (e.g., into and/or throughout the body). In some instances, for example, delivery may refer to payload delivery to the epithelial cells in the gastrointestinal tract. In some instances, for example, delivery may refer to payload delivery to into the blood stream (e.g., systemic absorption). In some instances, for example, delivery may refer to ingestion at the point of consumption for a shelf-stable tastant composition containing a tastant payload.

Diameter: As used herein, the term “diameter” is used to refer to the longest distance from one end of a particle to another end of the particle. Those skilled in the art will appreciate that a variety of techniques are available for use in characterizing particle diameters (i.e., particle sizes). In some instances, for example, size of particles (e.g., diameter of particles) can be measured by a Coulter Counter. In some instances, for example, size of particles (e.g., diameter of particles) can be measured by a Malvern Mastersizer. In some embodiments, a population of particles is characterized by an average size (e.g., D [3,2], D [4,3], etc.) and/or by particular characteristics of size distribution (e.g., absence of particles above or below particular sizes [e.g., Dv10, Dv20, Dv30, Dv40, Dv50, Dv60, Dv70, Dv80, Dv90, Dv99, etc.], a unimodal, bimodal, or multimodal distribution, etc.).

Dispersity: As used herein, the term “dispersity” is used to refer to the breadth of particle size distribution relative to the average particle size. In some instances, for example, size of particles (e.g., diameter of particles) can be measured by a Coulter Counter. In some instances, for example, size of particles (e.g., diameter of particles) can be measured by a Malvern Mastersizer. In some embodiments, the population of particles is characterized by, for example, an average size (e.g., Dv50) and, for example, a corresponding standard deviation. In some instances, the dispersity of a population of particles refers to double (e.g., 2-fold) the ratio of standard deviation (e.g., σ) to average particle diameter (e.g., Dv50).

Encapsulant: As used herein, the term “encapsulant” is used to refer to anything that is used to encapsulate a payload. For example, in many embodiments of the present disclosure, a payload component (e.g., a tastant) is described as being encapsulated by an encapsulant (e.g., polymer component, food component, material component, etc.).

Encapsulated: As used herein, the term “encapsulated” is used to refer to a characteristic of being physically associated with, and in some embodiments partly or wholly covered or coated. For example, in many embodiments of the present disclosure, a payload component (e.g., a tastant) is described as being encapsulated by a polymer component.

Flavor: As used herein, the term “flavor” is used to refer to a mix of sensations, including the scent, taste and texture of a food and/or beverage that are perceived after ingestion.

Food: As used herein, the term “food” is used to refer to an edible solid (e.g., that can be ingested, swallowed, chewed, or consumed by a person or animal without material risk to the person or animal). For example, food can be or comprise agricultural seed, baby formula, bread, candy, capsule, cake, cereal, chip, cookie, dry powder, fertilizer, food additive, ice cream, kefir, nutrition supplement, packaged food, pet feed, pet food, protein bar, protein powder, sachet, salad dressing, smoothie, spice, sprinkle packet, tablet, yogurt, etc. In some embodiments, a “food” may be or comprise a pharmaceutical formulation in solid form. In some embodiments, a “food” may generally refer to a tastant and/or food and/or beverage product. In some embodiments, a “food” may generally refer to an edible object that is intended to confer a benefit (e.g., taste, health, energy, nutrition, performance, well-being) on one or more animal(s).

Food Components: As used herein, the term “food components” is used to refer to components that makes up a composition (e.g. tastant composition), and comprises of at least one of a tastant, a tastant facilitator, a tastant modulator, a nutrient, a nutraceutical, a macronutrient, a carbohydrate, a sugar, a monosaccharide, a polysaccharide, a dietary fiber, a fat, a fatty acid, a lipid, a protein, an amino acid, a peptide, a micronutrient, a vitamin, a mineral, a polypeptide, a carotenoid, an element, a ketone body, a prebiotic (e.g., a prebiotic fiber), a polyphenol, a flavonoid, an antioxidant, an electrolyte, a salt, a circadian rhythm modulator, a supplement, a nootropic, and/or a source of energy, one or more excipient component(s), means for the controlled release of food component(s) from one or more tastant composition(s), and methods of manufacture, maintenance (e.g., storage), and/or use (e.g., administration or delivery) of one or more tastant composition(s).

Formulated Beverages: As used herein, the term “formulated beverages” is used to refer to an ingestible liquid (e.g., that can be ingested, swallowed, drank, or consumed by a person or animal without material risk to the person or animal) that provides health benefits resulting from controlled release, absorption, spatial access, concentration, and/or residence time of nutrients. Examples include protein shakes, coffee, Meal Ready-to-Drink (RTD), electrolyte beverages, sports beverages, hard seltzers (alcoholic seltzers), water, medical foods (e.g., Ready-to-drink low phenylalanine medical food), supplements, beer, wine, soda, fermented foods and beverages (e.g., yogurt, beer, etc.).

Formulated Foods: As used herein, the term “formulated foods” is used to refer to an edible solid (e.g., that can be ingested, swallowed, chewed, or consumed by a person or animal without material risk to the person or animal) that provides health benefits resulting from controlled release, absorption, spatial access, concentration, and/or residence time of nutrients. Examples include dry powders (e.g., baby formula, protein powder, drink mixes), Meal Ready-to-Eat (MRE), yogurt, cheese, freshly prepared meals, frozen meals, etc.

Formulated tastants: As used herein, the term “formulated tastants” is used to refer to an edible dosage form (e.g., that can be ingested, drank, swallowed, chewed, or consumed by a person or animal without material risk to the person or animal) such as a pill, capsule, tablet, etc. that provides taste benefits resulting from controlled release, absorption, spatial access, concentration, and/or residence time of tastants.

Formulated Meals: As used herein, the term “formulated meals” is used to refer to a solid meals (e.g., that can be ingested, swallowed, chewed, or consumed by a person or animal without material risk to the person or animal) such as microwavable meals, freshly prepared meals, frozen meals, MREs, etc., that provides health benefits resulting from controlled release, absorption, spatial access, concentration, and/or residence time of nutrients.

Formulated Supplements: As used herein, the term “formulated supplements” is used to refer to an edible dosage form (e.g., that can be ingested, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Hard Seltzers: As used herein, the term “hard seltzer” is used to refer to an ingestible liquid that contains alcohol and carbonated water.

HLB: As used herein, the term “HLB” is used to refer to the hydrophilic lipophilic balance that is an inherent property of, for example, a nonionic surfactant. In some instances, the HLB value of a given non-ionic surfactant is obtained from a commonly accessible tabular source. In some embodiments, non-ionic surfactants characterized as having a low HLB value (e.g., <8) are compatible emulsifiers for lipid systems. In some embodiments, nonionic surfactants characterized as having a high HLB value (e.g., >15) are compatible emulsifiers for aqueous systems. In some embodiments, non-ionic surfactants characterized as having an intermediate HLB value (e.g., >8 and <15) are compatible emulsifiers with both lipid and aqueous systems.

Homogenous: As used herein, the term “homogenous” means of substantially uniform structure and/or composition throughout.

Hydrophobic: As used herein, the term “hydrophobic” is used to refer to the propensity of a material to reject association, chemically and/or physically, with water. In some instances, a material characterized as being hydrophobic is biologically derived and/or synthetically derived. In some instances, a material characterized as being hydrophobic is a lipid, protein, and/or carbohydrate. In some instances, a material characterized as being hydrophobic is a polymer and/or small molecule. Alternatively, or additionally, in some embodiments, composites, mixtures, blends, or super-structures of several materials are collectively referred to as hydrophobic based on their observed propensity to reject association, chemically and/or physically, with water.

Incorporation: As used herein, the term “incorporation” is used to refer to a characteristic of being physically associated with, and in some embodiments, dispersed within, embedded within, or mixed in a bulk material (e.g., a lipid matrix component).

Layer: As used herein, the term “layer” typically refers to a material disposed above or below a distinguishable material. In some embodiments, a particular entity or preparation (e.g., particle preparation) is described as “layered” if it is prepared via a process in which a first material is laid down and then a second material is applied atop or underneath the first material (e.g., as by dipping or spraying, etc); in some such embodiments, physical or chemical distinctness of layers may be maintained over time, whereas in some such embodiments, physical or chemical distinctness of layers may decay over time, at least at layer interface(s). Alternatively or additionally, in some embodiments, a particular sample or preparation may be described as layered, independent of its mode of preparation, so long as at a particular point in time and/or using a particular mode of assessment, distinct materials can be identified in a layered structure. In some embodiments, a “layered” particle may include one or more layers that wholly encapsulate a material below. In some embodiments, a “layered” particle may include one or more layers that does not wholly encapsulate a material below. In some embodiments, at least one layer of a layered preparation is or comprises a polymer, e.g., a hydrophobic polymer or hydrophilic polymer. In some embodiments, each layer of a layered preparation is or comprises a polymer, e.g., a pH responsive polymer or a temperature-responsive polymer.

Lipid: As used herein, the term “lipid” is used to refer to a class of chemical structures characterized as hydrophobic materials. In some instances, a lipid material is derived from a biological source. In other instances, a lipid material is derived from a synthetic source. In some instances, a lipid is comprised of one or more aliphatic alcohols and/or acids linked by glycerol and/or glycol moieties. In other instances, a lipid is comprised of aliphatic chains, linear conjugated, aromatic, and/or cyclic aliphatic moieties. In some embodiments, a lipid refers to a pure chemical entity. In other embodiments, a lipid refers to a mixture of several pure chemical entities. For example, lipids include, but are not limited to: paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, or betulinic acid.

Lyophilized: As used herein, the term “lyophilized” is used to refer to the end product of a process by which water is removed from a material via sublimation. In some instances, prior to sublimation of water, the material is cooled to <−10° C., <−20° C., <−30° C., <−40° C., <−50° C., <−60° C., and/or <−70° C. In some instances, prior to the sublimation of water, the pressure is lowered to <200 torr, <150 torr, <100 torr, <50 torr, <10 torr, <5 torr, and/or <1 torr. Those skilled in the art recognize that the cooling temperature and pressure influence the physicochemical properties of the end product; it is understood that “lyophilized” ecompasses all suitable manners of cooling and vacuum protocol.

Medical Foods: As used herein, the term “medical foods” is used to refer to an edible dosage form (e.g., that can be ingested, swallowed, chewed, or consumed by a person or animal without material risk to the person or animal) such as a pill, capsule, tablet, etc. that provides health benefits resulting from controlled release, absorption, spatial access, concentration, and/or residence time of nutrients.

Nasal Cavity: As used herein, the term “nasal cavity” is used to refer to the inside of the nose.

Nutraceutical: As used herein, the terms “nutraceutical” or “nutraceutical composition” refer to a substance or material that is or comprises a nutraceutical agent (e.g., a nutraceutical). Those skilled in the art will be aware of a variety of agents understood in the art to be nutraceutical agents such as, for example, agents that are or comprise one or more antioxidants, macronutrients, micronutrients, minerals, prebiotics, probiotics, probiotic powders, probiotic ingredients, probiotic food ingredients, probiotic supplement ingredients, prebiotics, vitamins, or combinations thereof. In some embodiments, a nutraceutical is or comprises a carotenoid compound such as alpha-lipoic acid, astaxanthin, adonixanthin, adonirubin, beta-carotene, coenzyme Q10, lutein, lycopene, or zeaxanthin. In some embodiments, a nutraceutical is or comprises a vitamin such as vitamin D. In many embodiments, a nutraceutical agent is a natural product, and in certain such embodiments it is a product produced by plants. Many nutraceutical agents are compounds that have been reported or demonstrated to confer a benefit or provide protection against a disease in an animal or a plant. In some cases, nutraceuticals may be used to improve health, delay the aging process, protect against chronic diseases, increase life expectancy, or support the structure or function of the body of an animal, such as a human, a pet animal, an agricultural animal, or another domesticated animal. As used in the present disclosure, which focuses on probiotics, the term “nutraceutical composition” will generally be understood to mean a composition comprising at least one probiotic component, among other potential components (including one or more of the nutraceutical agents disclosed above). As such, as used in the present disclosure, the terms “nutraceutical composition,” “probiotic preparation,” “probiotic composition,” “particle preparation,” “microbe composition,” etc. may all be generally understood to describe compositions, preparations, and/or particles that include one or more probiotics (for example, encapsulated probiotics).

Nutrient: As used herein, the term “nutrient” is used to refer to a nutraceutical, a macronutrient, a carbohydrate, a sugar, a polysaccharide, a dietary fiber, a fat, a fatty acid, a lipid, a short-chain fatty acid, a protein, an amino acid, a peptide, a micronutrient, a vitamin, a mineral, a carotenoid, an element, a ketone body, a prebiotic, a probiotic, a postbiotic, a bacteria, a yeast, a polyphenol, a flavonoid, an antioxidant, an electrolyte, a salt, a circadian rhythm modulator, a supplement, a nootropic, a scent, a tastant, and/or a source of energy.

Oral Cavity: As used herein, the term “oral cavity” is used to comprise the lips, the inside lining of the lips and cheeks (buccal mucosa), the teeth, the gums, the front two-thirds of the tongue, the floor of the mouth below the tongue, the hard palate, the retromolar trigone, and/or the nasal cavity.

Overfortification: As used herein, the term “overfortification” is used to refer to the addition of a nutrient in excess of a label claim, due to expected nutrient degradation or loss of stability during manufacturing, processing, and/or shelf-life. This additional amount of nutrient is used to account for losses during manufacturing, processing, and/or shelf-life to still meet the nutrient label claim.

Particle: As used herein, the term “particle” is used to refer to a discrete physical entity, typically having a size (e.g., a longest cross-section, such as a diameter) within a range. For example, a particle can have a size of about 5-3000 μm, about 5-2000 μm, about 5-1000 μm, about 5-500 μm, about 5-50 μm, about 5-300 μm, about 5-200 μm, about 5-100 μm, about 5-50 μm, about 5-25 μm, or about 5-10 μm. In some embodiments, a particle may describe or include animal pellets ranging in size up to 1 mm, 5 mm, 10 mm, 25 mm, and even about 50 mm (about 2 inches) in diameter. A “particle” is not limited to a particular shape or form, for example, having a cross-section shape of a sphere, an oval, a triangle, a square, a hexagon, or an irregular shape. In some cases, particles can be solid particles. In some cases, particles can be liquid particles. In some cases, particles can be gel or gel-like particles. In some cases, particles may have a particle-in-particle structure wherein a layer of one material (e.g., one type of polymer component) encapsulates another material (e.g., another type of polymer component, which may itself encapsulate yet another, or rather may be or comprise a “core”—e.g., a polymer matrix core—of the particle).

Parts per million (ppm): As used herein, 1 ppm (“parts per million”) is equivalent to 1 milligram per liter (mg/L) or 1 milligram per kilogram (mg/kg).

Payload: In general, the term “payload”, as used herein, refers to an agent that may be delivered or transported by association with another entity. In some embodiments, such association may be or include a covalent linkage; in some embodiments such association may be or include non-covalent interaction(s). In some embodiments, association may be direct; in some embodiments, association may be indirect. The term “payload” is not limited to a particular chemical identity or type; for example, in some embodiments, a payload may be or comprise, for example, an entity of any chemical class including, for example, a scent, a tastant, a nutrient, a lipid, a metal, a nucleic acid, a polypeptide, a saccharide (e.g., a polysaccharide), small molecule, or a combination or complex thereof. In some embodiments, a payload may be or comprise a biological modifier, a detectable agent (e.g., a dye, a fluorophore, a radiolabel, etc.), a detecting agent, a nutrient, a therapeutic agent, etc., or a combination thereof. In some embodiments, a payload may be or comprise a cell or organism, or a fraction, extract, or component thereof. In some embodiments, a payload may be or comprise a natural product in that it is found in and/or is obtained from nature; alternatively or additionally, in some embodiments, the term may be used to refer to one or more entities that is man-made in that it is designed, engineered, and/or produced through action of the hand of man and/or is not found in nature. In some embodiments, a payload may be or comprise an agent in isolated or pure form; in some embodiments, such agent may be in crude form.

pH Responsive: The term “pH-responsive” is used to refer to certain polymer component(s) as described herein, and in particular means that the relevant polymer component is characterized in that one or more aspects of its structure or arrangement is altered when exposed to a change in pH condition (e.g., to a particular pH and/or to a pH change of particular magnitude). In some embodiments, a polymer component is considered to be “pH-responsive” if, when the relevant polymer component is associated with a payload component in a particle preparation as described herein, the particle preparation releases the payload component under specific pH condition(s). In some embodiments, >90% of payload component is released from a particle preparation that includes a pH-responsive polymer component within 15 minutes when the particle preparation is exposed to a particular defined pH condition (e.g., within a range of defined pH values and/or at a specific pH value); in some embodiments, such release results when such contacting occurs at temperatures between 33-40° C., and in aqueous-based buffers of ionic strength ranging from 0.001-0.151 M (e.g., water, simulated gastric fluid, gastric fluid, simulated intestinal fluid, intestinal fluid) with osmolality between 1-615 mOsm/kg. In some embodiments, a pH-responsive polymer component is one that degrades when exposed to a particular pH or pH change. Alternatively or additionally, in some embodiments, a pH-responsive polymer component is one that becomes soluble, or significantly (e.g., (e.g., by at least about 5%) increases its solubility when exposed to a particular pH level, or pH change. In some embodiments, a pH-responsive polymer component includes one or more moieties whose protonation state changes at the relevant pH or in response to the relevant pH change. For example, in some embodiments, a pH responsive polymer component includes one or more amine moieties that become protonated upon exposure to a relevant pH or pH chance.

Polyphenols: As used herein, the term “polyphenol” is used to refer to naturally occurring organic compounds, comprising one or multiple aromatic groups with one or more hydroxyl groups or hydroxyl derivatives (e.g., methoxyl, ethoxyl, acetyl, etc.) and/or deriving from the shikimate, phenylpropanoid, and/or polyketide pathways. For example, a polyphenol may be a phenolic acids, flavonoids, stilbenes, and lignans, antioxidants, tannins, and/or combinations thereof.

Prebiotic: As used herein, the term “prebiotic” is used to refer to a nondigestible food ingredient that promotes the growth of beneficial microorganisms in the intestines.

Reference: As used herein describes a standard or control relative to which a comparison is made. For example, in some embodiments, an agent, animal, individual, population, sample, sequence or value of interest is compared with a reference or control agent, animal, individual, population, sample, sequence or value. In some embodiments, a reference or control is tested and/or determined substantially simultaneously with the testing or determination of interest. In some embodiments, a reference or control is a historical reference or control, optionally embodied in a tangible medium. Typically, as would be understood by those skilled in the art, a reference or control is determined or characterized under comparable conditions or circumstances to those under assessment. Those skilled in the art will appreciate when sufficient similarities are present to justify reliance on and/or comparison to a particular possible reference or control.

Residual solvent: As used herein, the term “residual solvent” refers to a solvent that remains in a material after manufacture or processing of the material. In some embodiments, level of residual solvent is assessed by HPLC, mass spec, NMR, FTIR, and/or gas chromatography.

Satiety: As used herein, the term “satiety” refers to being full and/or sated; for example, feeling satisfied due to ingestion of a tastant composition or having a desire removed following ingestion of a tastant composition.

Stable: The term “stable,” when applied to compositions herein, means that the compositions maintain (e.g., as determined by one or more analytical assessments) one or more aspects of their physical structure and/or performance characteristic(s) (e.g., activity) over a period of time and/or under a designated set of conditions. When an assessed composition is a particle composition, in some embodiments, as will be clear from context to those skilled in the art, the term “stable” refers to maintenance of a characteristic such as average particle size, maximum and/or minimum particle size, range of particle sizes, and/or distribution of particle sizes (i.e., the percentage of particles above a designated size and/or outside a designated range of sizes) over a period of time and/or under a designated set of conditions. For tastants, stable often refers to maintenance or preservation of delivery functions (e.g., controlled release, sustained release, controlled residence time, sustained residence time, etc.), and/or scents, and/or taste.

Tastant: As used herein, the term “tastant” is used to refer to any compound and/or entity and/or chemical that provides taste and/or flavor and/or affects the taste and/or flavor of a food and/or beverage. In some embodiments, a tastant is considered to be a chemical that produces a taste sensation by activating taste receptors. In some embodiments a tastant is considered to be any compound and/or chemical and/or entity that produces activity in taste-related pathways in the nervous system. In some embodiments, a tastant can be a taste modulator. In some embodiments, a tastant can be a taste facilitator.

Taste: As used herein, the term “taste” is used to refer to a perceived sensation resulting from contact/binding of tastants with taste receptors and subsequent activation of taste-related pathways in the nervous system.

Tastant compositions: As used herein, the term “tastant compositions” is used to refer to an edible solid (e.g., that can be ingested, swallowed, chewed, or consumed by a person or animal without material risk to the person or animal) or an ingestible liquid (e.g., that can be ingested, swallowed, drank, or consumed by a person or animal without material risk to the person or animal) that provides taste benefits resulting from controlled retention time, controlled release rate, controlled adsorption/absorption rates, controlled spatial interactions and concentrations, controlled passage through selective barriers, and/or controlled taste receptor binding of one or more food component(s), tastant(s), tastant facilitator(s), or tastant modulator(s). For example, tastant compositions can be or comprise dry powders, supplements, solid foods, beverages and/or drinks, etc. In some embodiments, a “tastant composition” may be or comprise a pharmaceutical formulation in solid form. In some embodiments, a “tastant composition” may be or comprise a pharmaceutical formulation in liquid form. In some embodiments, a “tastant composition” may generally refer to a food and/or beverage product. In some embodiments, a “tastant composition” may generally refer to an edible object that is intended to improve upon the taste and/or flavor of its payload. Example tastant compositions (e.g., formulated tastants) include protein shakes, dry powders (e.g., baby formula, protein powder, drink mixes, coffee grinds), Meal Ready-to-Eat (MRE), Meal Ready-to-Drink (RTD), electrolyte beverages, sports beverages, hard seltzers (alcoholic seltzers), dry foods (e.g., rice, pasta), water, medical foods (e.g., Ready-to-drink low phenylalanine medical food), supplements, beer, wine, soda, coffee, candy, chewing gum, fermented foods and beverages (e.g., yogurt, beer, etc.); for example, MREs, Gatorade, Truly, Ensure, PKU Sphere Liquid, etc.

Taste facilitator: As used herein, the term “taste facilitator” is used to refer to any compound and/or entity and/or chemical that is characterized by an ability to facilitate passage of a payload through selective barriers and components. In certain embodiments, one or more taste facilitator(s) is characterized by an ability to penetrate into the taste bud from the mucosal, serosal or vascular environments. In certain embodiments, one or more taste facilitator(s) is characterized by reducing the activity and/or effectiveness of enzymatic components of a selective barrier. In certain embodiments, one or more taste facilitator(s) is characterized by reducing the activity and/or effectiveness of physical components of a selective barrier. In certain embodiments, one or more taste facilitator(s) is characterized by reducing the activity and/or effectiveness of molecular components of a selective barrier.

Taste modulator: As used herein, the term “taste modulator” (s) is used to refer to any compound and/or entity and/or chemical that is characterized by an ability to control the binding and/or response of a tastant to a taste receptor. In certain embodiments, one or more taste modulators(s) is characterized by potentiating the perceived taste of tastant(s). In certain embodiments, one or more taste modulator(s) is characterized by binding to G protein coupled receptors of taste cells. In certain embodiments, one or more taste modulator(s) is characterized by allosteric or orthosteric modulation of taste receptors.

Temperature-responsive: As used herein, the term “temperature-responsive” is used to refer to certain polymer component(s) as described herein, and in particular means that the relevant polymer component is characterized in that one or more aspects of its structure or arrangement is altered when exposed to a change in temperature condition (e.g., to a particular temperature and/or to a temperature change of particular magnitude). In some embodiments, a polymer component is considered to be “temperature-responsive” if, when the relevant polymer component is associated with a payload component in a particle preparation as described herein, amorphous regions of the polymer component experience a transition from a rigid state (e.g., glassy state) to a more fluid-like flexible state (e.g., more conducive to flow), at a temperature close to the point of transition from the solid state to rubbery state (e.g., glass transition).

Water activity: As used herein, “water activity” of a material is an indication (e.g., a measurement) of how much free (i.e., available to bind or react) water is present in the material, and is typically determined as the ratio of the vapor pressure of water in a material (p) to the vapor pressure of pure water (p0) at the same temperature. For example, a water activity of 0.80 means the vapor pressure is 80 percent of that of pure water. Water activity typically increases with temperature. Those skilled in the art will be familiar with three basic water activity measurement systems: Preventive Electrolytic Hygrometers (REH), Capacitance Hygrometers, and Dew Point Hygrometers (sometimes called chilled mirror).

### B. Overview

Disclosed herein, among other things, are compositions (e.g., tastant compositions (e.g., formulated tastants)) comprised of food component(s), comprising at least one of a tastant, a tastant facilitator, a tastant modulator, a nutrient, a nutraceutical, a macronutrient, a carbohydrate, a sugar, a monosaccharide, a polysaccharide, a dietary fiber, a fat, a fatty acid, a lipid, a protein, an amino acid, a peptide, a micronutrient, a vitamin, a mineral, a polypeptide, a carotenoid, an element, a ketone body, a prebiotic (e.g., a prebiotic fiber), a polyphenol, a flavonoid, an antioxidant, an electrolyte, a salt, a circadian rhythm modulator, a supplement, a nootropic, and/or a source of energy, one or more excipient component(s), means for the controlled release of food component(s) from one or more tastant composition(s), and methods of manufacture, maintenance (e.g., storage), and/or use (e.g., administration or delivery) of one or more tastant composition(s).

In some embodiments, provided tastant compositions (e.g., formulated tastants) are comprised of food component(s) and/or excipient component(s) physically or chemically arranged in a predetermined configuration. In some embodiments, provided tastant compositions (e.g., formulated tastants) are comprised of food component(s) and/or excipient component(s) physically or chemically arranged in an indeterminate configuration. In some embodiments, a predetermined physical configuration is a core-shell preparation and/or a matrix preparation and/or a layered preparation. In some embodiments, a predetermined chemical configuration is a salt, a linear oligomer, a linear polymer, a star-shaped oligomer, and/or a star-shaped polymer. In some embodiments, the configuration of one or more food component(s) establishes the means of controlled release of food component(s) from tastant composition(s).

In some embodiments, provided tastant compositions (e.g., formulated tastants) are comprised, on a dry weight basis, of a majority of food component(s), comprising at least one of a carbohydrate, a fat, a protein, a vitamin, a ketone body, and/or a polyphenol. In some embodiments, provided tastant compositions (e.g., formulated tastants) are comprised, on a dry weight basis, of at least 90% of food component(s), comprising at least one of a carbohydrate, a fat, a protein, a vitamin, a ketone body, and/or an antioxidant. In some embodiments, provided tastant compositions (e.g., formulated tastants) are comprised, on a dry weight basis, of at least 99% of food component(s), comprising at least one of a carbohydrate, a fat, a protein, a vitamin, a ketone body, and/or an antioxidant. In some embodiments, one or more food component(s) establishes the means of controlled release of food component(s) from tastant composition(s).

In some embodiments according to the present disclosure, a combination of one or more food component(s) and their configuration establishes the means of controlled release of food component(s) from tastant composition(s).

The present disclosure provides one or more tastant composition(s) characterized as providing a means of controlled release of one or more food component(s) comprising one or more food component(s) and their arrangement. In some embodiments, the present disclosure leverages (e.g., understanding and repurposing) the physical and/or chemical traits of one or more food component(s) to control the interaction of one or more tastant composition(s) in one or more animal(s).

In some embodiments, one or more tastants, nutrients, nutraceuticals, macronutrients, carbohydrates (e.g., one or more carbohydrate components), proteins (e.g., one or more protein components), fats (e.g., one or more fat components), micronutrients, vitamins, minerals, polyphenols, electrolytes, salts, ketone bodies, prebiotics, polymers, or combinations thereof are used to encapsulate a food component and/or core-shell and/or matrix preparations comprising one or more tastant composition(s).

In some embodiments, one or more hydrophobic materials, hydrophilic materials, and/or amphiphilic materials are used to encapsulate a food component and/or core-shell and/or matrix preparations comprising one or more tastant composition(s).

In some embodiments, one or more responsive properties of one or more food component(s) enables the means of controlled release of food component(s) from tastant composition(s). In some embodiments, properties of one or more food component(s) advantageous to establishing means of controlled release include, but are not limited to, response to pH, response to temperature, response to water, response to mechanical forces, response to endogenous chemical or enzymatic triggers, response to exogenous chemical or enzymatic triggers, response to osmotic pressure, and/or response to time.

In some embodiments, one or more interfacial properties of one or more food component(s) enables the means of controlled release of food component(s) from tastant composition(s). In some embodiments, properties of one or more food component(s) advantageous to establishing means of controlled release include, but are not limited to, mucoadhesion, bioadhesion, size, and/or shape.

In some embodiments, a combination of one or more responsive properties and one or more interfacial properties of one or more food component(s) establishes the means of controlled release of food component(s) from tastant composition(s).

### C. Tastant Compositions and Means of Controlled Release of One or More Food Component(s) from One or More Tastant Composition(s)

### 1. Tastant Composition(s)

In some aspects, the provided tastant composition(s) are comprised of one or more food component(s) (e.g. tastants, etc.), as described herein, in a predetermined physical and/or chemical configuration, as described herein. In some aspects, the provided tastant composition(s) are comprised of one or more food component(s) (e.g. tastants, etc.), as described herein, in an indeterminate physical and/or chemical configuration. In some aspects, the configuration of the food component(s) (e.g. tastants, etc.) comprising a tastant composition establishes a means of controlled release of food component(s) (e.g. tastants, etc.). In some aspects, the selection of food component(s) comprising one or more tastant compositions (e.g., formulated tastants) establish a means of controlled release of food component(s) (e.g. tastants, etc.).

In some embodiments, the provided tastant composition(s) are comprised of one food component (e.g. tastant, etc.). In some embodiments, the provided tastant composition(s) are comprised of several food components (e.g. tastants, etc.). In some embodiments, the arrangement of a single food component is used as a means of controlling the release of one or more food component(s) (e.g. tastants, etc.). In some embodiments, the arrangement of several food components is used as a means of controlling the release of one or more food component(s) (e.g. tastants, etc.).

In some embodiments, the provided tastant composition(s) are comprised of one or more food component(s) (e.g. tastants, etc.), as described herein, characterized by their taste benefits. In certain embodiments, one or more food component(s) characterized as material(s) providing a taste, flavor, and/or taste benefit upon consumption (e.g., an advantage conferred upon consumption) are additionally characterized as providing a means for the controlled release of one or more food component(s) (e.g. tastants, etc.).

(i) Food Component(s) Providing a Taste, Flavor, and/or Taste/Health Benefit

In certain embodiments, one or more tastant composition(s) are comprised of one or more food component(s). In certain embodiments, one or more food component(s) are characterized as material(s) providing a taste, flavor, and/or taste/health benefit upon consumption (e.g., an advantage conferred upon consumption) by one or more animals. In certain embodiments, a taste benefit is controlling the intensity of taste. In certain embodiments, a taste benefit is controlling the duration of taste. In certain embodiments, a taste benefit is controlling the onset of taste. In certain embodiments, a health benefit is the control of physiological reflexes (e.g., pancreatic secretions). In certain embodiments, a health benefit is the reduction of salt and/or sugar and/or fat in a tastant composition. In certain embodiments, one or more tastant composition(s) comprised of one or more food component(s) provide one, two, several, or all, of the following subset of taste and health benefits: controlled intensity of taste, controlled duration of taste, controlled onset of taste, control of physiological reflexes, and/or reduction of salt and/or sugar and/or fat.

In certain embodiments, taste, flavor, and/or taste/health benefits conferred upon consumption (e.g., an advantage conferred upon consumption) by one or more food component(s) are enabled by one or more delivery function(s). In certain embodiments, one or more food component(s) are characterized as material(s) providing a delivery function upon consumption (e.g., a utility conferred upon consumption) by one or more animals. In certain embodiments, a delivery function is extending retention time of payload in the oral cavity. In certain embodiments, a nutritional benefit is controlling payload release rate. In certain embodiments, a nutritional benefit is controlling payload adsorption/absorption rates. In certain embodiments, a nutritional benefit is controlling payload spatial interactions and concentrations within and around the oral cavity and specific areas (e.g. tongue, throat, nasal cavities, mucosa, epithelium, taste buds, microvilli, taste bud cell, etc.). In certain embodiments, a nutritional benefit is facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.). In certain embodiments, a nutritional benefit is controlling binding of payload to taste receptors. In certain embodiments, one or more tastant composition(s) comprised of one or more food component(s) provide one, two, several, or all, of the following subset of delivery functions: extending retention time, controlling release rate, controlling adsorption/absorption rates, controlling spatial interaction and concentrations, and facilitating passage through selective barriers and components).

In certain embodiments, as described herein, one or more food component(s) providing a taste, flavor, and/or taste benefit upon consumption may be characterized as being at least one of: a carbohydrate, a protein, a fat, and/or a ketone body.

As provided herein, one or more food component(s) characterized as being a carbohydrate may be or comprises at least one carbohydrate. In some instances, food component(s) characterized as being a carbohydrate can be a combination of carbohydrates, each of which may or may not individually provide a taste, flavor, and/or taste/health benefit.

For example, in some instances, one or more food component(s) characterized as being a carbohydrate may comprise glucose, fructose, mannitol, allulose, sorbitol, xylitol, erythritol, lactitol, galactose, sucrose, maltodextrin, isomaltulose, glycogen, chitosan, guar gum, pullulan, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, and/or sodium carboxymethylcellulose.

As provided herein, one or more food component(s) characterized as being a protein may be or comprises at least one protein. In some instances, food component(s) characterized as being a protein can be a combination of proteins, each of which may or may not individually provide a taste, flavor, and/or taste/health benefit.

For example, in some instances, one or more food component(s) characterized as being a protein may comprise pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, and/or legumin.

As provided herein, one or more food component(s) characterized as being a fat may be or comprises at least one fat. In some instances, food component(s) characterized as being a fat can be a combination of fats, each of which may or may not individually provide a taste, flavor, and/or taste/health benefit.

For example, in some instances, one or more food component(s) characterized as being a fat may comprise paraffin wax, montan wax, microcrystalline wax, polyethylene wax, petrolatum wax, ozokerite wax, ceresin wax, beeswax, lanolin wax, spermaceti wax, tallow wax, lac wax, chinese insect wax, ambergris wax, soy wax, carnauba wax, candelilla wax, coconut wax, palm kernel wax, rice bran wax, butyric acid, n-butanol, pentanoic acid, n-pentanol, hexanoic acid, n-hexanol, heptanoic acid, n-heptanol, caprylic acid, n-octanol, nonanoic acid, n-nonanol, capric acid, n-decanol, lauric acid, n-dodecanol, myristic acid, n-tetradecanol, palmitic acid, n-hexadecanol, stearic acid, n-octadecanol, arachidonic acid, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, fatty alcohol poly(glycerol) ethers, fatty acid poly(glycerol) esters, fatty alcohol poly(glycol) ethers, fatty acid poly(glycol) esters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, cholesterol, cholenic acid, ursolic acid, or betulinic acid.

As provided herein, one or more food component(s) characterized as being a polyunsaturated fatty acid may be or comprises at least one polyunsaturated fatty acid. In some instances, food component(s) characterized as being a polyunsaturated fatty acid can be a combination of polyunsaturated fatty acids, each of which may or may not individually provide a taste, flavor, and/or taste/health benefit.

For example, in some instances, one or more food component(s) characterized as being a polyunsaturated fatty acid may comprise at least one of medium-chain triglyceride, docosahexaenoic acid, eicosapentaenoic acid, arachidonic acid, linoleic acid, linolenic acid, oleic acid, parinaric acid, rumenic acid, or combinations thereof.

As provided herein, one or more food component(s) characterized as being a ketone body may be or comprises at least one ketone body. In some instances, food component(s) characterized as being a ketone body can be a combination of ketone bodies, each of which may or may not individually provide a taste, flavor, and/or taste/health benefit.

For example, in some instances, one or more food component(s) characterized as being a ketone body may comprise acetoacetate, R-β-hydroxybutyl R-β-hydroxybutyrate, β-hydroxybutyrate, R-3-hydroxybutyl R-3-hydroxybutyrate monoester, and/or 1,3-butanediol.

In certain embodiments, the provided tastant composition(s) are comprised of one or more food component(s) that each individually provide one or more taste, flavor, and/or taste benefit upon consumption. In certain embodiments, the provided tastant composition(s) are comprised of one or more food component(s) that each individually exhibit one or more delivery functions upon consumption.

### (ii) Food Component(s) Providing for Controlled Taste

In certain embodiments, one or more food component(s) comprising the provided tastant composition(s) provide for controlled taste. Controlled taste may be characterized as one or more of any taste/health benefits (e.g. controlled intensity of taste, controlled duration of taste, controlled onset of taste, and/or control of physiological reflexes, and/or reduction of salt and/or sugar and/or fat) and is enabled by a delivery function of a food component(s) (e.g. extending retention time, controlling release rate, controlling adsorption/absorption rates, controlling spatial interaction and concentrations, and facilitating passage through selective barriers and components). Typically, as described herein, one or more food component(s) providing for controlled taste is or are characterized as being at least one of: a tastant, a tastant facilitator, a tastant modulator, a nutrient, a nutraceutical, a macronutrient, a micronutrient, a polyphenol, a metal, a cofactor, a vitamin, an antioxidant, a mineral, an amino acid, a peptide, a ketone, an electrolyte, a salt, a protein, a carbohydrate, a sugar, a polysaccharide, a fat, a lipid, a fatty acid, a prebiotic, a dietary fiber, a carotenoid, a circadian rhythm modulator, a supplement, a nootropic, and/or a source of energy.

In some embodiments, one or more food component(s) comprising the provided tastant composition(s) may comprise a formulated food component (e.g., food ingredient, ingredient, formulated tastant, encapsulated tastant).

As provided herein, one or more food component(s) characterized as being a metal may be or comprises at least one metal. In some instances, food component(s) characterized as being a metal can be a combination of metals, each of which may or may not individually provide for the health of one or more animal(s).

For example, in some instances, one or more food component(s) characterized as being a metal may comprise calcium, chromium, cobalt, copper, iodine, iron, magnesium, manganese, molybdenum, potassium, selenium, sodium, and/or zinc.

As provided herein, one or more food component(s) characterized as being a cofactor may be or comprises at least one cofactor. In some instances, food component(s) characterized as being a cofactor can be a combination of cofactors, each of which may or may not individually provide for the health of one or more animal(s).

For example, in some instances, one or more food component(s) characterized as being a cofactor may comprise nicotinamide adenine dinucleotide, flavin adenine dinucleotide, adenosine triphosphate, S-adenosylmethionine, Coenzyme Q, glutathione, heme, lipoamide, molybdopterin, and/or tetrahydrobiopterin.

As provided herein, one or more food component(s) characterized as being a vitamin may be or comprises at least one vitamin. In some instances, food component(s) characterized as being a vitamin can be a combination of vitamins, each of which may or may not individually provide for the health of one or more animal(s).

For example, in some instances, one or more food component(s) characterized as being a vitamin may comprise trans-retinol, trans-β-carotene, thiamine, riboflavin, niacin, niacinamide, nicotinamide riboside, pantothenic acid, pyridoxine, pyridoxamine, pyridoxal, biotin, folic acid, cyanocobalamin, hydroxocobalamin, methylcobalamin, adenosylcobalamin, ascorbic acid, cholecalciferol, ergocalciferol, tocopherol, tocotrienol, phylloquinone, and/or menaquinone.

As provided herein, one or more food component(s) characterized as being an antioxidant may be or comprises at least one antioxidant. In some instances, food component(s) characterized as being an antioxidant can be a combination of antioxidants, each of which may or may not individually provide for the health of one or more animal(s).

For example, in some instances, one or more food component(s) characterized as being a polyphenol and/or an antioxidant may comprise tannic acid, ellagitannin, apigenin, luteolin, tangeritin, isorhamnetin, kaempferol, myricetin, quercetin, rutin, eriodictyol, genipin, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, and/or betanin.

As provided herein, one or more food component(s) characterized as being a mineral may be or comprises at least one mineral. In some instances, food component(s) characterized as being a mineral can be a combination of minerals, each of which may or may not individually provide for the health of one or more animal(s).

For example, in some instances, one or more food component(s) characterized as being a mineral may comprise iron oxide, calcium chloride, calcium carbonate, and/or calcium hydroxyapatite.

As provided herein, one or more food component(s) characterized as being an amino acid may be or comprises at least one amino acid. In some instances, food component(s) characterized as being an amino acid can be a combination of amino acids, each of which may or may not individually provide for the health of one or more animal(s).

For example, in some instances, one or more food component(s) characterized as being an amino acid may comprise alanine, arginine, asparagine, aspartic acid, cysteine, selenocysteine, glutamine, glutamic acid, glycine, histidine, isoleucine, leucine, lysine, methionine, phenylalanine, proline, serine, threonine, tryptophan, tyrosine, valine, norvaline, norleucine, pipecolic acid, ornithine, homocysteine, homoserine, isovaline, and/or sarcosine.

As provided herein, one or more food component(s) characterized as being a branched chain amino acid may be or comprises at least one branched chain amino acid. In some instances, food component(s) characterized as being a branched chain amino acid can be a combination of branched chain amino acids, each of which may or may not individually provide for the health of one or more animal(s).

For example, in some instances, one or more food component(s) characterized as being a branched chain amino acid may comprise isoleucine, leucine, and/or valine.

As provided herein, one or more food component(s) characterized as being a peptide may be or comprises at least one peptide. In some instances, food component(s) characterized as being a peptide can be a combination of peptides, each of which may or may not individually provide for the health of one or more animal(s).

For example, in some instances, one or more food component(s) characterized as being a peptide may comprise aspartame, GLP-1, GLP-2, collagen, sermorelin, tesamorelin, lenomorelin, anamorelin, ipamorelin, macimorelin, ghrelin, tabimorelin, alexamorelin, GHRP-1, GHRP-2, GHRP-3, GHRP-4, GHRP-5, GHRP-6, and/or hexarelin.

As provided herein, one or more food component(s) characterized as being a dietary fiber may be or comprises at least one dietary fiber. In some instances, food component(s) characterized as being a dietary fiber can be a combination of dietary fibers, each of which may or may not individually provide for the health of one or more animal(s).

For example, in some instances, one or more food component(s) characterized as being a dietary fiber may comprise cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, and/or sodium carboxymethylcellulose.

As provided herein, one or more food component(s) characterized as being at least one macronutrient. In some instances, a macronutrient is or comprises at least one carbohydrate, at least one fat, at least one protein, or a combination thereof.

As provided herein, one or more food component(s) characterized as being at least one fatty acid. In some instances, a fatty acid is or comprises at least one of medium-chain triglyceride, docosahexaenoic acid, eicosapentaenoic acid, or combinations thereof.

As provided herein, one or more food component(s) characterized as being at least one short chain fatty acid. In some instances, a short chain fatty acid is or comprises acetate, propionate, and butyrate, or a combination thereof.

As provided herein, one or more food component(s) characterized as being a carotenoid may be or comprises at least one carotenoid. In some instances, food component(s) characterized as being a carotenoid can be a combination of carotenoids, each of which may or may not individually provide for the health of one or more animal(s).

For example, in some instances, one or more food component(s) characterized as being a carotenoid may comprise alpha-lipoic acid, lycopene, β-carotene, lutein, zeaxanthin, adonixxanthin, adonirubin, meso-zeaxanthin, astaxanthin, capsanthin, citroxanthin, echinenone, astacein, bixin, crocetin, and/or peridin.

As provided herein, one or more food component(s) characterized as being a circadian rhythm modulator may be or comprises at least one circadian rhythm modulator. In some instances, food component(s) characterized as being a circadian rhythm modulator can be a combination of circadian rhythm modulators, each of which may or may not individually provide for the health of one or more animal(s).

For example, in some instances, one or more food component(s) characterized as being a circadian rhythm modulator may comprise melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, and/or taurine.

(iii) Excipient Components

In certain embodiments, one or more component(s) comprising one or more tastant composition(s) may be further characterized as an excipient component.

In some embodiments, an excipient component utilized in accordance with the present disclosure is or comprises components that are not one or more food component(s) as described herein.

In some embodiments, an excipient component is or comprises at least one anti-caking (e.g., anti-agglomerating, anti-clumping, anti-aggregating) component, surfactant component, plasticizing component, acid scavenger (e.g., buffering agent), moisture scavenger, water scavenger, oxygen scavenger, a desiccant, a polymer, a preservative, a colorant, a flavoring, an antioxidant, a humectant, a solvent, or a combination thereof. In some embodiments, an excipient component imparts a benefit (e.g., reduced caking, increased stability, increased solubility, improved physical properties, improved taste, improved longevity, increased biocompatibility) on one or more tastant composition(s). In some embodiments, an excipient component imparts a change to the environment within the tastant composition (e.g., pH change, color change, oxygen concentration change, water concentration change). In some embodiments, an excipient component imparts a change (e.g., pH change, oxygen concentration change, flavor change, water concentration change) to the local environment (e.g., stomach, food matrix, beverage) where the tastant composition resides at a point in time. In some embodiments, an excipient component increases and/or decreases the solubility of one or more food component(s) in one or more tastant composition(s) upon mixing in one or more dissolution solvent(s).

Excipient components exhibiting one or more of anti-caking (e.g., anti-agglomerating, anti-clumping, anti-aggregating), surfactant, plasticizing, acid scavenger (e.g., buffering agent), moisture scavenger, water scavenger, desiccant, polymer, preservative, colorant, flavoring, antioxidant, humectant, and/or solvent properties may be comprised of substance(s) identified by one or more governing bodies as safe (e.g., generally regarded as safe and/or food additives). In some instances, those skilled in the art will appreciate that excipient component(s) are or may be selected from those excipient(s) recognized as Generally Regarded as Safe (i.e., GRAS) by the U.S. Food and Drug Administration. In some instances, those skilled in the art will appreciate that excipient component(s) are or may be selected from those excipient(s) recognized in 21 C.F.R. 184. In some instances, those skilled in the art will appreciate that excipient component(s) are or may be selected from those excipient(s) recognized in GB2760-2014 by the National Health and Family Planning Commission of the People's Republic of China.

In some cases, an excipient component is or comprises a single excipient species. In some instances, an excipient component can comprise multiple excipients and combinations thereof.

In some embodiments, excipients are added to one or more tastant composition(s) during a manufacturing process. In some embodiments, one or more shell component(s), core component(s), matrix component(s), and/or solute component(s) further comprise an excipient component. In certain embodiments, excipients are added to one or more tastant composition(s) prior to consumption.

In some cases, an excipient component is at least about 10 wt %, at least about 5 wt %, at least about 1 wt %, at least about 0.8 wt %, at least about 0.5 wt %, and/or at least about 0.1 wt % of one or more tastant composition(s).

In some cases, an excipient component can lower water activity of tastant compositions (e.g., formulated tastants).

In some cases, an excipient component can lower moisture content of tastant compositions (e.g., formulated tastants).

In some cases, an excipient component can lower residual solvent content of tastant compositions (e.g., formulated tastants).

In some cases, an excipient component can reduce the friability of tastant compositions (e.g., formulated tastants).

In some cases, an excipient component can improve the flowability of tastant compositions (e.g., formulated tastants).

In some cases, an excipient component can reduce clumping upon storage of tastant compositions (e.g., formulated tastants).

In some cases, an excipient component can improve the solubility of one or more food component(s) comprising one or more tastant composition(s).

In some cases, an excipient component can improve the mixing of one or more food component(s) with one or more dissolution solvent(s).

In some cases, an excipient component can improve the mixing of one or more food component(s) with one or more food products(s).

In some cases, an excipient component can improve the mixing of one or more food component(s) with one or more beverage products(s).

In some cases, an excipient component can improve the mixing of one or more food component(s) with one or more supplement products(s).

In some cases, an excipient component can improve the mixing of one or more food component(s) with other food component(s).

In some cases, an excipient component can either raise or lower the elastic modulus of tastant compositions (e.g., formulated tastants). In some cases, this may enable or facilitate methods of formulating or manufacturing tastant compositions (e.g., formulated tastants).

In some cases, an excipient component can either raise or lower the crystallinity of tastant compositions (e.g., formulated tastants).

In some cases, an excipient component can either alter and/or maintain the pH of a tastant composition. In some embodiments, excipient components used as a means of maintaining pH are additionally used as a means of gas generation. Without wishing to be bound by any particular theory, generation of gas within one or more tastant composition(s) may reduce the density of a tastant composition and introduce buoyancy leading to increased residence time in one or more gastrointestinal compartments.

In some cases, an excipient component can either react with environmental molecular oxygen or introduce molecular oxygen towards one or more tastant composition(s).

In some cases, an excipient component is essential to triggered release, as described herein, for one or more food component(s) from one or more tastant compositions (e.g., formulated tastants).

In some cases, an excipient component can alter pH within the microenvironment (e.g., stomach, food matrix, beverage) where the tastant composition resides.

In some cases, an excipient component affects response of the tastant composition to heat.

In some cases, an excipient component affects response of the tastant composition to shear.

In some cases, an excipient component affects response of the tastant composition to elevated pressure.

In some cases, an excipient component prevents fouling (e.g., microbial growth) of one or more tastant compositions (e.g., formulated tastants) over a period of at least 4 weeks, at least 12 weeks, at least 6 months, at least 1 year, at least 2 years, at least 5 years, and/or at least 10 years.

In some cases, an excipient component improves the taste and/or fragrance of one or more tastant composition(s).

In some cases, an excipient component improves the texture and/or mouthfeel of one or more tastant composition(s).

In some cases, an excipient component maintains the water activity of one or more tastant composition(s).

In some cases, an excipient component provides a visually pleasing appearance to one or more tastant composition(s).

In some cases, an excipient component can affect the stability of one or more tastant composition(s) towards light, heat, pressure, shear, enzymes, bacteria, and/or one or more dissolution solvent(s) as described herein.

### 2. Food Component(s) Providing a Means for Controlled Release of Food Component(s)

In certain embodiments, one or more tastant composition(s) are comprised of one or more food component(s). In certain embodiments, one or more food component(s) are characterized as material(s) providing a means of controlled release. In certain embodiments, release of one or more food component(s) from one or more tastant composition(s) is characterized by physical and/or chemical dissociation. In some cases, release of one or more food component(s) from one or more tastant composition(s) is characterized by the amount of one or more food component(s) released from one or more tastant composition(s) in the presence of one or more dissolution solvent(s) (e.g., dissolution). In some cases, release of one or more food component(s) from one or more tastant composition(s) is characterized by the rate of one or more food component(s) released from one or more tastant composition(s) in the presence of one or more dissolution solvent(s) (e.g., release rate). In some cases, the release of one or more food component(s) from one or more tastant composition(s) is characterized by a combination of amount of dissolution and/or release rate (e.g., release profile).

Those skilled in the art will appreciate that one or more food component(s) may be essentially characterized by solubility. Those skilled in the art will further appreciate that one or more food component(s) may be characterized as slightly soluble, partially soluble, and/or completely soluble in one or more dissolution solvent(s). Those skilled in the art will further appreciate that solubility of one or more food component(s) may be achieved by physical and/or chemical dispersal of one more food component(s) within one or more dissolution solvent(s). Those skilled in the art will further appreciate that the dispersal (e.g., dissolution) of one or more food component(s) in one or more dissolution solvent(s) relevant to a useful (e.g., to provide a taste and/or health benefit) application of one or more technologies may be further characterized as release.

Without wishing to be bound by any particular theory, it is contemplated that the solubility characteristic(s) of one more food component(s) is an important factor(s) determining their perceivable taste. Without wishing to be bound by any particular theory, it is contemplated that the solubility characteristic(s) of one more food component(s) is an important factor(s) determining their absorption in the mucosa. Without wishing to be bound by any particular theory, it is contemplated that the solubility characteristic(s) of one more food component(s) is an important factor(s) determining their absorption in the epithelium. Without wishing to be bound by any particular theory, it is contemplated that the solubility characteristic(s) of one more food component(s) is an important factor(s) determining their passage into and within a taste bud. Without wishing to be bound by any particular theory, it is contemplated that the solubility characteristic(s) of one more food component(s) is an important factor(s) determining their kinetics of binding to a protein receptor. Without wishing to be bound by any particular theory, a means of controlling the release of one or more food component(s) may be characterized as a means of controlling the solubilization of one or more food component(s) (e.g., release modifier).

In certain embodiments of the present disclosure, means of controlling the release of one or more food component(s) from one or more tastant composition(s) are provided. In certain embodiments, one or more food component(s) provides a means of controlling the release of one or more food component(s) from one or more tastant composition(s).

In some embodiments, a means of controlling the release of one or more food component(s) from one or more tastant composition(s) may be characterized by at least one of: (i) controlling access of one or more dissolution solvent(s) to one or more food component(s) (e.g., core-shell preparation) and/or (ii) diffusivity of one or more food component(s) (e.g., matrix preparation).

In certain embodiments, a means of controlling the release of one or more food component(s) from one or more tastant composition(s) characterized as core-shell and/or matrix preparations is further characterized as controlling the chemical properties and/or chemical structure of one or more food component(s), modulators of gastrointestinal residence time, and/or trigger-responsive materials.

### (i) Core-Shell Preparations

Among other things, the present disclosure provides core-shell preparations (e.g., tastant compositions (e.g., formulated tastants)) as a means of controlling the release of one or more food component(s) from one or more tastant composition(s). For example, in some embodiments, one or more tastant composition(s) are or comprise core-shell preparations. For example, core-shell preparations may comprise a core component (e.g., interior component) and/or a shell component (e.g., coating, exterior component), each of which are essentially comprised of one or more food component(s), as described herein. In some embodiments, a core component is comprised of one or more food component(s) and/or one or more excipient component(s). In some embodiments, a shell component is comprised of one or more food component(s) and/or one or more excipient component(s).

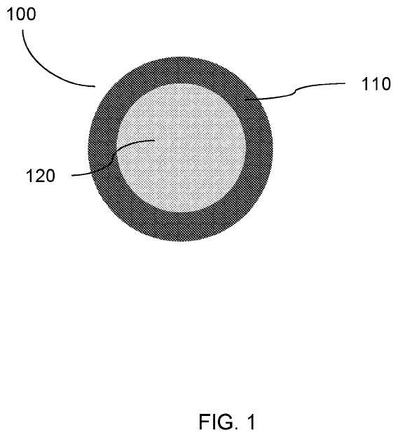

As depicted in a non-limiting schematic in FIG. 1, in some embodiments, an exemplary core-shell preparation may comprise a formulation comprising at least one food component and/or one excipient component arranged as a core component and at least one food component and/or one excipient component arranged as a shell component. In some embodiments, the at least one food component and/or one excipient component comprising a core component are additionally the at least one food component and/or one excipient component comprising a shell component. In some embodiments, the at least one food component and/or one excipient component comprising a core component are different from the at least one food component and/or one excipient comprising a shell component.

As depicted in a non-limiting schematic in FIG. 1, in some embodiments, an exemplary core-shell preparation 100 may comprise a core component 120 comprising at least one food component and/or at least one excipient component. In some embodiments, an exemplary core-shell preparation 100 may comprise a shell component 110 comprising at least one food component and/or at least one excipient component.

In some embodiments, the at least one food component and/or at least one excipient component comprising exemplary core component 120 is different from the at least one food component and/or at least one excipient component comprising exemplary shell component 110. In some embodiments, the at least one food component and/or at least one excipient component comprising exemplary core component 120 is the same as the at least one food component and/or at least one excipient component comprising exemplary shell component 110.

In some embodiments, the exemplary core component 120 is comprised of a single food component and/or excipient component. In some embodiments, the exemplary core component 120 is comprised of several food components and/or excipient components. In some embodiments, the exemplary shell component 110 is comprised of a single food component and/or excipient component. In some embodiments, the exemplary shell component 110 is comprised of several food components and/or excipient components.

In some embodiments, at least one food component and/or excipient component 120 may be described as being dispersed within (e.g., embedded within) at least one shell component 110.

In some embodiments, at least one shell component 110 may be described as encapsulating at least one core component 120, comprising at least one food component and/or excipient component.

In some embodiments, one or more core component(s) and/or a shell component(s) may be further characterized as a matrix preparation. In some embodiments one or more core component(s) and/or shell component(s) comprise a matrix preparation.

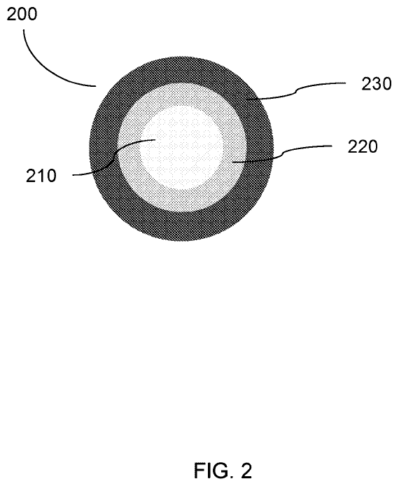

As depicted in a non-limiting schematic in FIG. 2, in some embodiments, an exemplary core-shell preparation may comprise a formulation comprising multiple layers of at least one food component and/or one excipient component arranged as a core component and at least one food component and/or one excipient component arranged as at least one shell component.

As depicted in a non-limiting schematic in FIG. 2, in some embodiments, an exemplary core-shell preparation 200 may comprise a core component 210 comprising at least one food component and/or excipient component, at least one shell component 220 comprising at least one food component and/or excipient component, and/or a second shell component 230 comprising at least one food component and/or excipient component.

In some embodiments, at least one core-shell composition 220 and 210 may be described as being dispersed within (e.g., embedded within) at least one shell component 230.

In some embodiments, at least one shell component 230 may be described as encapsulating at least one core-shell preparation and/or matrix preparation 210 and 220.

In some embodiments, at least one payload component 120, at least one excipient component 130, at least one matrix component 140, or a combination thereof may be described as being dispersed within (e.g., encapsulated in) at least one carrier component 110.

In some embodiments, one or more core-shell preparation(s) are encapsulated in a range of 1-15, 1-10, 1-8, 1-6, 1-4, and/or 1-2 distinct shell component(s). In some embodiments, one or more core component(s) may be characterized as a core-shell preparation. In some embodiments, a core-shell preparation is further encapsulated in 1 shell component. In other embodiments, a core-shell preparation is encapsulated in 2 layered shell components.

In certain embodiments, a core-shell preparation is encapsulated in a range of 1-15, 1-10, 1-8, 1-6, 1-4, and/or 1-2 shell component(s) that are homogeneously blended. In certain embodiments, the core-shell preparations are encapsulated in a range of 1-15, 1-10, 1-8, 1-6, 1-4, and/or 1-2 shell components that are subsequently encapsulated in a range of 1-15, 1-10, 1-8, 1-6, 1-4, and/or 1-2 shell components.

In some embodiments, one or more food component(s) comprising a shell component and/or a core component is characterized as being a liquid. In some embodiments, one or more food component(s) comprising a shell component and/or a core component is characterized as being a solid.

In some embodiments, provided core-shell preparations may be characterized as a particle (e.g., particle preparation), an emulsion, a suspension, a powder, a bar, a gel, a capsule, a tablet, a fiber, an extrudate, a hard candy, a chip, and/or a mesh.

In certain aspects, one or more core-shell preparation(s) comprising one or more tastant composition(s) may be further characterized as an emulsion. In certain embodiments, one or more emulsion(s) present in one or more tastant composition(s) comprise one or more shell component(s), one or more core component(s), or both shell component(s) and core component(s) characterized by low solubility (e.g., miscibility) in water. Additionally, or alternatively, one or more emulsion(s) present in one or more tastant composition(s) comprise one or more shell component(s), one or more core component(s), or both shell component(s) and core component(s) of amphiphilic nature. In certain embodiments, one or more core-shell preparation(s) further characterized as an emulsion may be described as having one or more core component(s) of low solubility (e.g., miscibility) in water and one or more shell component(s) of amphiphilic nature. In certain embodiments, one or more core-shell preparation(s) further characterized as an emulsion may be described as having one or more core component(s) of high solubility (e.g., miscibility) in water and one or more shell component(s) of amphiphilic nature. In certain embodiments, one or more emulsion(s) are prepared prior to consumption by one or more animal(s). In certain embodiments, one or more emulsion(s) form spontaneously upon addition to one or more dissolution solvent(s). In certain embodiments, one or more emulsion(s) form spontaneously upon exposure to one or more triggers. For example, in certain embodiments, one or more emulsion(s) form spontaneously in response to cross-linkers, pH, bile salts, surfactants, reducing and/or oxidizing agents, osmotic pressure, proteases, amylases, lipases, bacteria, yeast, transglutaminases, thrombin, temperature, time, and/or mechanical forces.

In certain embodiments, core-shell preparations (e.g., tastant compositions) are characterized as a means of controlling the release of one or more food component(s). In certain embodiments, one or more shell component(s) controls the release profile of one or more core component(s). In certain embodiments, one or more core component(s) controls the release profile of one or more shell component(s). In certain embodiments, control of the release of one more core component(s) is achieved by one or more shell component(s) providing a physical barrier to a dissolution solvent, controlling the diffusivity of one or more core component(s), controlling the chemical properties of one or more core component(s), controlling residence time of one or more core component(s) in the dissolution medium, and/or responsiveness to one or more triggers, as described herein. In certain embodiments, control of the release of one more shell component(s) is achieved by one or more core component(s) controlling the diffusivity of one or more shell component(s), controlling the chemical properties of one or more shell component(s), controlling residence time of one or more shell component(s) in the dissolution medium, and/or responsiveness to one or more triggers, as described herein.

In certain embodiments, one or more shell component(s) provides a physical barrier between a dissolution solvent and one or more core component(s). For example, in some embodiments, one or more shell component(s) may be characterized as insoluble in aqueous media (e.g., water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer). For example, in some embodiments, one or more shell component(s) may be characterized by slow and/or zero-order solubilization in aqueous media. Without wishing to be bound by any particular theory, it is contemplated that one or more shell component(s) characterized by insolubility, slow, and/or zero-order solubilization in aqueous media prevent access of such aqueous media to one or more core component(s), thus preventing dissolution (e.g., release) of one or more core component(s).

In certain embodiments, one or more shell component(s) controls the chemical properties of one or more core component(s). In certain embodiments, one or more core component(s) controls the chemical properties of one or more shell component(s). For example, in some embodiments, one or more shell component(s) may be ionically and/or covalently bonded (i.e., associated, complexed) to itself (e.g., a polymer and/or a crystal) and/or one or more core component(s). Additionally, or alternatively, one or more core component(s) may be ionically and/or covalently bonded (i.e., associated, complexed) to itself (e.g., a polymer and/or a crystal) and/or one or more shell component(s). Without wishing to be bound by any particular theory, it is contemplated that ionic and/or covalent bonding of one or more core component(s) with itself and/or one or more shell component(s) may reduce its solubility, increase hydrophobicity, and/or increase molecular weight of the core component, thereby reducing diffusivity and release. Without wishing to be bound by any particular theory, it is contemplated that ionic and/or covalent bonding of one or more shell component(s) with itself and/or one or more core component(s) may reduce its solubility, increase hydrophobicity, and/or increase molecular weight of the shell component, thereby reducing diffusivity and release. In some embodiments, one or more shell component(s) performs a chemical reaction on one or more core component(s) to change its molecular weight and/or introduce a new chemical functionality. In some embodiments, one or more core component(s) performs a chemical reaction on one or more shell component(s) to change its molecular weight and/or introduce a new chemical functionality. Without wishing to be bound by any particular theory, it is contemplated that one or more component(s) performing chemical reactions to reduce the molecular weight of a core component or a shell component may increase the release of one or more component(s) from a core-shell preparation.

In certain embodiments, one or more shell component(s) controls the chemical properties of one or more core component(s). In certain embodiments, one or more core component(s) controls the chemical properties of one or more shell component(s). For example, in some embodiments, one or more shell component(s) may be non-covalently bonded (e.g., hydrogen bonding, Van der Waals forces, electrostatic interactions, hydrophobic interactions, etc.) to itself (e.g., a polymer and/or a crystal) and/or one or more core component(s). Additionally, or alternatively, one or more core component(s) may be non-covalently bonded (i.e., associated, complexed) to itself (e.g., a polymer and/or a crystal) and/or one or more shell component(s). Without wishing to be bound by any particular theory, it is contemplated that non-covalent bonding of one or more core component(s) with itself and/or one or more shell component(s) may reduce its solubility, increase hydrophobicity, and/or increase molecular weight of the core component, thereby reducing diffusivity and release. Without wishing to be bound by any particular theory, it is contemplated that non-covalent bonding of one or more shell component(s) with itself and/or one or more core component(s) may reduce its solubility, increase hydrophobicity, and/or increase molecular weight of the shell component, thereby reducing diffusivity and release. In some embodiments, one or more shell component(s) performs a chemical reaction on one or more core component(s) to change its molecular weight and/or introduce a new chemical functionality. In some embodiments, one or more core component(s) performs a chemical reaction on one or more shell component(s) to change its molecular weight and/or introduce a new chemical functionality. Without wishing to be bound by any particular theory, it is contemplated that one or more component(s) performing chemical reactions to reduce the molecular weight of a core component or a shell component may increase the release of one or more component(s) from a core-shell preparation.

In certain embodiments, one or more shell component(s) controls the residence time of one or more core component(s) in and around the oral cavity and specific areas (e.g. tongue, throat, nasal cavities, mucosa, epithelium, taste buds, microvilli, taste bud cell, etc.). In certain embodiments, one or more core-shell preparation(s) (e.g., tastant compositions), as provided herein, are characterized by retention in and around the oral cavity and specific areas (e.g. tongue, throat, nasal cavities, mucosa, epithelium, taste buds, microvilli, taste bud cell, etc.). In certain embodiments, one or more core-shell preparation(s) (e.g., tastant compositions), as provided herein, are characterized by lack of retention in and around the oral cavity and specific areas (e.g. tongue, throat, nasal cavities, mucosa, epithelium, taste buds, microvilli, taste bud cell, etc.). In certain embodiments, one or more shell component(s) is or are characterized as being mucoadhesive (e.g., affinity and/or adhesion to one or more mucosal interfaces through interaction with the mucus, glycocalyx, extracellular matrix, cell membrane proteins, and/or cell membranes). In certain embodiments, one or more shell component(s) is or are characterized as being mucopenetrative (e.g., lack of interaction with the mucus, glycocalyx, extracellular matrix, cell membrane proteins, and/or cell membranes).

In some embodiments, mucoadhesive component(s) are further characterized as pH-responsive carbohydrates, as described herein. In certain embodiments, pH-responsive carbohydrates are carbohydrate materials that are characterized by their water solubility at a predetermined pH. In some embodiments, pH-responsive carbohydrates are characterized by their water solubility at low pH (e.g., pH <about 5, pH <about 4, pH <about 3, pH <about 2, pH <about 1). In some embodiments, pH-responsive carbohydrates exhibit low water solubility at low pH and higher water solubility at moderate (e.g., pH of about 5.5, about 6, about 6.5, about 7, about 7.5, about 8) to high (e.g., pH >8, pH >9, pH >10, pH >11, pH >12) pH. In other embodiments, pH-responsive carbohydrates exhibit higher water solubility at low pH and lower water solubility at moderate to high pH.

For example, in some embodiments, pH-responsive carbohydrate component(s) may comprise sodium alginate, potassium alginate, calcium alginate, magnesium alginate, zinc alginate, sodium pectinate, potassium pectinate, calcium pectinate, zinc pectinate, sodium hyaluronate, potassium hyaluronate, calcium hyaluronate, magnesium hyaluronate, zinc hyaluronate, cellulose acetate succinate, cellulose acetate butyrate, cellulose acetate phthalate, hydroxypropyl methylcellulose acetate succinate, heparin sodium, sodium carboxymethylcellulose, chitosan, and/or combinations thereof.

In some embodiments, mucoadhesive component(s) are considered mucoadhesive carbohydrates. In certain embodiments, mucoadhesive carbohydrates are carbohydrate materials that are characterized by their ability to interact with the mucosal interface (e.g., mucus, mucins, glycocalyx, proteoglycans, cell membrane, phospholipids). Without wishing to be bound by any particular theory, mucoadhesive carbohydrates may utilize a combination of hydrogen bonding, charge-charge interaction, and hydrophobic effect to prolong residence time of formulations (e.g., particle preparations) on a mucosal surface.

For example, in some embodiments, mucoadhesive carbohydrate component(s) may comprise sodium alginate, potassium alginate, calcium alginate, magnesium alginate, zinc alginate, sodium pectinate, potassium pectinate, calcium pectinate, zinc pectinate, sodium hyaluronate, potassium hyaluronate, calcium hyaluronate, magnesium hyaluronate, zinc hyaluronate, sodium carboxymethylcellulose, chitosan, and/or combinations thereof.

In some embodiments, mucoadhesive component(s) are considered mucoadhesive proteins. In certain embodiments, mucoadhesive proteins are protein materials that are characterized by their ability to interact with the mucosal interface (e.g., mucus, mucins, glycocalyx, proteoglycans, cell membrane, phospholipids). Without wishing to be bound by any particular theory, mucoadhesive proteins may utilize a combination of hydrogen bonding, charge-charge interaction, and hydrophobic effect to prolong residence time of formulations (e.g., particle preparations) on a mucosal surface.

For example, in some embodiments, mucoadhesive protein component(s) may comprise Lycopersicon esculentum agglutinin, wheat germ agglutinin, Urtica dioica agglutinin, and/or combinations thereof.

In some embodiments, mucoadhesive component(s) are considered catechols. In certain embodiments, mucoadhesive catechols are polyphenol (e.g., as described herein) that are characterized by their ability to interact with the mucosal interface (e.g., mucus, mucins, glycocalyx, proteoglycans, cell membrane, phospholipids). Without wishing to be bound by any particular theory, mucoadhesive catechols may utilize a combination of hydrogen bonding, π-stacking, chemical cross-linking, and hydrophobic effect to prolong residence time of formulations (e.g., particle preparations) on a mucosal surface.

For example, in some embodiments, mucoadhesive catechols may comprise L-dopamine, poly(L-dopamine), hydroxytyrosol, catechol, caffeic acid, vanillin, veratraldehyde, eugenol, tannic acid, syringaldehyde, and/or protocatechuic aldehyde.

In some embodiments, mucoadhesive component(s) are further characterized as charged polymers (e.g., polymers exhibiting charge depending on pH of one or more dissolution solvent(s)). In some embodiments, a charged polymer may be an anionic mucoadhesive polymer component (e.g., polymers exhibiting a negative charge depending on pH of one or more dissolution solvent(s)). In some embodiments, a charged polymer may be cationic mucoadhesive polymer component (e.g., polymers exhibiting a positive charge depending on pH of one or more dissolution solvent(s)). Without wishing to be bound by any particular theory, it is contemplated that charged polymers facilitate interaction with the mucosal interface (e.g., mucus, mucins, glycocalyx, proteoglycans, cell membrane, phospholipids) thereby enabling greater retention time of one or more core-shell preparation(s).

For example, in some embodiments anionic mucoadhesive polymer component(s) may comprise poly(acrylic acid), poly(methacrylic acid), and/or poly(glycerol citrate)

For example, in some embodiments cationic mucoadhesive polymer component(s) may comprise poly(ethyleneimine), trimethylchitosan, and/or poly(L-arginine).

In some embodiments, mucopenetrative component(s) are characterized by lack of interaction with the mucus, glycocalyx, extracellular matrix, cell membrane proteins, and/or cell membranes. Without wishing to be bound by any particular theory, one or more shell component(s) comprising a mucopenetrative component is contemplated to increase the diffusion of one or more core-shell preparation(s) at a mucosal interface. For example, in some embodiments, mucopenetrative component(s) may comprise poly(ethylene glycol), poly(propylene glycol), poly(vinyl alcohol), and/or poly(ethylene oxide-co-propylene oxide).

In certain embodiments, one or more shell component(s) controls the release of one or more core component(s) by responding to a trigger. In certain embodiments, one or more core component(s) controls the release of one or more shell component(s) by responding to a trigger. In certain embodiments, a trigger is characterized as a chemical trigger, enzymatic trigger, and/or a physical trigger. For example, a chemical trigger may be further characterized as a cross-linker, pH, bile salts, reducing and/or oxidizing agents, and/or osmotic pressure. For example, an enzymatic trigger may be further characterized as exposure to proteases, amylases, lipases, bacteria, transglutaminases, and/or thrombin. For example, a physical trigger may be further characterized as temperature, time, and/or mechanical forces. Without wishing to be bound by any particular theory, it is contemplated that one or more trigger(s) may act to alter the physical and/or chemical properties of one or more core component(s) and/or one or more shell component(s). It is further contemplated that alteration of one or more physical properties (e.g., increasing porosity, reducing molecular weight) acts to increase the release rate of one or more food component(s). It is further contemplated that alteration of one or more chemical properties (e.g., increasing charge, increasing polarity) acts to increase the release rate of one or more food component(s).

### (ii) Matrix Preparations

Among other things, the present disclosure provides matrix preparations (e.g., tastant compositions (e.g., formulated tastants)) as a means of controlling the release of one or more food component(s) from one or more tastant composition(s). For example, in some embodiments, one or more tastant composition(s) are or comprise matrix preparations. For example, matrix preparations may comprise a solute component and/or a matrix component, each of which are essentially comprised of one or more food component(s), as described herein. In some embodiments, a solute component is comprised of one or more food component(s) and/or one or more excipient component(s). In some embodiments, a matrix component is comprised of one or more food component(s) and/or one or more excipient component(s).

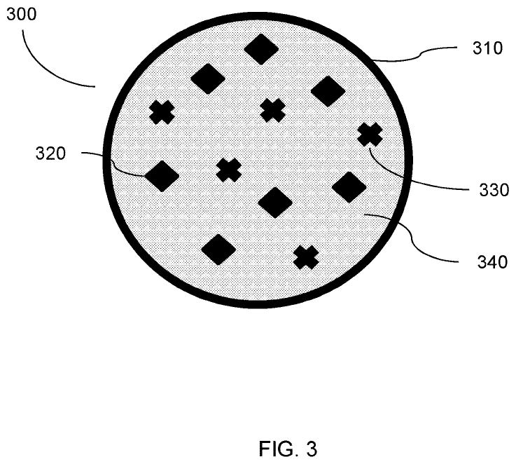

As depicted in a non-limiting schematic in FIG. 3 in some embodiments, an exemplary matrix preparation may comprise a formulation comprising at least one food component and/or one excipient component arranged as a solute component and at least one food component and/or one excipient component arranged as a matrix component. In some embodiments, the at least one food component and/or one excipient component comprising a solute component are additionally the at least one food component and/or one excipient component comprising a matrix component. In some embodiments, the at least one food component and/or one excipient component comprising a solute component are different from the at least one food component and/or one excipient comprising a matrix component. In some embodiments, one or more solute component(s) are distributed homogeneously within a matrix preparation (e.g., food composition). In some embodiments, one or more solute component(s) are distributed heterogeneously within a matrix preparation (e.g., food composition).

As depicted in a non-limiting schematic in FIG. 3 in some embodiments, an exemplary matrix preparation 300 may comprise one or more solute components 320 and/or 330 further comprising one or more food component(s) and/or excipient component(s). In some embodiments, an exemplary matrix preparation 300 may comprise one or more matrix components 340 further comprising one or more food component(s) and/or excipient component(s) comprising at least one carrier component 110, at least one payload component 120, at least one excipient component 130, or a combination thereof.

In some embodiments, at least one food component 320 and/or an at least one excipient component 330 may be described as being dispersed within (e.g., embedded within) at least one matrix component 340.

In some embodiments, at least one matrix component 340 may be described as encapsulating (i) at least one food component 320, and/or at least one excipient component 330.

In some embodiments, at least one food component 320, at least one excipient component 330, at least one matrix component 340, or a combination thereof may be described as being dispersed within (e.g., encapsulated in) at least one matrix preparation 300.

In some embodiments, at least one food component 320, at least one excipient component 330, at least one matrix component 340, or a combination thereof comprising one or more matrix preparations 300 may be described as being dispersed within (e.g., encapsulated or embedded within) a shell component 310, as a core-shell preparation.

In some embodiments, one or more solute component(s) and/or matrix component(s) may be further characterized as a core-shell preparation. In some embodiments, one or more solute component(s) and/or matrix component(s) comprise a core-shell preparation.

In some embodiments, one or more food component(s) comprising a matrix component and/or a solute component is characterized as being a liquid. In some embodiments, one or more food component(s) comprising a matrix component and/or a solute component is characterized as being a solid.

In some embodiments, provided matrix preparations may be characterized as a particle (e.g., particle preparation), a bar, a gel, a capsule, a tablet, a fiber, an extrudate, a hard candy, a chip, and/or a mesh.

In certain embodiments, matrix preparations (e.g., tastant compositions (e.g., formulated tastants)) are characterized as a means of controlling the release of one or more food component(s). In certain embodiments, one or more matrix component(s) controls the release profile of one or more solute component(s). In certain embodiments, one or more solute component(s) controls the release profile of one or more matrix component(s). In certain embodiments, control of the release of one more solute component(s) is achieved by one or more matrix component(s) providing a physical barrier to a dissolution solvent, controlling the diffusivity of one or more solute component(s), controlling the chemical properties of one or more solute component(s), controlling residence time of one or more solute component(s) in the dissolution medium, and/or responsiveness to one or more triggers, as described herein. In certain embodiments, control of the release of one more matrix component(s) is achieved by one or more solute component(s) controlling the chemical properties of one or more matrix component(s), and/or responsiveness to one or more triggers, as described herein.

In certain embodiments, one or more matrix component(s) controls the residence time of one or more core component(s) in and around the oral cavity and specific areas (e.g. tongue, throat, nasal cavities, mucosa, epithelium, taste buds, microvilli, taste bud cell, etc.). In certain embodiments, one or more matrix preparation(s) (e.g., tastant compositions), as provided herein, are characterized by retention in and around the oral cavity and specific areas (e.g. tongue, throat, nasal cavities, mucosa, epithelium, taste buds, microvilli, taste bud cell, etc.). In certain embodiments, one or more matrix preparation(s) (e.g., tastant compositions), as provided herein, are characterized by lack of retention in and around the oral cavity and specific areas (e.g. tongue, throat, nasal cavities, mucosa, epithelium, taste buds, microvilli, taste bud cell, etc.). In certain embodiments, one or more matrix component(s) is or are characterized as being mucoadhesive (e.g., affinity and/or adhesion to one or more mucosal interfaces through interaction with the mucus, glycocalyx, extracellular matrix, cell membrane proteins, and/or cell membranes). In certain embodiments, one or more matrix component(s) is or are characterized as being mucopenetrative (e.g., lack of interaction with the mucus, glycocalyx, extracellular matrix, cell membrane proteins, and/or cell membranes).

In certain embodiments, one or more matrix component(s) controls the diffusivity of one or more solute component(s). In certain embodiments, one or more solute component(s) controls the diffusivity of one or more matrix component(s). For example, in some embodiments, one or more matrix component(s) and/or one or more solute component(s) may be characterized by at least one of porosity, chain length, and/or electric charge. Without wishing to be bound by any particular theory, it is contemplated that one or more matrix component(s) characterized by reduced porosity and/or increased chain length and/or complementary charge to one or more solute component(s) reduce free movement (e.g., diffusivity) of one or more solute component(s) by presenting a physical obstruction and/or an electric field, thus preventing dissolution (e.g., release) of one or more solute component(s). Without wishing to be bound by any particular theory, it is contemplated that one or more solute component(s) characterized by increased chain length and/or complementary charge to one or more matrix component(s) reduce free movement (e.g., diffusivity) of one or more matrix component(s) by presenting a physical obstruction and/or an electric field, thus preventing dissolution (e.g., release) of one or more matrix component(s).

In certain embodiments, one or more matrix component(s) controls the chemical properties of one or more solute component(s). In certain embodiments, one or more solute component(s) controls the chemical properties of one or more matrix component(s). For example, in some embodiments, one or more matrix component(s) may be ionically and/or covalently bonded (i.e., associated, complexed) to itself (e.g., a polymer) and/or one or more solute component(s). Additionally, or alternatively, one or more solute component(s) may be ionically and/or covalently bonded (i.e., associated, complexed) to itself (e.g., a polymer) and/or one or more matrix component(s). Without wishing to be bound by any particular theory, it is contemplated that ionic and/or covalent bonding of one or more solute component(s) with itself and/or one or more matrix component(s) may reduce its solubility, increase hydrophobicity, and/or increase molecular weight of the solute component, thereby reducing diffusivity and release. Without wishing to be bound by any particular theory, it is contemplated that ionic and/or covalent bonding of one or more matrix component(s) with itself and/or one or more solute component(s) may reduce its solubility, increase hydrophobicity, and/or increase molecular weight of the matrix component, thereby reducing diffusivity and release. In some embodiments, one or more matrix component(s) performs a chemical reaction on one or more solute component(s) to change its molecular weight and/or introduce a new chemical functionality. In some embodiments, one or more solute component(s) performs a chemical reaction on one or more matrix component(s) to change its molecular weight and/or introduce a new chemical functionality. Without wishing to be bound by any particular theory, it is contemplated that one or more component(s) performing chemical reactions to reduce the molecular weight of a solute component or a matrix component may increase the release of one or more component(s) from a matrix preparation.

In certain embodiments, one or more matrix component(s) controls the chemical properties of one or more solute component(s). In certain embodiments, one or more solute component(s) controls the chemical properties of one or more matrix component(s). For example, in some embodiments, one or more matrix component(s) may be non-covalently bonded (e.g., hydrogen bonding, Van der Waals forces, electrostatic interactions, hydrophobic interactions, etc.) to itself (e.g., a polymer) and/or one or more solute component(s). Additionally, or alternatively, one or more solute component(s) may be non-covalently bonded (e.g., hydrogen bonding, Van der Waals forces, electrostatic interactions, hydrophobic interactions, etc.) to itself (e.g., a polymer) and/or one or more matrix component(s). Without wishing to be bound by any particular theory, it is contemplated that non-covalent bonds (e.g., hydrogen bonding, Van der Waals forces, electrostatic interactions, hydrophobic interactions, etc.) of one or more solute component(s) with itself and/or one or more matrix component(s) may reduce its solubility, increase hydrophobicity, and/or increase molecular weight of the solute component, thereby reducing diffusivity and release. Without wishing to be bound by any particular theory, it is contemplated that non-covalent bonds (e.g., hydrogen bonding, Van der Waals forces, electrostatic interactions, hydrophobic interactions, etc.) of one or more matrix component(s) with itself and/or one or more solute component(s) may reduce its solubility, increase hydrophobicity, and/or increase molecular weight of the matrix component, thereby reducing diffusivity and release. In some embodiments, one or more matrix component(s) performs a chemical reaction on one or more solute component(s) to change its molecular weight and/or introduce a new chemical functionality. In some embodiments, one or more solute component(s) performs a chemical reaction on one or more matrix component(s) to change its molecular weight and/or introduce a new chemical functionality. Without wishing to be bound by any particular theory, it is contemplated that one or more component(s) performing chemical reactions to reduce the molecular weight of a solute component or a matrix component may increase the release of one or more component(s) from a matrix preparation.

In certain embodiments, one or more matrix component(s) controls the release of one or more solute component(s) by responding to a trigger. In certain embodiments, one or more solute component(s) controls the release of one or more matrix component(s) by responding to a trigger. In certain embodiments, a trigger is characterized as a chemical trigger, enzymatic trigger, and/or a physical trigger. For example, a chemical trigger may be further characterized as a cross-linker, pH, bile salts, reducing and/or oxidizing agents, and/or osmotic pressure. For example, an enzymatic trigger may be further characterized as exposure to proteases, amylases, lipases, bacteria, transglutaminases, and/or thrombin. For example, a physical trigger may be further characterized as temperature, time, and/or mechanical forces. Without wishing to be bound by any particular theory, it is contemplated that one or more trigger(s) may act to alter the physical and/or chemical properties of one or more solute component(s) and/or one or more matrix component(s). It is further contemplated that alteration of one or more physical properties (e.g., increasing porosity, reducing molecular weight) acts to increase the release rate of one or more food component(s). It is further contemplated that alteration of one or more chemical properties (e.g., increasing charge, increasing polarity) acts to increase the release rate of one or more food component(s).

(iii) Release Profiles

In certain embodiments, the release of one or more food component(s) is characterized by the amount (e.g., concentration) of one or more food component(s) solubilized in one or more dissolution solvent(s) over a predetermined period of time (e.g., incubation period). In certain embodiments, the present disclosure provides for a means of controlled release of one or more food component(s) (e.g., core-shell preparations and/or matrix preparations). In certain embodiments, controlled release of one or more food component(s) is control of the amount (e.g., concentration) of one or more food component(s) released over an incubation period (e.g., release rate). In many embodiments, the concentration and release rate comprise the release profile of one or more food component(s).

In certain embodiments, control of the release profile of one or more food component(s) provides a taste benefit (e.g., controlled duration of taste, controlled onset of taste). For example, in certain embodiments, the release of one or more food component(s) may be held at a constant release rate for at least about 1, about 3, about 5, about 10, about 15, about 30, about 45, about 60, about 120, about 180, about 300, about 600, about 1200, and/or about 2400 seconds. For example, in certain embodiments, the release of one or more food component(s) may occur in intervals (e.g., bolus dose) every about 0.5 seconds, about 1, about 3, about 5, about 10, about 15, about 30, about 45, about 60, about 120, about 180, about 300, about 600, about 1200, and/or about 2400 seconds. For example, in certain embodiments, the release of one or more food component(s) may occur with a release rate that increases after at least about 1, about 3, about 5, about 10, about 15, about 30, about 45, about 60, about 120, about 180, about 300, about 600, about 1200, and/or about 2400 seconds. For example, in certain embodiments, the release of one or more food component(s) may occur with a release rate that decreases after at least about 1, about 3, about 5, about 10, about 15, about 30, about 45, about 60, about 120, about 180, about 300, about 600, about 1200, and/or about 2400 seconds.

In certain embodiments, control of the release profile of one or more food component(s) provides a taste benefit (e.g., controlled duration of taste, controlled onset of taste). For example, in certain embodiments, the release of one or more food component(s) may be held at a constant release rate for at least about 1, about 2, about 4, about 6, about 12, about 24, and/or about 48 hours. For example, in certain embodiments, the release of one or more food component(s) may occur in intervals (e.g., bolus dose) every about 30 minutes, about 1 hour, about 2 hours, about 4 hours, about 6 hours, about 8 hours, about 12 hours, and/or about 24 hours. For example, in certain embodiments, the release of one or more food component(s) may occur with a release rate that increases after at least about 1, about 2, about 4, about 6, about 12, about 24, and/or about 48 hours. For example, in certain embodiments, the release of one or more food component(s) may occur with a release rate that decreases after at least about 1, about 2, about 4, about 6, about 12, about 24, and/or about 48 hours.

### (iv) Dissolution Solvents

In certain embodiments, the release of one or more food component(s) from one or more tastant composition(s) is characterized by quantification of solubilization in one or more dissolution solvent(s), as provided herein.

In certain embodiments, one or more dissolution solvent(s) may be characterized by their miscibility with water. In certain embodiments, one or more dissolution solvent(s) may be characterized by their salinity. In certain embodiments, one or more dissolution solvent(s) may be characterized by their pH. In certain embodiments, one or more dissolution solvent(s) may be characterized as being a native biological fluid (i.e., a fluid characterized as essential to a living organism). In certain embodiments, one or more dissolution solvent(s) may be characterized as being a surrogate of a native biological fluid (i.e., a surrogate of a fluid characterized as essential to a living organism). In certain embodiments, one or more dissolution solvent(s) may be characterized by a combination of at least one of their miscibility with water, pH, and/or salinity, as being a native biological fluid, and/or resembling a native biological fluid.

In certain embodiments, one or more tastant composition(s) is added to an excess quantity, by weight, of one or more dissolution solvent(s) to characterize solubility. In certain embodiments, one or more tastant composition(s) is added to at least about 5 fold, at least about 10 fold, at least about 20 fold, at least about 50 fold, at least about 100 fold, at least about 200 fold, at least about 1000 fold, at least about 5000 fold, and/or at least about 10000 fold, by weight, excess of one or more dissolution solvent(s) to characterize solubility.

In certain embodiments, one or more tastant composition(s) is added to one or more dissolution solvent(s) at a controlled temperature to characterize solubility. In certain embodiments, one or more tastant composition(s) is added to one or more dissolution solvent(s) held at least at about −20° C., at least at about 0° C., at least at about 4° C., at least at about 20° C., at least at about 37° C., and/or at least at about 50° C. to characterize solubility.

In certain embodiments, one or more tastant composition(s) is added to one or more dissolution solvent(s) for a predetermined period of time (e.g., incubation period) to characterize solubility. In certain embodiments, one or more tastant composition(s) is added to one or more dissolution solvent(s) for at least about 30 seconds, at least about 1 minute, at least about 5 minutes, and/or at least about 10 minutes to characterize solubility.

In certain embodiments, one or more tastant composition(s) is added to one or more dissolution solvent(s) for a predetermined period of time (e.g., incubation period) to characterize solubility. In certain embodiments, one or more tastant composition(s) is added to one or more dissolution solvent(s) for at least about 10 minutes, at least about 30 minutes, at least about 60 minutes, and/or at least about 120 minutes to characterize solubility.

In certain embodiments, one or more tastant composition(s) is added to one or more dissolution solvent(s) for a predetermined period of time (e.g., incubation period) to characterize solubility. In certain embodiments, one or more tastant composition(s) is added to one or more dissolution solvent(s) for at least about 120 minutes, at least about 6 hours, at least about 12 hours, and/or at least about 24 hours to characterize solubility.

In certain embodiments, one or more tastant composition(s) is added to one or more dissolution solvent(s) at a particular combination of weight ratio, temperature, and/or period of time, as described herein, to characterize solubility.

In certain embodiments, one or more dissolution solvent(s) is characterized as being miscible with water. In certain embodiments, one or more dissolution solvent(s) is characterized as being immiscible with water.

For example, one or more dissolution solvent(s) characterized as being miscible with water may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, Cyrene, Glycofurol, furfural, Kreb's buffer, acetone, tetrahydrofuran, ethanol, methanol, dimethylformamide, and/or dimethyl sulfoxide.

For example, one or more dissolution solvent(s) characterized as being immiscible with water may be n-octanol, n-nonanol, n-decanol, n-dodecanol, n-tetradecanol, n-hexadecanol, n-octadecanol, n-icosanol, fatty alcohol monoglyceride ethers, fatty acid monoglyceride esters, fatty alcohol diglyceride ethers, fatty acid diglyceride esters, fatty alcohol triglyceride ethers, fatty acid triglyceride esters, fatty alcohol glycol monoether, fatty acid glycol monoesters, fatty alcohol glycol diethers, fatty acid glycol diesters, coconut oil, corn oil, cottonseed oil, olive oil, palm oil, peanut oil, rapeseed oil, safflower oil, sesame oil, soybean oil, sunflower oil, almond oil, pine nut oil, cashew oil, fully hydrogenated palm oil, partially hydrogenated palm oil, fully hydrogenated sunflower oil, partially hydrogenated sunflower oil, fully hydrogenated soybean oil, partially hydrogenated soybean oil, fully hydrogenated vegetable oil, partially hydrogenated vegetable oil, fully hydrogenated cottonseed oil, partially hydrogenated cottonseed oil, dichloromethane, hexanes, toluene, 2-methyltetrahydrofuran, and/or ethyl acetate.

In certain embodiments, one or more dissolution solvent(s) is characterized by salinity. For example, one or more dissolution solvent(s) characterized by salinity may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer.

In certain embodiments, one or more dissolution solvent(s) is characterized by pH. For example, one or more dissolution solvent(s) characterized by pH may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, biological intestinal fluid, biological gastric fluid, plasma, saliva, urine, feces, sweat, tear fluid, and/or Kreb's buffer.

In certain embodiments, one or more dissolution solvent(s) is characterized as being a native biological fluid. For example, one or more dissolution solvent(s) characterized as being a native biological fluid may be water, biological intestinal fluid, biological gastric fluid, plasma, saliva, urine, feces, sweat, oral fluid, cecum fluid, bile, and/or tear fluid.

In certain embodiments, one or more dissolution solvent(s) is characterized as being a surrogate of native biological fluid. For example, one or more dissolution solvent(s) characterized as being a surrogate of native biological fluid may be water, phosphate buffered saline solution, simulated intestinal fluid, simulated gastric fluid, simulated tear fluid, simulated urine, HEPES buffered saline solution, Dulbecco's Modified Eagle Medium, Hank's balanced salt solution, and/or Kreb's buffer.

### 3. Moisture Content

In some embodiments, provided tastant composition(s) is or are characterized by low moisture content. In some embodiments, the present disclosure provides technologies for preparing and/or characterizing tastant compositions (e.g., formulated tastants) comprising low moisture content.

In some embodiments, the present disclosure provides one or more tastant composition(s) with low moisture content. Disclosed technologies provide benefits over existing products because high moisture content formulations may lead to rapid degradation of food component(s).

In some embodiments, the present disclosure provides one or more tastant composition(s) with low moisture content. In some instances, provided tastant compositions (e.g., formulated tastants) may have a moisture content of <8 wt %, <6 wt %, <4 wt %, <2 wt %, <1 wt %, or <0.5 wt %.

In some embodiments, provided tastant compositions (e.g., formulated tastants) are characterized by resistance or mitigation of water absorption or moisture absorption when exposed to high humidity or moisture content. In some embodiments, the present disclosure provides technologies for preventing uptake of water or moisture.

In some embodiments, the present disclosure provides one or more tastant composition(s) that resist or mitigate moisture absorption when exposed to high humidities or moisture. In some instances, provided tastant compositions (e.g., formulated tastants) resist absorption of less than about 0.25%, less than about 0.5%, less than about 1%, and/or less than about 5% (w/w) moisture content, as compared to initial moisture content, after incubation in relative humidities of about 33%, about 53%, and/or about 75%.

### 4. Water Activity

Without wishing to be bound by any particular theory, food component(s) may exhibit poor stability in environments with high water activity. In certain aspects of the present embodiments, a tastant composition of low water activity exhibits a water activity of <about 0.4, <about 0.3, <about 0.2, and/or <about 0.1.

In certain embodiments, the disclosed invention provides one or more tastant composition(s) of water activity <about 0.4, <about 0.3, <about 0.2, and/or <about 0.1. In certain embodiments, the disclosed invention provides one or more tastant composition(s) of low water activity. In some embodiments, the present disclosure provides technologies for preparing and/or characterizing tastant composition(s) comprising low water activity.

In some embodiments, the present disclosure provides one or more tastant composition(s) with low water activity. Disclosed technologies provide benefits over existing products because high water activity formulations lead to rapid degradation of food component(s).

### 5. Particle Preparations

Among other things, the present disclosure provides particle preparations (e.g., tastant compositions, e.g. tastant particle preparations). For example, in some embodiments, tastant compositions (e.g., formulated tastants) are or comprise particles (e.g., particle preparations, e.g., tastant particle preparations). For example, particles may comprise a payload component (e.g., tastant, etc.) and/or a carrier component.

In some embodiments, one or more tastant composition(s) are or comprise particles (e.g., particle preparations). In some embodiments, the present disclosure provides particle preparations in which particles have a particular shape or form, for example, having a cross-section shape of a circle, an oval, a triangle, a square, a hexagon, or an irregular shape. In some embodiments, a preparation includes particles of different shapes or forms. In some embodiments, most or substantially all or all particles in a preparation have a common shape.

In some embodiments, particles in a provided particle preparation may have a distribution of diameters (e.g., Dv(10), Dv(20), Dv(30), Dv(40), Dv(50), Dv(60), Dv(70), Dv(80), Dv(90), Dv99, etc.). In some embodiments, particles in a provided particle preparation may have an average diameter (e.g., D[3,2], D[4,3], etc.). Regardless of the shape of the particle, the “diameter” (i.e., size) of a particle is the longest distance from one end of the particle to another end of the particle.

In some instances, particles in a particle preparation as described and/or utilized herein may have a distribution of diameters (e.g., Dv(10), Dv(20), Dv(30), Dv(40), Dv(50), Dv(60), Dv(70), Dv(80), Dv(90), Dv(99), etc.) of up to about 10000 μm, up to about 5000 μm, up to about 2500 μm, up to about 1250 μm, up to about 800 μm, up to about 400 μm, up to about 200 μm, up to about 100 μm, up to about 50 μm, up to about 40 μm, up to about 30 μm, up to about 20 μm, up to about 10 μm, or up to about 5 μm.

### 6. Release of Food Component(s)

In certain embodiments of the present disclosure, a means for controlled release of one or more food component(s) from one or more tastant composition(s) is provided. In certain embodiments, the controlled release of one or more food components is characterized by at least one of release profile (e.g., as described herein), total amount (e.g., mass and/or weight) of one or more food component(s) released, total amount of one or more food component(s) released relative to initial loading (e.g., percent release), and/or location of release in a given incubation period in one or more dissolution solvent(s).

In certain embodiments, a total amount (e.g., mass and/or weight) of one or more food component(s), percent release, total amount of tastants provided, and/or location of release is characterized by one or more release profiles (e.g., as described herein). In certain embodiments, the release of one or more food component(s) is characterized by release over a given time frame. In certain embodiments, release is characterized over a time period of at least about 1 second, at least about 3 seconds, at least about 5 seconds, at least about 10 seconds, at least about 30 seconds, at least about 1 minute, at least about 5 minutes, at least about 10 minutes, at least about 30 minutes, at least about 60 minutes, at least about 2 hours, at least about 4 hours, at least about 8 hours, at least about 16 hours, and/or at least about 24 hours. In certain embodiments, release is characterized over a time period relevant to time periods between one or more meals. For example, in certain embodiments, release is characterized over a time period of at least about 8 hours, at least about 16 hours, and/or at least about 24 hours. In certain embodiments, release profiles of one or more food component(s) may be characterized (e.g., as described herein) as held at a constant release rate, bolus dose in intervals, with increasing release rate, and/or decreasing release rate for at least about 1 second, about 3 seconds, about 5 seconds, about 10 seconds, about 30 seconds, about 1 minute, about 5 minutes, about 10 minutes, about 30 minutes, about 1 hour, about 2 hours, about 4 hours, about 6 hours, about 8 hours, about 12 hours, about 24 hours, and/or about 48 hours. In some embodiments, one or more food component(s) comprising one or more tastant composition(s) exhibit the same release (e.g., release profile). In some embodiments, one or more food component(s) comprising one or more tastant composition(s) exhibit differing release (e.g., release profile).

In certain embodiments, controlled release of one or more food component(s) is characterized by the percent release in a given incubation period in one or more dissolution solvent(s). In certain embodiments, at least about 0%, about 10%, about 25%, about 50%, about 75%, and/or about 100% of one or more food component(s) are released over an 8 hour period. In certain embodiments, at least about 0%, about 10%, about 25%, about 50%, about 75%, and/or about 100% of one or more food component(s) are released over a 16 hour period. In certain embodiments, at least about 0%, about 10%, about 25%, about 50%, about 75%, and/or about 100% of one or more food component(s) are released over a 24 hour period.

In certain embodiments, controlled release of one or more food component(s) is characterized by a targeted location of release. In certain embodiments, one or more food component(s) is characterized by release in at least one of the mouth, throat, nasal cavity, and/or mucosa. In certain embodiments, one or more food component(s) comprising one or more core component(s) and/or shell component(s) is characterized as controlling release in at least one of the mouth, throat, nasal cavity, and/or mucosa. In certain embodiments, one or more food component(s) comprising one or more solute component(s) and/or matrix component(s) is characterized as controlling release in at least one of the mouth, throat, nasal cavity, and/or mucosa. In certain aspects, the at least one food component controlling release in at least one of the mouth, throat, nasal cavity, and/or mucosa is further characterized as triggered by pH. In certain embodiments, one or more food component(s) is characterized by release at a pH of at about 1-2, about 2-3, about 3-4, about 4-5, about 5-6, about 6-7, about 7-8, about 8-9, and/or about 9-10. In certain aspects, the at least one food component controlling release in at least one of the mouth, throat, nasal cavity, and/or mucosais further characterized as enzymatically triggered. In certain embodiments, one or more food component(s) is characterized by susceptibility to amylases, lipases, proteases, and/or bacteria. In certain aspects, the at least one food component controlling release in at least one of the mouth, throat, nasal cavity, and/or mucosa is further characterized as triggered by physical forces. In certain embodiments, one or more food component(s) is characterized by release upon application of physical pressure and/or shear forces. In certain aspects, the at least one food component controlling release in at least one of the mouth, throat, nasal cavity, and/or mucosa is further characterized as triggered by temperature. In certain embodiments, one or more food component(s) is characterized by release at a temperature of at least about 20° C., about 25° C., about 28° C., about 30° C., about 35° C., about 37° C., about 40° C., about 45° C., and/or about 50° C. In certain aspects, the at least one food component controlling release in at least one of the mouth, throat, nasal cavity, and/or mucosa is further characterized as triggered by time. In certain embodiments, one or more food component(s) is characterized by release after an incubation period of at least about 0.5 seconds, about 1 second, about 3 seconds, about 5 seconds, about 8 seconds, about 10 seconds, about 12 minutes, about 18 minutes, about 24 minutes, and/or about 30 minutes.

In certain embodiments, the current disclosure provides for the incorporation of one or more tastant composition(s) into food and/or beverage products.

In some cases, one or more tastant composition(s) are incorporated into food and/or beverage products in the food and/or beverage manufacturing process. In some cases, one or more tastant composition(s) are incorporated into food and/or beverage products in the food and/or beverage packaging process. In some cases, one or more tastant composition(s) are incorporated prior to pasteurization of a food and/or beverage product. In some cases, one or more tastant composition(s) are incorporated prior to mixing of a food and/or beverage product. In some cases, one or more tastant composition(s) are incorporated into finished food and/or beverage products. In some cases, one or more tastant composition(s) are incorporated into food and/or beverage products immediately prior to consumption.

In certain embodiments, incorporation of tastant composition(s) (e.g., core-shell and/or matrix preparations) into food and/or beverage products utilizes size reduction techniques and/or homogenization. In some cases, size reduction techniques are applied to tastant composition(s) prior to incorporation. Alternatively or additionally, size reduction techniques are applied to food and/or beverage products during incorporation of the tastant composition(s). Alternatively or additionally, size reduction techniques are applied to food and/or beverage products after incorporation of the tastant composition(s). The present disclosure provides for size reduction using, for example, planetary milling, ball milling, burr milling, roller milling, media milling, impact milling, jet milling, high-pressure homogenization, cryo milling, hammer milling, conical milling, hand screening, or granulation/extrusion, extrusion, spray drying, lyophilization/milling, fluid bed agglomeration, spray congealing, high-shear granulation, tableting, pouring, roller compaction, crosslinking, prilling, spinning disc atomization, and/or combinations thereof.

In certain embodiments, homogenization is applied to tastant composition(s) following incorporation into food and/or beverage products. The present disclosure provides for homogenization using, for example, overhead stirrer, manual stirring, stir bar, high pressure homogenization, low pressure homogenization, sonication, ultrasonication, vortexing, or combinations thereof.

In certain embodiments, incorporation of tastant composition(s) into food and/or beverage products significantly affects the visual appearance, texture, and/or taste of the food and/or beverage products. In other embodiments, incorporation of tastant composition(s) into food and/or beverage products minimally affects the visual appearance, texture, and/or taste of the food and/or beverage products.

In some embodiments, disclosed tastant composition(s) minimally affect visual appearance, texture, and/or taste when incorporated, as provided herein, into a protein beverage (e.g., Ensure). In some instances, disclosed tastant composition(s) minimally affect visual appearance, texture, and/or taste when incorporated, as provided herein, into a MRE (i.e., meal ready-to-eat).

Some aspects of the current disclosure provide methods of providing an effective amount of tastant compositions described herein in combination with a consumable composition (e.g., a food product, a beverage product, an animal-consumable product, etc.) to an animal. In some cases, consumable compositions comprise core-shell preparations and/or matrix preparations.

In some embodiments, an animal is a human, for example, an adult, an elder, a teenager, an adolescent, or an infant. In some cases, an animal is an agricultural animal, for example, a horse, a cow, a pig, a sheep, a goat, a domesticated bird (e.g., chicken, duck, goose), a non-domesticated (e.g., wild) bird, etc. In some cases, an animal is a pet animal, for example, a dog, a cat, a rabbit, and/or a fish.

Some aspects of the current disclosure provide consumable compositions (e.g., food products, beverage products, animal-consumable compositions) comprising disclosed tastant compositions. In some cases, consumable compositions comprising tastant compositions is or comprises a food product. In some cases, a food product is characterized by high water activity. In some cases, a food product is or comprises at least one of agricultural seed, baby formula, bread, candy, capsule, cake, cereal, chip, cookie, dry powder, fertilizer, food additive, ice cream, kefir, nutrition supplement, packaged food, pet feed, pet food, protein bar, protein powder, sachet, salad dressing, smoothie, spice, sprinkle packet, tablet, and/or yogurt. In some cases, consumable compositions comprising tastant compositions are provided to an animal in a mixture with a food or food ingredient.

Some aspects of the current disclosure provide consumable compositions (e.g., food products, beverages, animal-consumable compositions) comprising disclosed tastant compositions. In some cases, consumable compositions comprising tastant compositions is or comprises a beverage product. In some cases, a beverage product is characterized by high water activity. In some cases, a beverage product is or comprises at least one of liquid supplement formulation, beer, seltzer, kefir, coffee, juice, liquid pharmaceutical formulation, milk, soda, sports drink (e.g., Gatorade, sports drinks, Vitamin beverage), tea, water, liquor (e.g., vodka, whiskey, rum, etc.) and/or wine. In some cases, the formulation is provided to an animal in a mixture with a beverage or beverage ingredient.

Some aspects of the current disclosure provide powder-based supplement, food, and/or beverage-mix products comprising tastant compositions disclosed herein. In some cases, the powder-based supplement, food, and/or beverage-mix products are characterized by high water activity. In some cases, the powder-based supplement, food, and/or beverage-mix products is a pre-workout powder, post-workout powder or pill, pre-workout capsule/pill, baby formula, whey powder, milk powder, protein powder, drink powder mix (e.g., Kool-Aid type mix), or a powder-based supplement, food, or beverage-mix products.

7. Stability of Tastant Payload Component in Food and/or Beverage Products

Those skilled in the art will recognize that incorporation of one or more food component(s) into food and/or beverage products may be associated with significant reduction in its stability. As defined herein, the stability of one or more food component(s) may refer to a chemical stability, a physical stability, a stability of function, a stability of benefit, and/or combinations thereof. The present disclosure provides stability of one or more food component(s) via one or more tastant composition(s) upon standing, upon incorporation into one or more food and/or beverage products, and/or upon mixing with one or more dissolution solvent(s) at a predetermined temperature, a predetermined humidity, and/or a predetermined period of time (e.g., incubation period). In some instances, a tastant composition provides for stability of a food component in a liquid (e.g., water, simulated gastric fluid, simulated intestinal fluid), food and/or beverage product(s) (e.g., sachet, yogurt, milk powder, seltzer, alcoholic beverage, vitamin beverage, sprinkle packet, meals ready-to-eat, protein drink) or environment (e.g., elevated humidity, temperature).

In some embodiments, tastant composition(s) may be or are effective at protecting food component(s) against a physical change, a chemical change, a functional change, a change in benefit or combinations thereof. In some instances, a physical, chemical, functional change or change in benefit may be induced by one or more of heat, light, shear, water, acid, enzymes, bacteria, or combinations thereof.

In some embodiments, stability of one or more food component(s) in one or more tastant composition(s) refers to the percentage of change of a measured stability characteristic (e.g., stability properties) after a period of storage relative to the measured property immediately after formulation. In some embodiments, stability of one or more food component(s) is defined as <about 40%, <about 30%, <about 20%, <about 10%, <about 5%, <about 2%, and/or <about 1% change in one or more measured stability properties. In some cases, the chemical stability of one or more food component(s) may be determined by a chemical quantity (e.g., mol, g, lbs) of one or more food component(s) relative to initial formulation. In some cases, the physical stability of one or more food component(s) may be determined by a physical quantity (e.g., diameter, morphology, porosity) of one or more food component(s) relative to initial formulation. In some cases, the functional stability of one or more food component(s) may be determined by comparison of release profile, as described herein, of one or more food component(s) relative to initial formulation.

In some embodiments, stability of one or more food components(s) in a provided tastant composition (e.g., as described above), is assessed over a period of time at a particular environmental condition. In some embodiments, stability is assessed after 6 months at ambient temperature.

In some embodiments, a provided tastant composition is stable in that percent change of a stability property is minimized after passage of a period of time (e.g., at least about 1, 2, 3, 4, 5, 6, 7, or 8 weeks) under a particular environmental condition (e.g., ambient temperature). In some embodiments, stability is a measured change of <about 40%, <about 30%, <about 20%, <about 10%, <about 5%, <about 2%, and/or <about 1% of a food component over a period of time under the environmental condition. In some embodiments, the period of time is up to about 8 weeks and the environmental condition is or comprises ambient temperature. In some embodiments, the period of time is up to about 2 weeks and the environmental condition is or comprises presence of water (e.g., in aqueous solution). In some embodiments, the period of time is up to about 72 hours and the environmental condition is or comprises exposure to light at elevated temperatures (e.g., about 37° C.).

In some embodiments, a provided tastant composition is stable in that percent change of a stability property is minimized after passage of a period of time (e.g., at least about 1, 2, 3, 4, 5, 6, 7, or 8 weeks) under a particular environmental condition (e.g., ambient temperature). In some embodiments, stability is a measured change of <about 40%, <about 30%, <about 20%, <about 10%, <about 5%, <about 2%, and/or <about 1% of a food component over a period of time under the environmental condition. In some embodiments, the period of time is up to about 36 months and the environmental condition is or comprises ambient temperature. In some embodiments, the period of time is up to about 12 months and the environmental condition is or comprises presence of food product (e.g., in a mixture with a food product). In some embodiments, the period of time is up to about 1 month and the environmental condition is or comprises exposure to a food product (e.g., in a mixture with yogurt).

In some instances, stability of one or more food component(s) (<about 20% change in one or more stability properties) is maintained after storage in a solid food (e.g., bread, rice, baked goods, etc.) at ambient temperatures for time periods between 0-1 week, 0-1 month, 0-1 years, or 1-5 years of storage.

In some instances, stability of one or more food component(s) (<about 20% change in one or more stability properties) is maintained after storage in a dry powder (e.g., supplement powder, milk powder, baby formula, flour, etc.) at ambient temperatures for time periods between 0-1 week, 0-1 month, 0-1 years, or 1-5 years of storage.

In some instances, stability of one or more food component(s) (<about 20% change in one or more stability properties) is maintained after storage in a liquid beverage (e.g., coffee, drinkable yogurt, protein beverage, water, soda, Gatorade, sports drinks, etc.) at ambient temperatures for time periods between 0-1 week, 0-1 month, 0-1 years, or 1-5 years of storage.

In some embodiments, disclosed tastant compositions are stable (<about 20% change in one or more stability properties) up to 2 weeks, up to 1 month, up to 6 months, up to 1 year, up to 2 years, up to 5 years, etc. in water at ambient temperature.

In some embodiments, disclosed tastant compositions are stable (<about 20% change in one or more stability properties) up to 2 weeks in yogurt at ambient temperature.

In some embodiments, disclosed tastant compositions are stable (<about 20% change in one or more stability properties) up to 2 weeks in milk powder at ambient temperature.

In some embodiments, disclosed tastant compositions are stable (<about 20% change in one or more stability properties) up to 2 weeks in baby formula at ambient temperature.

In some embodiments, disclosed tastant compositions are stable (<about 20% change in one or more stability properties) up to 2 weeks in milk powder at ambient temperature.

In some embodiments, disclosed tastant compositions are stable (<about 20% change in one or more stability properties) up to 2 weeks in high dry powders at ambient temperature.

In some embodiments, disclosed tastant compositions are stable (<about 20% change in one or more stability properties) up to 2 weeks in a sachet at ambient temperature.

In some embodiments, disclosed tastant compositions are stable (<about 20% change in one or more stability properties) up to 2 weeks when combined with animal feed (e.g., total meal ration, animal feed pellets, etc.) at ambient temperature.

In some embodiments, tastant compositions may be effective to protect food component(s) against humidity-induced degradation. In some instances, food component(s) dispersed in food product(s) is or are stable (<about 20% change in one or more stability properties) when exposed to ambient humidity (e.g., 30% relative humidity) at ambient temperatures (e.g., 25° C.) for up to 6 weeks.

In some embodiments, tastant compositions are incorporated into a food and/or beverage product in the presence of humidity (e.g., water, moisture content, water activity). In some instances, tastant compositions are effective to protect food component(s) against humidity-induced degradation. In some instances, food component(s) is or are stable (<about 20% change in one or more stability properties) when exposed to >15%, >20%, >25%, and/or >30% relative humidity, at >−20° C. and/or >4° C. and/or >25° C. and/or >30° C. and/or >35° C. and/or >37° C. and/or >50° C., for >1, >2, >3, >4, >6, and/or >8 weeks.

In some instances, stability of the food component (<about 20% change in one or more stability properties) is maintained after storage in a freezer (−85 C to 0° C.), a refrigerator (1-10° C.), or atmospheric temperature (−10° C.-40° C.) for time periods between 0-1 week, 0-1 month, 0-1 years, or 1-5 years of storage.

In some instances, protection against oxygen, heat, light, and water of a food component is maintained after storage in a freezer (−85° C. to 0° C.), a refrigerator (1-10° C.), or atmospheric temperature (−10° C.-40° C.) for time periods ranging from 0-1 week, 0-1 month, 0-1 year, and/or 1-5 years of storage.

In certain embodiments, the disclosed tastant compositions provide protection against degradation (e.g., oxidation, hydrolysis, isomerization, fragmentation, lysis, or a combination thereof) of food component(s). In some embodiments, the disclosed tastant compositions comprise core-shell and/or matrix preparations wherein food components are protected from environmental factors (e.g., water, humidity, moisture, water activity, light, heat, and/or acid).

It is contemplated that provided tastant compositions disclosed herein are suitable for use in varying consumable compositions (e.g., a food product, a beverage product, an animal-consumable product). It is further contemplated that provided tastant compositions disclosed herein are suitable for use in consumable compositions of high water activity. In some instances, disclosed tastant compositions provide for stability of food component(s) further characterized as core components, shell components, matrix components, solute components, or a combination thereof when used with consumable compositions (e.g., a food product, a beverage product, an animal-consumable product).

### D. Methods of Manufacturing Food Composition(s)

The present disclosure provides a method of manufacturing (e.g., formulating) one or more tastant composition(s) that comprises, on a dry weight basis, at least about 90%, at least about 95%, and/or at least about 99% of one or more food component(s), as described herein. Additionally, or alternatively, the disclosure provides a means of controlling the release of one or more food component(s) from one or more tastant composition(s). In certain embodiments, a means of controlling the release of one or more food component(s) is characterized as being a physical arrangement (e.g., formulation) of one or more food component(s) comprising one more tastant composition(s). In certain embodiments, the physical arrangement (e.g., formulation) of one or more food component(s) comprising one or more tastant composition(s) is further characterized as a core-shell preparation and/or a matrix preparation. In certain embodiments, one or more core-shell and/or matrix preparations are further characterized as particle preparations.

In some aspects, the disclosure provides a method of manufacture for tastant compositions (e.g., formulated tastants) for improving taste and/or health benefits. In certain embodiments, one or more matrix preparation(s) are formulated using one or more matrix component(s) and one or more solute component(s). In certain embodiments, one or more core-shell preparation(s) are formulated using one or more shell component(s) and one or more core component(s). In certain embodiments, one or more solute component(s) are characterized as a core-shell preparation. In certain embodiments, one or more core component(s) are characterized as a matrix preparation. Among other things, the present disclosure provides a method of formulating one or more matrix, solute, core, and/or shell component(s). Among other things, the present disclosure provides a method of formulating one or more core-shell preparations and/or matrix preparations.

In certain embodiments, tastant compositions (e.g., formulated tastants) are characterized by average particle diameter. In some cases, tastant compositions (e.g., formulated tastants) are characterized as having an average particle diameter of <10000 μm, <5000 μm, <1000 μm, <500 μm, <250 μm, <125 μm, <50 μm, <20 μm, and/or <5 μm. In certain preferred embodiments, one or more tastant composition(s) are characterized as having an average particle diameter between about 10 μm-200 μm.

In certain preferred embodiments, one or more tastant composition(s) are characterized as having an average particle diameter between about 50 μm-800 μm. In certain preferred embodiments, one or more tastant composition(s) are characterized as having an average particle diameter in a range from about 90 μm-400 μm.

### (i) Methods of Size Reduction

In some cases, one or more core, shell, matrix, solute, core-shell, and/or matrix preparation component(s), as described herein, are reduced to a size (e.g., size reduction) amenable to homogeneous formulation. In some cases, one or more core, shell, matrix, solute, core-shell, and/or matrix preparation component(s) is reduced to a size (e.g., size reduction) amenable to mitigate any sensory aspects (e.g., texture, grit, taste, etc.). In some cases, one or more core, shell, matrix, solute, core-shell, and/or matrix preparation component(s) undergoing one or more size reduction processes are characterized as a particle preparation, as described herein. In some cases, one or more core, shell, matrix, solute, core-shell, and/or matrix preparation component(s) characterized as particle preparation(s) are further characterized by particle diameter, morphology, and/or porosity.

For example, in some embodiments, methods of size reduction of tastant compositions (e.g., formulated tastants) include, but are not limited to, planetary milling, ball milling, burr milling, roller milling, media milling, impact milling, jet milling, high-pressure homogenization, cryo milling, hammer milling, conical milling, hand screening, or granulation/extrusion, extrusion, spray drying, fluid bed agglomeration, spray congealing, high-shear granulation, tableting, pouring, roller compaction, crosslinking, prilling, spinning disc atomization, and/or combinations thereof.

### (ii) Methods of Mixing

In some cases, one or more core, shell, matrix, solute, core-shell, and/or matrix preparation component(s), as described herein, are mixed within a homogeneous formulation. In some cases, mixing is between solid food component(s) in liquid food component(s), solid food component(s) in solid food component(s), liquid food component(s) in liquid food component(s), and/or liquid food component(s) in solid food component(s). In some cases, mixing of one or more core, shell, matrix, solute, core-shell, and/or matrix component(s) enables uniformity of sensory aspects (e.g., texture, grit, taste, etc.). In some cases, mixing of one or more core, shell, matrix, solute, core-shell, and/or matrix component(s) enables a uniform distribution in a formulation. In some cases, mixed core, shell, matrix, solute, core-shell, and/or matrix preparation component(s) are characterized by concentration as a function of sampling location.

For example, in some embodiments, methods of mixing of tastant compositions (e.g., formulated tastants) include, but are not limited to, stir-bar, overhead stirring, ultrasonic mixing, high-shear mixing, and/or combinations thereof.

(iii) Methods of Preparing Matrix Component(s) and/or Matrix Preparation(s)

In some cases, methods of preparation of one or more matrix component(s) and/or matrix preparation(s) are provided. In certain embodiments, one or more matrix component(s) and/or matrix preparation(s) is characterized as a solid, a gel, a particle, a liquid, or combinations thereof. In certain embodiments, one or more matrix component(s) and/or matrix preparation(s) is characterized as having partial, high, and/or complete solubility in water (e.g., hydrophilic). In certain embodiments, one or more matrix component(s) and/or matrix preparation(s) are characterized as having no, low, and/or moderate solubility in water (e.g., hydrophobic). In certain embodiments, one or more matrix component(s) and/or matrix preparation(s) are characterized as being amphiphilic. In certain embodiments, the preparation of one or more matrix component(s) and/or matrix preparation(s) is characterized as solidification, crystallization, self-assembly, gelation, and/or hydration.

In certain embodiments, the preparation of one or more matrix component(s) and/or matrix preparation(s), characterized as solidification, crystallization, self-assembly, gelation, and/or hydration, is achieved through heating, in a range of about 20° C. to about 200° C., mixing of one or more tastant composition(s), and subsequent cooling in a range of about −40° C. to about 20° C. In certain embodiments, the preparation of one or more matrix component(s) and/or matrix preparation(s), characterized as solidification, crystallization, self-assembly, gelation, and/or hydration, is achieved through the action of a trigger (e.g., exposure to water, pH, light, physical forces, chemical reaction, enzymatic reaction) as provided herein.

In certain embodiments, the preparation of one or more matrix component(s) and/or matrix preparation(s) further includes size reduction, as provided herein.

(iv) Methods of Preparing Shell Component(s) and/or Core-Shell Preparation(s)

In some cases, methods of preparation of one or more shell component(s) and/or core-shell preparation(s) are provided. In certain embodiments, one or more shell component(s) and/or core-shell preparation(s) is characterized as a solid, a gel, a particle, a liquid, or combinations thereof. In certain embodiments, one or more shell component(s) and/or core-shell preparation(s) is characterized as having partial, high, and/or complete solubility in water (e.g., hydrophilic). In certain embodiments, one or more shell component(s) and/or core-shell preparation(s) are characterized as having no, low, and/or moderate solubility in water (e.g., hydrophobic). In certain embodiments, one or more shell component(s) and/or core-shell preparation(s) are characterized as being amphiphilic. In certain embodiments, the preparation of one or more shell component(s) and/or core-shell preparation(s) is further characterized as a coating process and/or layering process.

As provided herein, methods of coating and/or layering may be or comprise a single method of coating and/or layering. In some instances, methods of coating and/or layering may be or comprise at least 1, 2, or 3 successive methods of coating and/or layering. In some instances, methods of coating and/or layering may be or comprise several successive methods of coating and/or layering.

For example, in some embodiments, methods of coating comprise, but are not limited to, spray pan coating, fluidized bed coating, dip coating, roller coating, sputter coating, self-assembly, or combinations thereof.

For example, in some embodiments, methods of layering comprise, but are not limited to, dip coating, roller coating, layered deposition, vapor deposition, physical arrangement, or combinations thereof.

In certain embodiments, one or more shell component(s) and/or core-shell preparation(s) are prepared by homogenous coating and/or layering of one or more core component(s), solute component(s), and/or matrix preparation(s) with an aqueous solution of one or more shell component(s) and/or core-shell preparation(s). In certain embodiments, one or more shell component(s) and/or core-shell preparation(s) are prepared by heterogeneous coating and/or layering of one or more core component(s), solute component(s), and/or matrix preparation(s) with an aqueous solution of one or more shell component(s) and/or core-shell preparation(s). In certain embodiments, one or more shell component(s) and/or core-shell preparation(s) are prepared by homogenous coating and/or layering of one or more core component(s), solute component(s), and/or matrix preparation(s) with an organic solution of one or more shell component(s) and/or core-shell preparation(s). In certain embodiments, one or more shell component(s) and/or core-shell preparation(s) are prepared by heterogeneous coating and/or layering of one or more core component(s), solute component(s), and/or matrix preparation(s) with an organic solution of one or more shell component(s) and/or core-shell preparation(s).

In some embodiments, a method of coating a tastant compositions (e.g., formulated tastants) uses or may utilize materials that improve (e.g., protect, or improve the functionality of) the tastant compositions (e.g., formulated tastants). In some cases, a method of coating a tastant compositions (e.g., formulated tastants) improves resistance to moisture (e.g., humidity, water, water activity). In some cases, a method of coating a tastant compositions (e.g., formulated tastants) improves resistance to acidity (e.g., pH responsive materials). In some cases, a method of coating a tastant composition reduces porosity. In some cases, a method of coating a tastant compositions (e.g., formulated tastants) reduces agglomeration, aggregation, and/or tackiness. In some cases, a method of coating a tastant composition increases gastrointestinal residence time (e.g., mucoadhesive components). In some cases, a method of coating a tastant composition improves taste and/or fragrance.

In certain embodiments, the preparation of one or more shell component(s) and/or core-shell preparation(s) further includes size reduction, as provided herein.

### (v) Methods of Drying Tastant Composition(s)

In certain embodiments, a method of drying tastant compositions (e.g., formulated tastants) is provided. In some cases, drying of a tastant compositions (e.g., formulated tastants) comprises reduction of moisture content. In some cases, drying of a tastant compositions (e.g., formulated tastants) comprises reduction of water activity.

The disclosed method of drying certain tastant compositions (e.g., formulated tastants), as provided herein, improves upon the prior art by further eliminating exposure of food components (e.g., micronutrients, macronutrients, etc.) to moisture and/or presence of water.

In certain embodiments, drying of certain tastant compositions (e.g., formulated tastants) is achieved by the use of chemical drying agents, elevated temperature, vacuum, or combinations thereof.

For example, in some embodiments, drying of tastant compositions (e.g., formulated tastants) is achieved by use of drierite, heating, vacuum, molecular sieves, sodium sulfate, magnesium sulfate, calcium carbonate, calcium chloride, or combinations thereof.

### (vi) Method of Quantifying Amount of Food Component(s) in One or More Tastant Composition(s)

In certain aspects, the present disclosure provides methods for the quantification of food component(s) present in one or more disclosed tastant composition(s) (e.g., loading). In certain embodiments, quantifying loading is beneficial to understanding the efficiency of the manufacturing process. In certain embodiments, quantifying loading is beneficial to understanding the relative composition of tastants in one or more tastant composition(s). In certain embodiments, quantifying loading is beneficial to understanding the nutritional content of one or more tastant composition(s).

In certain embodiments, loading of one or more tastant composition(s) is quantification of amount of one food component. In certain embodiments, loading of one or more tastant composition(s) is quantification of amount of several distinct food components. In certain embodiments, quantification of one or more food component(s) within one or more tastant composition(s) is quantification of the concentration (e.g., amount) of one or more food component(s) following complete release (e.g., 100%) from one or more tastant composition(s).

In certain embodiments, loading of one or more tastant composition(s) is quantified by subjecting one or more tastant composition(s) to one or more dissolution solvent(s) and/or trigger(s) to effect complete release.

In certain embodiments, quantification of one or more food component(s) is achieved using at least one of nuclear magnetic resonance, mass spectrometry, liquid chromatography, intrinsic colorimetry, intrinsic fluorimetry, enzymatic colorimetry, enzymatic fluorimetry, enzymatic amperometry, and/or antibody-mediated recognition (e.g., ELISA, Western blot).

### E. Means of Controlling Physiological Response

In certain embodiments, one or more delivery functions of tastant composition(s) (e.g. extending retention time, controlling release rate, controlling adsorption/absorption rates, controlling spatial interaction and concentrations, and facilitating passage through selective barriers and components) is characterized as enabling controlled physiological response (e.g. physiological modulation) and providing a health benefit. In certain embodiments, a health benefit provided by one or more delivery functions of tastant composition(s) is increased and/or extended satisfaction and/or satiety. In certain embodiments, a health benefit provided by one or more delivery functions of tastant composition(s) is a reduced salt and/or sugar and/or fat in food and/or beverages. Without being bound by any theory, tastant composition(s) confer a health benefit(s) through a delivery function(s) that extends and/or enhances taste, thereby reducing the required dosage of salt and/or sugar and/or fat in a food and/or beverage to produce the same level of taste and/or reducing the need to replace a loss and/or reduction in taste with additional ingestion of food and/or beverage.

Alternatively or additionally, in certain embodiments, one or more food component(s), excipient component(s), and/or tastant composition(s) themselves are characterized as controlling physiological response (e.g., physiological modulator).

As provided herein, one or more physiological modulator(s) are characterized by the modulation of an endogenous physiological satiety response. In certain embodiments, one or more physiological modulator(s) elicits an endogenous physiological satiety response to provide satisfaction and/or satiety. In certain embodiments, an endogenous physiological satiety response may be characterized by factors including, but not limited to: reduced desire to eat, reduced serum ghrelin, increased serum leptin, and/or cephalic-phase response. In certain embodiments, physiological modulation of satiety is achieved through chemical means.

In certain embodiments, chemical means of modulating a physiological response to satiety include selection of food component(s) and/or selection of food component release profile(s). In certain embodiments, one or more tastant composition(s) characterized as a core-shell preparation and/or a matrix preparation provides a chemical means of modulating a physiological response to satiety.

For example, in certain embodiments, one or more food component(s) characterized as a chemical modulator of physiological response include micronutrients, macronutrients, or combinations thereof. For example, in certain embodiments, a micronutrient is tannic acid, ellagitannin, apigenin, luteolin, tangeritin, isorhamnetin, kaempferol, myricetin, quercetin, genipin, rutin, eriodictyol, hesperetin, naringenin, catechin, gallocatechin, epicatechin, epigallocatechin, theaflavin, daidzein, genistein, glycitein, resveratrol, pterostilbene, hydroxytyrosol, cyanidin, delphinidin, malvidin, pelargonidin, peonidin, petunidin, chicoric acid, chlorogenic acid, cinnamic acid, ellagic acid, gallic acid, sinapic acid, rosmarinic acid, salicylic acid, curcumin, piperine, silymarin, silybin, eugenol, melatonin, methylcobalamin, adrafinil, cathine, cathinone, dextroamphetamine, ephedrine, epinephrine, armodafinil, modafinil, phenylethylamine, synephrine, theanine, 5-hydroxytryptophan, caffeine, theobromine, and/or taurine. For example, in certain embodiments, a macronutrient is aspartame, GLP-1, GLP-2, collagen, sermorelin, tesamorelin, lenomorelin, anamorelin, ipamorelin, macimorelin, ghrelin, leptin, tabimorelin, alexamorelin, GHRP-1, GHRP-2, GHRP-3, GHRP-4, GHRP-5, GHRP-6, hexarelin, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, and/or sodium carboxymethylcellulose.

In certain embodiments, a release profile of one or more micronutrient(s) and/or macronutrient(s) is a chemical means of modulating a physiological response. For example, in certain embodiments, the release profile(s) of one or more macronutrients (e.g., carbohydrates, proteins, fats) is controlled in order to maximize satiety. For example, without wishing to be bound by any particular theory, in certain embodiments, the release profile(s) of one or more carbohydrates (e.g., glucose, sucrose) are characterized as slow, constant release to provide a continuous energy source. For example, without wishing to be bound by any particular theory, in certain embodiments, the release profile(s) of one or more proteins (e.g., whey protein, soy protein) are characterized as bolus dose in 8 hour intervals to sufficiently stimulate growth hormone secretion.

In certain embodiments, one or more physical and/or chemical means of modulating a physiological response for at least about 8 hours, about 10 hours, about 12 hours, about 16 hours, about 20 hours, and/or about 24 hours.

In certain embodiments, one or more physical and/or chemical means of modulating a physiological response to satiety comprise, on a dry weight basis, at least about 0%, about 1%, about 5%, about 10%, about 15%, about 20%, about 25%, about 50%, about 75%, about 90%, about 95%, about 99%, and/or about 100% of one or more means of providing satisfaction and/or satiety.

### F. Facilitating Payload Passage

In certain embodiments, enhancing taste of a payload comprises an effective dose of one or more taste facilitator(s). As provided herein, one or more taste facilitator(s) are characterized by the facilitation of a payload through selective barriers and components. In certain embodiments, one or more taste facilitator(s) is characterized by an ability to penetrate into the taste bud from the mucosal, serosal or vascular environments. In certain embodiments, one or more taste facilitator(s) is characterized by reducing the activity and/or effectiveness of enzymatic components of a selective barrier. In certain embodiments, one or more taste facilitator(s) is characterized by reducing the activity and/or effectiveness of physical components of a selective barrier. In certain embodiments, one or more taste facilitator(s) is characterized by reducing the activity and/or effectiveness of molecular components of a selective barrier. Without wishing to be bound by any particular theory, it is contemplated that one or more taste facilitator(s) bypasses or reduces the effectiveness of selective barriers to taste cells, thereby increasing access and/or binding of tastants to taste cells, enhancing taste. In certain embodiments, means of facilitating payload passage (e.g., taste facilitators) are comprised of one or more food component(s), excipient component(s), and/or tastant composition(s), as provided herein.

In certain embodiments, an effective dose of one or more taste facilitator(s) comprising one or more food component(s), excipient component(s), and/or tastant composition(s) is characterized by an ability to inhibit, neutralize or otherwise reduce the effectiveness of one or more components of selective barriers to taste cells. For example, in certain embodiments, an effective dose of one or more taste facilitator(s) results in the degradation of at least about 10%, about 20%, about 30%, about 40%, about 50%, about 60%, about 75%, about 90%, and/or about 100% of proteoglycan. For example, in certain embodiments, an effective dose of one or more taste facilitator(s) reduces the activity of extracellular ATPase (e.g. ectonucleotidase NTPDase2) by at least about 10%, about 20%, about 30%, about 40%, about 50%, about 60%, about 75%, about 90%, and/or about 100%.

For example, a taste facilitator may be comprised of at least one of Clostridium-perfringens, verapamil, EGTA, EDTA, sodium caprate, salcaprozate sodium, collagenase, dispase, elastase, heparitinase, chondroitinase, hyaluronidase, and/or lysozyme.

In certain embodiments, one or more food component(s), excipient component(s), and/or tastant composition(s) are characterized as facilitating payload passage through selective barriers and components (e.g. enzymatic components (ATPases, etc.), physical components (zonula occludens, etc.), molecular components (chondroitin, heparan sulfates, glycosaminoglycans, proteoglycans, etc.).

One skilled in the art will appreciate that one or more taste facilitator(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more taste facilitator(s) comprise, on a dry weight basis, at least about 0%, about 1%, about 5%, about 10%, about 15%, about 20%, about 25%, about 50%, about 75%, about 90%, about 95%, about 99%, and/or about 100% of one or more tastant compositions.

### G. Controlling Taste Receptor Binding

In certain embodiments, enhancing taste of a payload comprises an effective dose of one or more taste modulator(s). As provided herein, one or more taste modulator(s) are characterized by controlling the binding and/or response of a tastant to a taste receptor. In certain embodiments, one or more taste modulators(s) is characterized by potentiating the perceived taste of tastant(s). In certain embodiments, one or more taste modulator(s) is characterized by binding to G protein coupled receptors of taste cells. In certain embodiments, one or more taste modulator(s) is characterized by allosteric or orthosteric modulation of taste receptors. In certain embodiments, means of modulate the binding and/or response of a tastant to a taste receptor (e.g., taste modulators) are comprised of one or more food component(s), excipient component(s), and/or tastant composition(s), as provided herein.

In certain embodiments, an effective dose of one or more taste modulator(s) comprising one or more food component(s), excipient component(s), and/or tastant composition(s) is characterized by an ability to modulate the binding and/or response of a tastant to a taste receptor. For example, in certain embodiments, an effective dose of one or more taste modulator(s) results in an increased stabilization of a specific conformation of a taste receptor by at least about 10%, about 20%, about 30%, about 40%, about 50%, about 60%, about 75%, about 90%, and/or about 100%.

In certain embodiments, one or more food component(s), excipient component(s), and/or tastant composition(s) are characterized by controlling the binding and/or response of a tastant to a taste receptor.

For example, a taste modulator may be characterized as being a metal and may comprise calcium, chromium, cobalt, copper, iodine, iron, magnesium, manganese, molybdenum, potassium, selenium, sodium, and/or zinc, and/or may be comprised of at least one of an anthocyanin and/or poryphyrin.

Having read the present disclosure, one skilled in the art will appreciate that one or more taste facilitator(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more taste modulators comprise, on a dry weight basis, at least about 0%, about 1%, about 5%, about 10%, about 15%, about 20%, about 25%, about 50%, about 75%, about 90%, about 95%, about 99%, and/or about 100% of one or more tastant compositions.

### H. Absorption Enhancers

In certain embodiments, a means of providing a nutritional benefit comprises an effective dose of one or more absorption enhancer(s). In certain embodiments, one or more absorption enhancer(s) is characterized by increasing the oral absorption of one or more food component(s). Without wishing to be bound by any particular theory, it is contemplated that a means of increasing tastant delivery increases the intensity of taste. In certain embodiments, means of increasing the absorption of one or more food component(s) (e.g., absorption enhancers) are comprised of one or more food component(s), excipient component(s), and/or tastant composition(s), as provided herein.

In certain embodiments, an effective dose of one or more absorption enhancer(s) comprising one or more food component(s), excipient component(s), and/or tastant composition(s) is characterized by an increase in the oral bioavailability of one or more food component(s). For example, in certain embodiments, an effective dose of one or more absorption enhancer(s) increases the bioavailability of one or more food component(s) by at least about 10%, about 20%, about 30%, about 40%, about 50%, about 60%, about 75%, about 90%, and/or about 100%. For example, in certain embodiments, an effective dose of one or more absorption enhancer(s) increases the bioavailability of one or more food component(s) by at least about 1-fold, 2-fold, 3-fold, 5-fold, 10-fold, 20-fold, and/or 50-fold.

In certain embodiments, one or more absorption enhancers is comprised of at least one or more food component(s), excipient component(s), and/or tastant composition(s). In certain embodiments, one or more absorption enhancers is characterized by one or more release profile(s), as described herein. Without wishing to be bound by any particular theory, it is contemplated that the release profile of one or more absorption enhancer(s) is critical to its function. In certain embodiments, controlled release, as provided herein, is applied to one or more food component(s), excipient component(s), and/or tastant composition(s) comprising an absorption enhancer.

For example, an absorption enhancer may be comprised of at least one of sodium caprylate, sodium caprate, sodium laurate, sodium oleate, sodium linoleate, propyl gallate, propyl syringate, propyl shikimate, octyl gallate, octyl syringate, octyl shikimate, ammoniated glycyrrhizin, quillaia extract, tocopherol PEG succinate, lauroyl polyoxylglycerides, polysorbate 80, ethanol, propylene glycol, poly(ethylene glycol), diethylene glycol monoethyl ether, sodium citrate, medium chain triglycerides, lipase, sodium lauryl sulfate, and/or ascorbyl palmitate.

Having read the present disclosure, one skilled in the art will appreciate that one or more absorption enhancer(s) further include, but are not limited to, substance(s) identified by one or more governing bodies as safe (e.g., generally regarded as safe and/or food additives). In some instances, those skilled in the art will appreciate that texture modifier(s) are or may be selected from those substance(s) recognized as Generally Regarded as Safe (i.e., GRAS) by the U.S. Food and Drug Administration. In some instances, those skilled in the art will appreciate that texture modifier(s) are or may be selected from those substance(s) recognized in 21 C.F.R. 184. In some instances, those skilled in the art will appreciate that texture modifier(s) are or may be selected from those substance(s) recognized in GB2760-2014 by the National Health and Family Planning Commission of the People's Republic of China.

In certain embodiments, one or more absorption enhancers comprise, on a dry weight basis, at least about 0%, about 1%, about 5%, about 10%, about 15%, about 20%, about 25%, about 50%, about 75%, about 90%, about 95%, about 99%, and/or about 100% of one or more means of reducing daily meal frequency.

### I. Characterizing Compositions and/or Components Thereof

In some embodiments, provided composition(s), and/or component(s) thereof, are subjected to one or more assessments, for example to characterize one or more structural features and/or functional properties thereof (e.g., for quality control and/or after storage under particular conditions and for a particular period of time). In some embodiments, batches that do not meet designated criteria may be discarded or not further utilized.

### EXEMPLIFICATION

The following examples are intended to illustrate but not limit the disclosed embodiments. The following examples are useful to confirm aspects of the disclosure described above and to exemplify certain embodiments of the disclosure.

These non-limiting examples demonstrate particular features and advantages of provided technologies—e.g., of provided tastant composition(s).

In some embodiments, the present disclosure provides technologies (e.g., tastant compositions, such as formulated tastants) that provide one or more advantages for tastants (e.g sugars, salts, carbohydrates, fats, proteins, vitamins, minerals, etc.) such as extending retention time in the oral cavity, controlling release rate, controlling adsorption and/or absorption rates, controlling spatial interactions and concentrations within the oral cavity and specific areas (e.g. tongue, throat, nasal cavities, mucosa, epithelium, taste buds, microvilli, taste bud cell, etc.), facilitating passage through selective barriers and components (e.g. enzymatic components (ATPases), physical components (zonula occludens), molecular components (chondroitin, heparan sulfates, glycosaminoglycans, proteoglycans)), controlling binding of to taste receptors, etc.

### J. Example 1: Encapsulation of Tastant

In certain embodiments, one or more food component(s) characterized by sweet taste are encapsulated in one or more core-shell preparations and/or matrix preparations. In one exemplary embodiment, one or tastants is encapsulated in a core-shell preparation further characterized as a particle preparation.

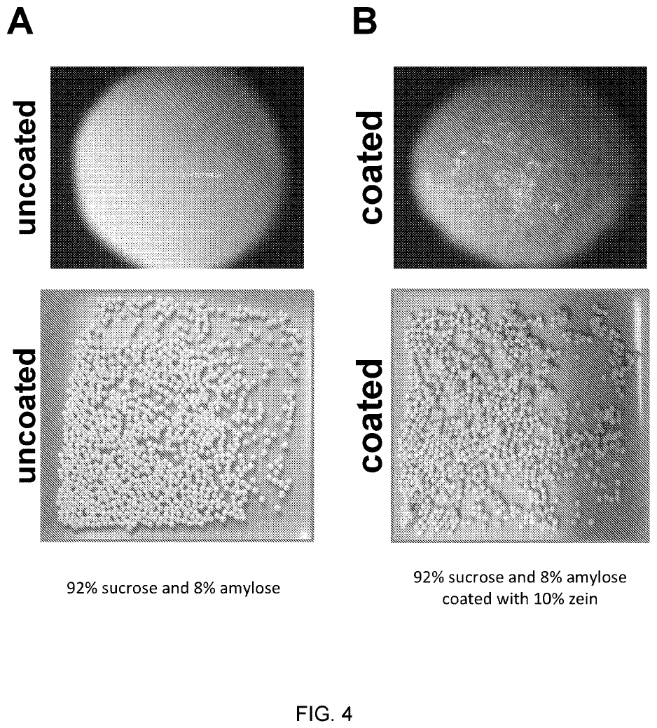

For example, in one non-limiting instance, a tastant composition comprised of a carbohydrate (e.g., a solute component) is embedded within a carbohydrate (e.g., a matrix component), further characterized as encapsulation of a carbohydrate. For example, in one non-limiting instance, a tastant composition comprised of an encapsulated carbohydrate (e.g., a matrix preparation) is encapsulated by a protein (e.g., a core-shell preparation). In one non-limiting instance, a core-shell preparation is further characterized as a particle preparation. For example, in FIG. 4A, sucrose is dispersed within a wet amylose matrix, the slurry sprayed into cool air to generate particles of controlled diameter. The encapsulation of sucrose within amylose is calculated to be 92%, on a dry weight basis. For example, in FIG. 4B, particles comprising encapsulated sucrose (92% loading, 2 mm diameter) are further coated (e.g., spray pan coating) with a 10% ethanolic solution of Zein with a colorant (e.g., excipient component). Brightfield micrographs reveal increased surface roughness and a red coloring, indicative of successful coating.

### K. Example 2: Exemplary Coating Formulation Protocols

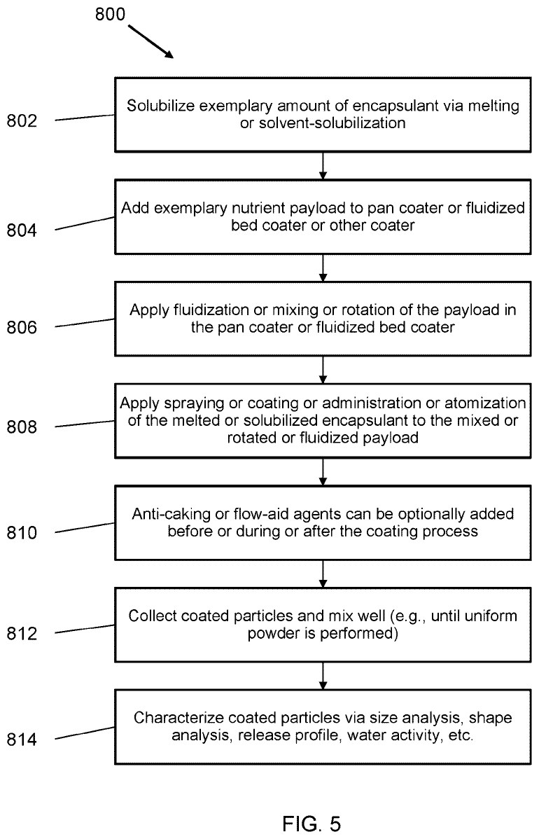

This example describes two non-limiting processes of arranging one or more food component(s) as a shell component to one or more food component(s) characterized as a core component via spray pan coating and/or fluidized bed spray coating. A schematic of an exemplary coating procedure, method, or protocol 800 is presented in FIG. 5. At step 802, the method 800 may include solubilizing an exemplary amount of encapsulant via melting or solvent-solubilization. At step 804, the method 800 may include adding an exemplary nutrient payload to pan coater or fluidized bed coater or other coater. At step 806, the method 800 may include applying fluidization or mixing or rotation of the payload in the pan coater or fluidized bed coater. At step 808, the method 800 may include applying spraying or coating or administration or atomization of the melted or solubilized encapsulant to the mixed, rotated and/or fluidized payload. At step 810, the method 800 may include adding anti-caking or flow-aid agents before, during and/or after the coating process. At step 812, the method 800 may include collecting the coated particles and thoroughly mixing (e.g., until uniform powder is achieved). At step 814, the method 800 may include characterizing the coated particles via size analysis, shape analysis, release profile, water activity, etc.

In one non-limiting example, tastant composition(s) are prepared in core-shell preparations using the procedure described below. Particle preparations comprising sucrose encapsulated in amylose (10 g) are coated using a spray pan coater with an inlet air temperature of 80° C., pan temperature of 70° C., rotation speed of 2 Hz, and spray rate of 0.5 mL/s. A 10% (w/v) ethanolic (90% ethanol) solution of Zein with 1% (v/v) Propylene Glycol and 0.5% (w/v) Talc powder is applied as a thin film over 5 minutes to the encapsulated sucrose. The volume-normalized weight gain due to coating is 120%]. The concentration of formulated tastant in this embodiment, on a dry weight basis, is 100% (w/w).

### L. Example 4: Exemplary Matrix Formulation Protocol

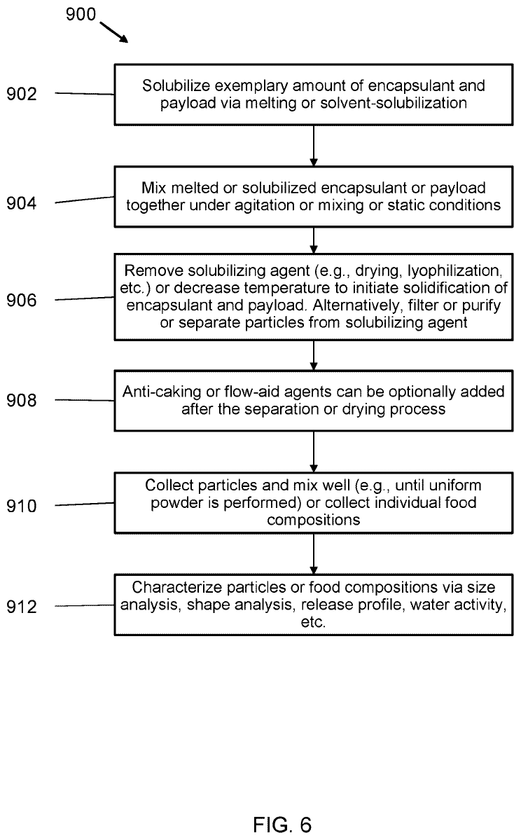

This example describes non-limiting processes of arranging one or more food component(s) as a matrix component to one or more food component(s) characterized as a solute component via melt-gelation. A schematic of an exemplary matrix formulation procedure, method, or protocol 900 is presented in FIG. 6. At step 902, the method 900 may include solubilizing an exemplary amount of encapsulant and payload via melting or solvent-solubilization. At step 904, the method 900 may include mixing melted or solubilized encapsulant or payload together under agitation or mixing or static conditions. At step 906, the method 900 may include removing the solubilizing agent (e.g., drying, lyophilization, etc.) or decreasing the temperature to initiate solidification of the encapsulant and payload. Alternatively, (or in addition), step 906 may include filtering, purifying and/or separating particles from the solubilizing agent. At step 908, the method 900 may include adding anti-caking or flow-aid agents after the separation and/or drying process(es). At step 910, the method 900 may include collecting particles and mixing (e.g., until uniform powder is achieved) and/or collecting individual food compositions. At step 912, the method 900 may include characterizing particles or food compositions via size analysis, shape analysis, release profile, water activity, etc.

In one non-limiting example, tastant composition(s) are prepared in matrix preparation using the procedure described below. Gelatin (10 g) is suspended in 100 mL of stirring deionized water and the suspension is heated to 65° C. Following complete solubilization of the gelatin at elevated temperature, 2 g of sucrose powder are added and allowed to dissolve for 5 minutes. The resulting clear solution is poured into a polypropylene mold and allowed to cool for 1 hour at 20° C. The density of the cooled gel is measured to be 0.87 g/cm³. The concentration of formulated tastant in this non-limiting embodiment, on a dry weight basis, is 100% (w/w).

### M. Example 5: Exemplary Dissolution Protocol

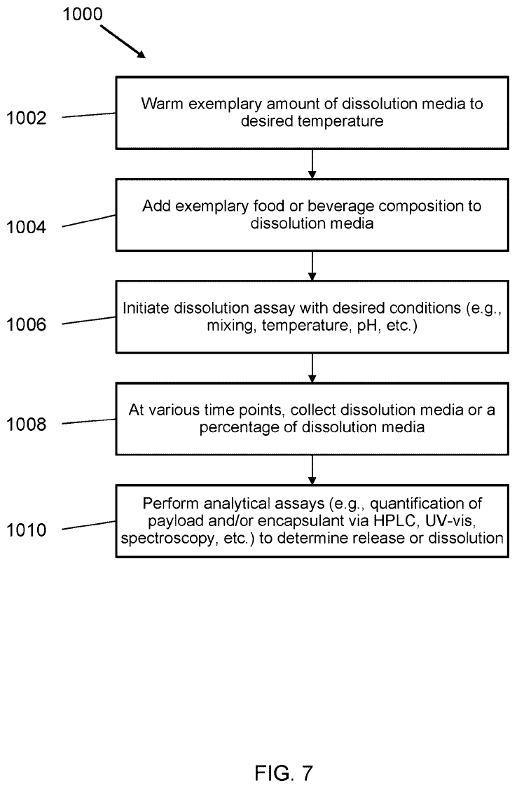

This example describes one non-limiting process of assessing the release (e.g., controlled release) of one or more food component(s) from one or more dissolution solvent(s). A schematic of an exemplary dissolution procedure, method, or protocol 1000 is presented in FIG. 7. At step 1002, the method 1000 may include warming an exemplary amount of dissolution media to a desired temperature. At step 1004, the method 1000 may include adding an exemplary food or beverage composition to the dissolution media. At step 1006, the method 1000 may include initiating dissolution assay with one or more desired conditions (e.g., via mixing, temperature, pH, etc.). At step 1008, the method 1000 may include collecting dissolution media and/or a percentage of dissolution media at various time points. At step 1010, the method 1000 may include performing analytical assays (e.g., quantification of payload and/or encapsulant via HPLC, UV-vis, spectroscopy, etc.) to determine release or dissolution characteristics.

In one non-limiting example, a tastant composition characterized as a core-shell preparation (e.g., Zein-coated amylose encapsulating sucrose) is assessed for controlled release in an aqueous dissolution solvent (e.g., 10 mM phosphate buffered saline, pH 7.4). 12 mL of 10 mM phosphate buffered saline are added to a polypropylene 15 mL centrifuge tube and allowed to equilibrate for 30 min while rotating at 10 rpm on a laboratory rotator. Exemplary core-shell preparations comprising Zein, sucrose, and amylose (500 mg) are added to the rotating tube. 100 μL aliquots are sampled at time points of 1 minute, 2 minutes, 5 minutes, 10 minutes, 15 minutes, 20 minutes, 30 minutes, 40 minutes, 50 minutes, and 60 minutes following addition of core-shell preparations and stored in 1.5 mL centrifuge tubes. The concentration of sucrose in collected aliquots is assayed using an enzymatic electrochemical method. Sucrose concentration, mass, and percent release is plotted with respect to incubation period to construct a release profile.

### N. Example 6: Exemplary Controlled Release Profiles

As provided herein, one or more tastant composition(s) is characterized by controlled release of one or more food component(s). Selection of release profile, as described herein, is intended to confer a benefit (as described herein) one or more animal(s). The following example depicts anticipated (e.g., theoretical) non-limiting release profiles exhibited by one or more tastant composition(s).

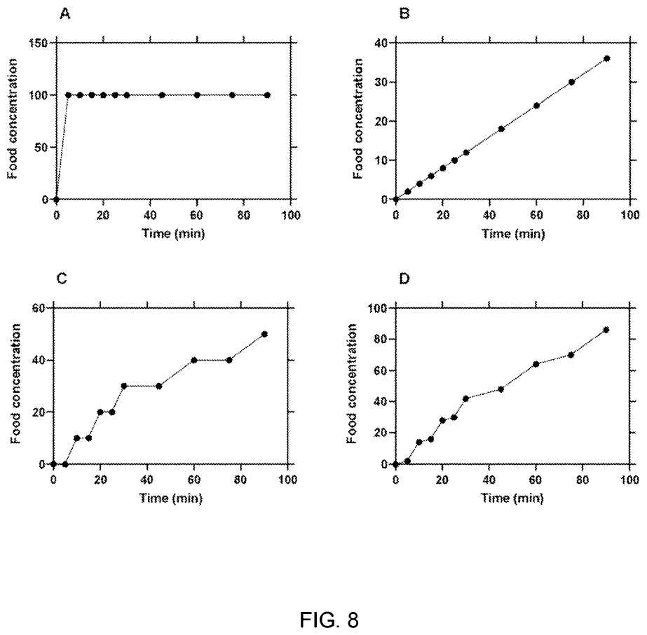

In one non-limiting example, the release of one or more food component(s) is characterized as a single bolus release, as measured by concentration present in one or more dissolution solvent(s) over time, as shown in FIG. 8A. In one non-limiting example, the release of one or more food component(s) is characterized as release with constant rate, as measured by concentration present in one or more dissolution solvent(s) over time, as shown in FIG. 8B. In one non-limiting example, the release of one or more food component(s) is characterized as multiple bolus dose (e.g., pulsatile) release, as measured by concentration present in one or more dissolution solvent(s) over time, as shown in FIG. 8C. In one non-limiting example, the release of one or more food component(s) is characterized as a combination of multiple bolus dose and constant release rate, as measured by concentration present in one or more dissolution solvent(s) over time, as shown in FIG. 8D.

### O. Example 7: Exemplary Controlled Release Profile from a Tastant Composition

Controlled release of one or more food component(s) from a formulated taste composition is demonstrated using the procedure described below.

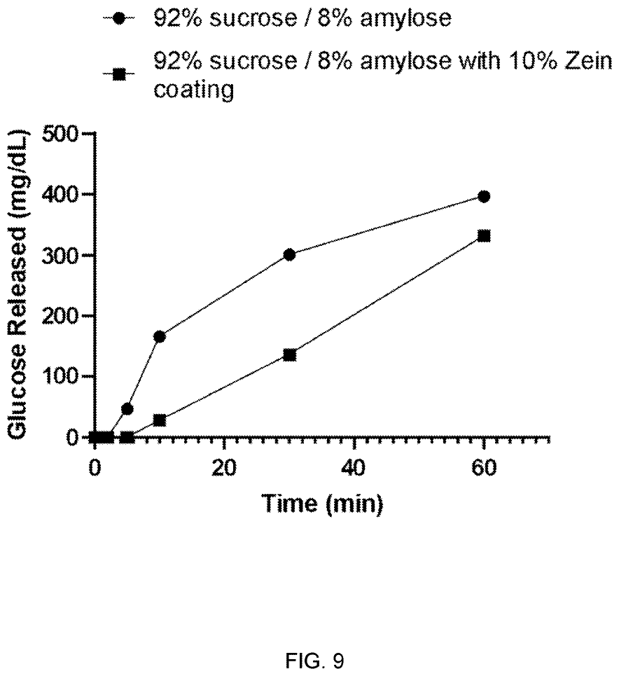

In one non-limiting example, sucrose-containing tastant composition(s) (500 mg) coated with Zein (see Example 2) were added to a 15 mL conical centrifuge tube filled (12 mL) with 10 mM phosphate buffered saline solution. The centrifuge tube was allowed to rotate at 10 rpm at 20° C. and 100 μL samples were collected every 15 minutes. Release of sucrose was quantified by a dual enzymatic electrochemical assay, first converting sucrose to glucose using Invertase from Yeast, followed by application to a glucometer. As shown in FIG. 9, the Zein coated sucrose particle preparations exhibited slower (<50 mg/dL) release of sucrose over 15 minutes relative to uncoated sucrose particle preparations (>150 mg/dL) over 15 minutes.

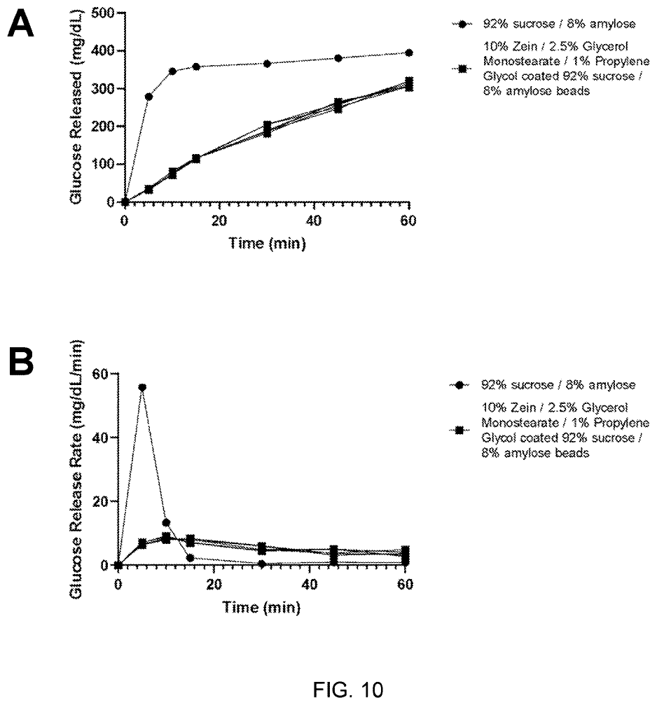

In another non-limiting example, sucrose-containing tastant composition(s) (500 mg) coated with, on a dry weight basis, 77% Zein (e.g., protein component), 21% Glycerol Monostearate (e.g., fat component), and 2% propylene glycol (e.g., excipient component) were added to a 15 ml conical centrifuge tube filled (12 mL) with 10 mM phosphate buffered saline solution. The centrifuge tube was allowed to rotate at 10 rpm at 20° C. and 100 μL samples were collected every 15 minutes. Release of sucrose was quantified by a dual enzymatic electrochemical assay, first converting sucrose to glucose using Invertase from Yeast, followed by application to a glucometer. As shown in FIG. 10A, the coated sucrose particle preparations exhibited slower (<50%) release of sucrose over 30 minutes relative to uncoated sucrose particle preparations (>90% in 10 minutes). Additionally, examination of release rate, shown in FIG. 10B, indicates that uncoated particle preparations exhibit bolus release while coated particle preparations exhibit constant sucrose release.

### P. Example 8: Incorporation of Tastant Composition(s) into Food and/or Beverage Products

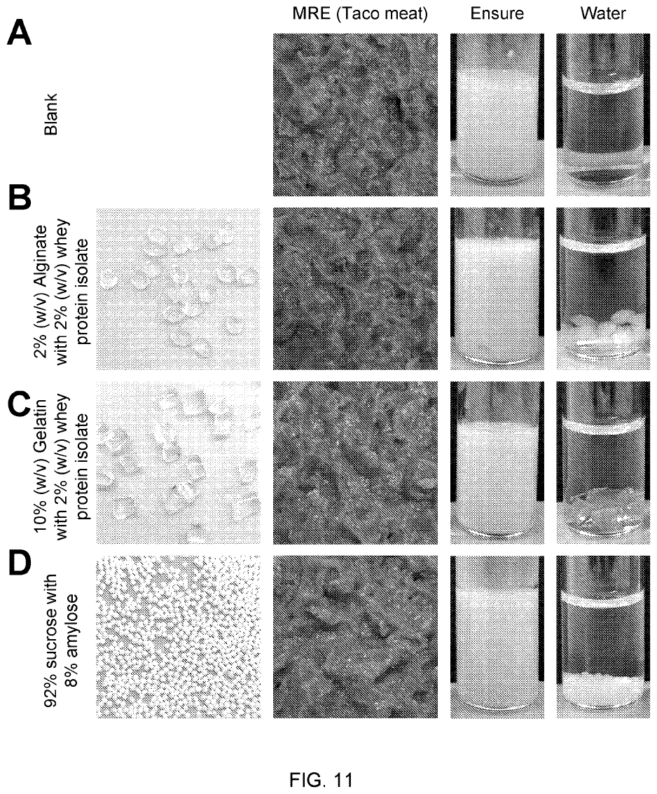

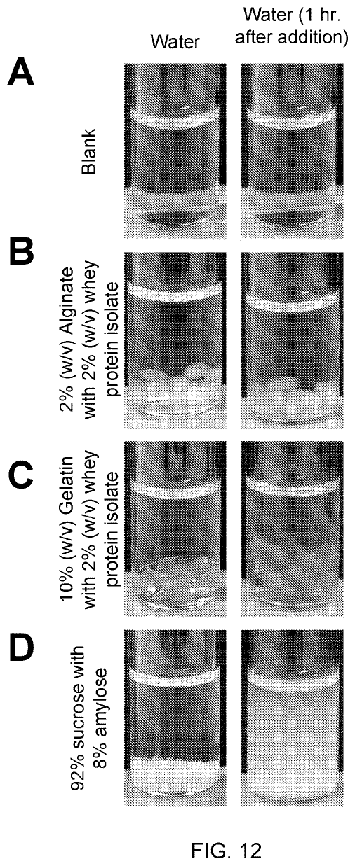

This example illustrates homogeneous mixtures of disclosed tastant composition(s) within food and/or beverage products (e.g., MRE, nutritional beverage, water) as demonstrated in FIGS. 11A-D. It is contemplated that non-limiting exemplary embodiments of tastant compositions can be homogeneously mixed with other food products such as freeze dried powder, protein powder, solid bars, domestic pet food (pellets), liquid shakes, pudding, etc. Homogenization can be achieved without additional processing aid or improved through addition of processing aid/excipients, through the use of mixing apparatuses such as a homogenizer, stand mixer, paddle blender, stir bar, spatula, etc. Without wishing to be bound by any particular theory, the present disclosure proposes that size characteristics and/or compositions of certain provided tastant composition(s) may surprisingly contribute desirable and/or useful attribute(s) to such particles, specifically including, for example, amenability to homogenous combination with other component(s). As shown in FIGS. 11B-D, incorporation of alginate beads, gelatin beads, each encapsulating sucrose, and/or sucrose-encapsulating beads into MRE and Ensure is homogeneous and associated with minimal change in visual appearance. In certain embodiments, incorporation of food composition(s) within one or more food and/or beverage products is associated with structural changes. In one non-limiting example (FIGS. 12A-D), food composition(s) are shown to change morphology over a 1-hour incubation period, with gelatin and alginate beads exhibiting expansion and sucrose-encapsulating beads exhibiting dissolution.

### Q. Example 9: Encapsulation of Carbohydrates

In certain embodiments, one or more taste component(s) characterized as a carbohydrate is or are encapsulated in one or more core-shell preparations and/or matrix preparations. In one exemplary embodiment, one or more carbohydrate(s) is or are encapsulated in a core-shell preparation further characterized as a particle preparation.

For example, in one non-limiting instance, a taste composition comprised of a carbohydrate (e.g., a solute component) further characterized as a monosaccharide is embedded within a carbohydrate (e.g., a matrix component) further characterized as a polysaccharide, demonstrating exemplary encapsulation of a carbohydrate. For example, in one non-limiting instance, a taste composition comprised of a carbohydrate (e.g., a solute component) further characterized as a polysaccharide is embedded within a carbohydrate (e.g., a matrix component) further characterized as a polysaccharide, demonstrating exemplary encapsulation of a carbohydrate. For example, in one non-limiting instance, a taste composition comprised of an encapsulated carbohydrate (e.g., a matrix preparation) is encapsulated by a polymer (e.g., excipient component) (e.g., a core-shell preparation). For example, in one non-limiting instance, a taste composition comprised of an encapsulated carbohydrate (e.g., a matrix preparation) is encapsulated by a protein (e.g., a core-shell preparation). In one non-limiting instance, a core-shell preparation is further characterized as a particle preparation.

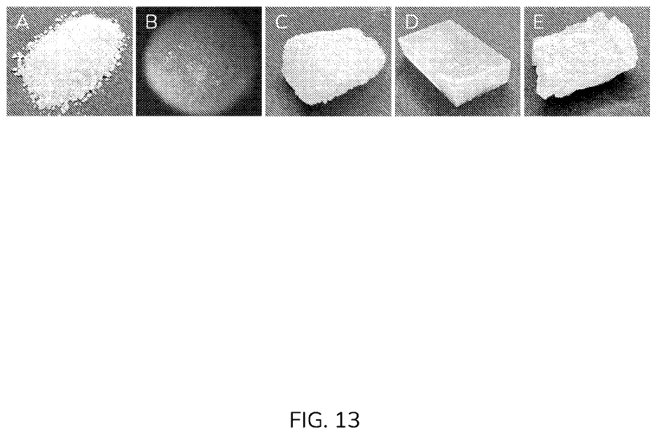

FIG. 13 illustrates a comparison between gross morphologies of unencapsulated (FIG. 13A) and encapsulated (FIGS. 13B-E) carbohydrates. For example, in FIG. 13B, sucrose is dispersed within a wet amylose matrix, the slurry sprayed into cool air to generate particles of controlled diameter. The encapsulation of sucrose within amylose is calculated to be 92%, on a dry weight basis. For example, in FIG. 13B, particles comprising encapsulated sucrose (92% loading, 1 mm diameter) are further coated (e.g., spray pan coating) with a 90% (v/v) solution of Zein with a colorant (e.g., excipient component). Brightfield micrographs reveal increased surface roughness and a red coloring, indicative of successful coating. For example, in FIG. 13C, 14 g of glucose is added to 6 mL of a stirring 5% (w/v) pectin solution held at 110° C. and the resulting mixture is stirred for 3 minutes, or until all glucose is dissolved. 1.0 mL of 1 M citric acid in distilled water is added to the stirring mixture, which is further mixed for 15 seconds before pouring into molds coated with loose glucose crystals and setting for 1 hour at 20° C. For example, in FIG. 13D, 100 mg of inulin (from dahlia tubers) is dissolved in 5 mL of distilled water and warmed to 60° C. while stirring. 5 mL of a 5% (w/v) solution of agarose at 130° C. is added to the stirring mixture, which is further mixed for 15 seconds before pouring into molds and setting for 1 hour at 20° C. For example, in FIG. 13E, 10 mL of a stirring 20% (w/v) suspension of calcium caseinate is added to 10 mL of a stirring 60° C. mixture of 5% (w/v) solution of sodium alginate and 2% (w/v) inulin (from dahlia tuber). The resulting mixture is allowed to stir for 15 seconds before pouring into molds and setting for 1 hour at 20° C. Unlike the free-flowing powder depicted in FIG. 13A, the formulations generated using the methods of manufacture outlined for FIG. 13C-E are cohesive particle preparation(s) indicating successful encapsulation.

### R. Example 10: Encapsulation of Proteins

In certain embodiments, one or more taste component(s) characterized as a protein is or are encapsulated in one or more core-shell preparations and/or matrix preparations. In one exemplary embodiment, one or more protein(s) is or are encapsulated in a core-shell preparation further characterized as a particle preparation.

For example, in one non-limiting instance, a taste composition comprised of a protein (e.g., a solute component) is embedded within a lipid (e.g., a matrix component), demonstrating exemplary encapsulation of a protein. For example, in one non-limiting instance, a taste composition comprised of a protein (e.g., a solute component) is embedded within a carbohydrate (e.g., a matrix component) further characterized as a polysaccharide, demonstrating exemplary encapsulation of a protein. For example, in one non-limiting instance, a taste composition comprised of an encapsulated protein (e.g., a matrix preparation) is encapsulated by a polymer (e.g., excipient component) (e.g., a core-shell preparation). For example, in one non-limiting instance, a taste composition comprised of an encapsulated protein (e.g., a matrix preparation) is encapsulated by a carbohydrate (e.g., a core-shell preparation). In one non-limiting instance, a core-shell preparation is further characterized as a particle preparation.

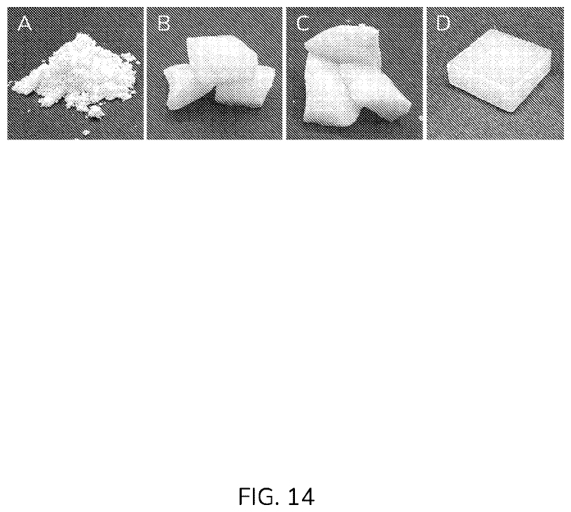

FIG. 14 illustrates a comparison between gross morphologies of unencapsulated (FIG. 14A, whey protein isolate) and encapsulated (FIG. 14B-D, encapsulated) protein. For example, in FIG. 14B, whey protein isolate powder is dispersed at 10000 rpm using a high-shear homogenizer within molten beeswax and the resulting dispersion is poured into a mold to set for 1 hour at 20° C. For example, in FIG. 14C, whey protein isolate powder is dispersed at 10000 rpm using a high-shear homogenizer within molten hydrogenated soy oil and the resulting dispersion is poured into a mold to set for 1 hour at 20° C. For example, in FIG. 14D, 5 mL of 5% (w/v) agarose solution at 130° C. is mixed with 5 mL of a solution comprising 20% (w/v) whey protein isolate and 2% (w/v) chitosan) at pH 5 and 60° C. The resulting mixture is allowed to stir for 15 seconds before pouring into molds and setting for 1 hour at 20° C. Unlike the free-flowing powder depicted in FIG. 14A, the formulations generated using the methods of manufacture outlined for FIG. 14B-D are cohesive particle preparation(s) indicating successful encapsulation.

### S. Example 11: Encapsulation of Lipids

In certain embodiments, one or more taste component(s) characterized as a lipid is or are encapsulated in one or more core-shell preparations and/or matrix preparations. In one exemplary embodiment, one or more lipid(s) is or are encapsulated in a core-shell preparation further characterized as a particle preparation.

For example, in one non-limiting instance, a taste composition comprised of a lipid (e.g., a solute component) is embedded within a lipid (e.g., a matrix component), demonstrating exemplary encapsulation of a lipid. For example, in one non-limiting instance, a taste composition comprised of a lipid (e.g., a solute component) is embedded within a carbohydrate (e.g., a matrix component) further characterized as a polysaccharide, demonstrating exemplary encapsulation of a lipid. For example, in one non-limiting instance, a taste composition comprised of an encapsulated lipid (e.g., a matrix preparation) is encapsulated by a polymer (e.g., excipient component) (e.g., a core-shell preparation). For example, in one non-limiting instance, a taste composition comprised of an encapsulated lipid (e.g., a matrix preparation) is encapsulated by a carbohydrate (e.g., a core-shell preparation). In one non-limiting instance, a core-shell preparation is further characterized as a particle preparation.

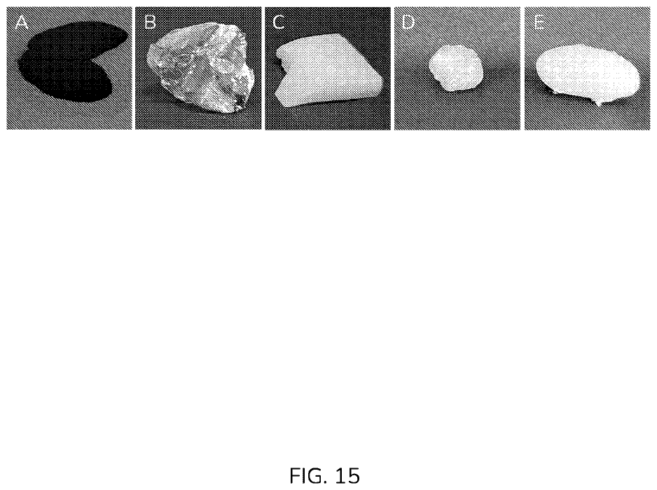

FIG. 15 illustrates a comparison between gross morphologies of unencapsulated (FIG. 15A, oleic acid) and encapsulated (FIG. 15B-E, encapsulated) lipid. For example, in FIG. 15B, 8 mL of oleic acid is heated, while stirring, to 130° C., followed by the addition of 2.0 g of ethyl cellulose (100 cP). The mixture is kept stirring at 130° C. for 10 minutes, or until all solids are dissolved, and the resulting clear solution is then poured into an aluminum pan to set at 20° C. for 1 hour. For example, in FIG. 15C, 8 mL of oleic acid is heated, while stirring, to 90° C., followed by the addition of 2.0 g of beeswax. The mixture is kept stirring at 90° C. for 10 minutes, or until all solids are dissolved, and the resulting clear solution is poured into an aluminum pan to set at 20° C. for 1 hour. For example, in FIG. 15D, 6.5 mL of oleic acid is heated, while stirring, to 130° C., followed by the addition of 1.0 g of carnauba wax and 1.5 g of ethyl cellulose. The mixture is kept stirring at 130° C. for 10 minutes, or until all solids are dissolved, and 1.0 g of whey protein isolate is added. After 15 seconds of stirring, the suspension is poured into an aluminum pan and allowed to set at 20° C. for 1 hour. The resulting waxy solid is then immersed and wrapped in an interfacial thin film comprised of chitosan-polyphosphate and allowed to dry at 50° C. for 6 hours. For example, in FIG. 15E, core component(s) prepared as described in FIG. 15D are instead coated by dipping into a 15% (w/v) solution of cellulose acetate phthalate in acetone and drying under air at 40° C. Unlike the loose oil depicted in FIG. 15B, the formulations generated using the methods of manufacture outlined for FIG. 15B-E are solid, cohesive particle preparation(s) indicating successful encapsulation.

### T. Example 12: Release of Carbohydrates from One or More Taste Composition(s)

In certain embodiments, one or more taste component(s) characterized as a carbohydrate is or are encapsulated in one or more core-shell preparations and/or matrix preparations. In certain embodiments, the encapsulation of one or more carbohydrate(s) in one or more matrix and/or core-shell preparation(s) is further characterized by the release of encapsulated carbohydrate(s) in one or more release environment(s). In some instances, the release profile(s), as provided herein, of carbohydrate(s) encapsulated in one or more matrix and/or core-shell preparation(s) illustrate controlled release of carbohydrate(s).

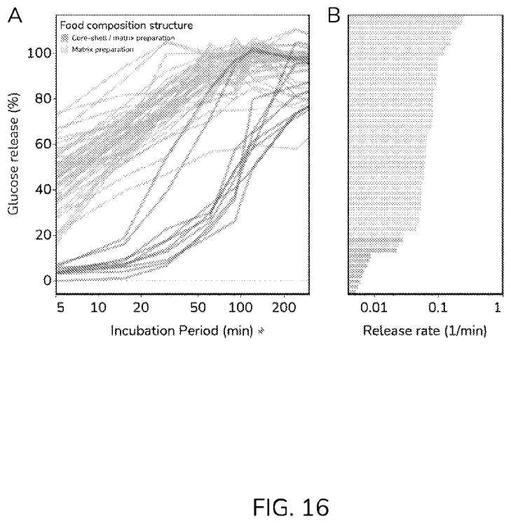

In some non-limiting instances, one or more taste composition(s) comprising carbohydrate(s) further characterized as core-shell preparation(s) and/or matrix preparation(s) provide a means of controlling carbohydrate release. In certain embodiments, the selection of one or more core component(s), shell component(s), and/or matrix component(s) and their relative concentration(s) provide a means of controlling release of carbohydrate(s). In one non-limiting embodiment (FIG. 16), the average release profiles (n=3) of an exemplary carbohydrate encapsulated within taste composition(s) comprising distinct core component(s), shell component(s), and/or matrix component(s) within a release environment comprising phosphate buffered saline, pH 7.4 at 37° C. are depicted. In this example, exemplary release profile(s) are provided by taste composition(s) further characterized as matrix preparation(s), core-shell preparation(s), and/or combinations of matrix and core-shell preparation(s). In some instances, the release profile(s) provided by one or more taste composition(s) changes in different release environment(s). In some instances, the release profile(s) provided by one or more taste composition(s) remains constant in different release environment(s). In certain preferred embodiments, the release profile(s) provided by one or more taste composition(s) illustrated in FIG. 16 enable the selection of taste composition(s) conferring desirable release profile(s) upon one or more carbohydrates, for example, to reduce meal frequency in one or more mammal(s).

In some non-limiting instances, one or more taste composition(s) providing for 80% release of encapsulated carbohydrate within 30 minutes is or may be advantageous. In some non-limiting embodiments, release of 80% of encapsulated carbohydrate tastant(s) within 30 minutes is or may be beneficial for applications where immediate sweetness is desired. In some non-limiting instances, one or more taste composition(s) providing for 80% release of encapsulated carbohydrate within 100 minutes is or may be advantageous. In some non-limiting embodiments, release of 80% of encapsulated carbohydrate tastant(s) within 100 minutes is or may be beneficial for applications where long-lasting sweetness is desired. In some non-limiting instances, one or more taste composition(s) providing for 80% release of encapsulated carbohydrate within 240 minutes is or may be advantageous. In some non-limiting embodiments, release of 80% of encapsulated carbohydrate tastant(s) within 240 minutes is or may be beneficial for applications where sweet-masking is desired.

As shown in FIG. 16, the time required to reach 80% (w/w) release of encapsulated carbohydrate(s) can vary from ˜7 minutes to >280 min depending on the concentration(s) and/or identity of one or more core component(s), shell component(s), and/or matrix component(s) comprising one or more taste composition(s). A complete list of exemplary taste composition(s), their associated core component(s), shell component(s) and/or matrix component(s), their respective concentration(s), and release rates are provided in Appendix 1. In some cases, the exemplary release profiles provided in FIG. 16 aid in the selection of desirable taste composition structure (e.g., core-shell preparation, matrix preparation, particle preparation). In some cases, the exemplary release profiles provided in FIG. 16 aid in the selection and relative concentration(s) of one or more core component(s), shell component(s), and/or matrix component(s).

As shown in FIG. 16, the release rate of glucose from one or more exemplary taste composition(s) varies substantially by taste composition structure (e.g., core-shell preparation, matrix preparation, particle preparation). Core-shell preparations wherein one or more core component(s) further comprise a matrix preparation generally offer slower release kinetics (<0.03 min⁻¹) relative to uncoated matrix preparations (>0.03 min⁻¹).

### U. Example 13: Release of Proteins from One or More Taste Composition(s)

In certain embodiments, one or more taste component(s) characterized as a protein is or are encapsulated in one or more core-shell preparations and/or matrix preparations. In certain embodiments, the encapsulation of one or more protein(s) in one or more matrix and/or core-shell preparation(s) is further characterized by the release of encapsulated protein(s) in one or more release environment(s). In some instances, the release profile(s), as provided herein, of protein(s) encapsulated in one or more matrix and/or core-shell preparation(s) illustrate controlled release of protein(s).

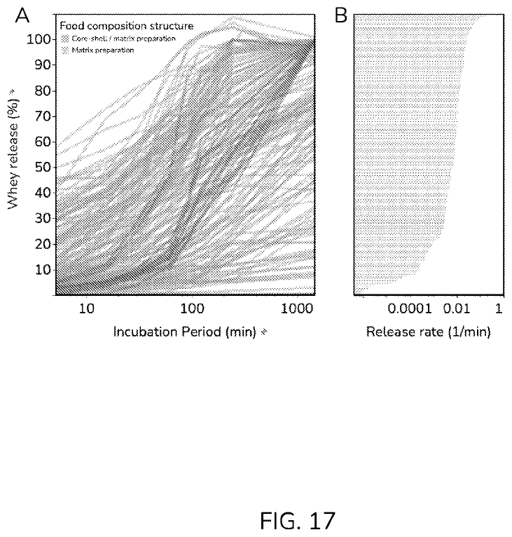

In some non-limiting instances, one or more taste composition(s) comprising protein(s) further characterized as core-shell preparation(s) and/or matrix preparation(s) provide a means of controlling protein release. In certain embodiments, the selection of one or more core component(s), shell component(s), and/or matrix component(s) and their relative concentration(s) provide a means of controlling release of protein(s). In one non-limiting embodiment (FIG. 17), the average release profiles (n=3) of an exemplary protein encapsulated within taste composition(s) comprising distinct core component(s), shell component(s), and/or matrix component(s) within a release environment comprising phosphate buffered saline, pH 7.4 at 37° C. are depicted. In this example, exemplary release profile(s) are provided by taste composition(s) further characterized as matrix preparation(s), core-shell preparation(s), and/or combinations of matrix and core-shell preparation(s). In some instances, the release profile(s) provided by one or more taste composition(s) changes in different release environment(s). In some instances, the release profile(s) provided by one or more taste composition(s) remains constant in different release environment(s). In certain preferred embodiments, the release profile(s) provided by one or more taste composition(s) illustrated in FIG. 17 enable the selection of taste composition(s) conferring desirable release profile(s) upon one or more carbohydrates, for example, to reduce meal frequency in one or more mammal(s).

In some non-limiting instances, one or more taste composition(s) providing for 80% release of encapsulated protein within 60 minutes is or may be advantageous. In some non-limiting embodiments, release of 80% of encapsulated protein tastant(s) within 60 minutes is or may be beneficial for applications where immediate savory flavor is desired. In some non-limiting instances, one or more taste composition(s) providing for 80% release of encapsulated protein within 200 minutes is or may be advantageous. In some non-limiting embodiments, release of 80% of encapsulated protein tastant(s) within 200 minutes is or may be beneficial for applications where evolving tastant texture is desired. In some non-limiting instances, one or more taste composition(s) providing for 80% release of encapsulated protein within 1000 minutes is or may be advantageous. In some non-limiting embodiments, release of 80% of encapsulated protein tastant(s) within 1000 minutes is or may be beneficial for applications where savory-masking is desired.

As shown in FIG. 17, the time required to reach 80% (w/w) release of encapsulated protein(s) can vary from ˜30 minutes to >1000 min depending on the concentration(s) and/or identity of one or more core component(s), shell component(s), and/or matrix component(s) comprising one or more taste composition(s). A complete list of exemplary taste composition(s), their associated core component(s), shell component(s) and/or matrix component(s), their respective concentration(s), and release rates are provided in Appendix 1. In some cases, the exemplary release profiles provided in FIG. 17 aid in the selection of desirable taste composition structure (e.g., core-shell preparation, matrix preparation, particle preparation). In some cases, the exemplary release profiles provided in FIG. 17 aid in the selection and relative concentration(s) of one or more core component(s), shell component(s), and/or matrix component(s).

As shown in FIG. 17, the release rate of protein from one or more exemplary taste composition(s) remains consistent regardless of taste composition structure (e.g., core-shell preparation, matrix preparation, particle preparation). Core-shell preparations wherein one or more core component(s) further comprise a matrix preparation offer comparable release kinetics (0.002-0.02 min⁻¹) relative to the majority of exemplary uncoated matrix preparations (0.001-0.03 min⁻¹).

### V. Example 14: Release of Lipids from One or More Taste Composition(s)

In certain embodiments, one or more taste component(s) characterized as a lipid is or are encapsulated in one or more core-shell preparations and/or matrix preparations. In certain embodiments, the encapsulation of one or more lipid(s) in one or more matrix and/or core-shell preparation(s) is further characterized by the release of encapsulated lipid(s) in one or more release environment(s). In some instances, the release profile(s), as provided herein, of lipid(s) encapsulated in one or more matrix and/or core-shell preparation(s) illustrate controlled release of lipid(s).

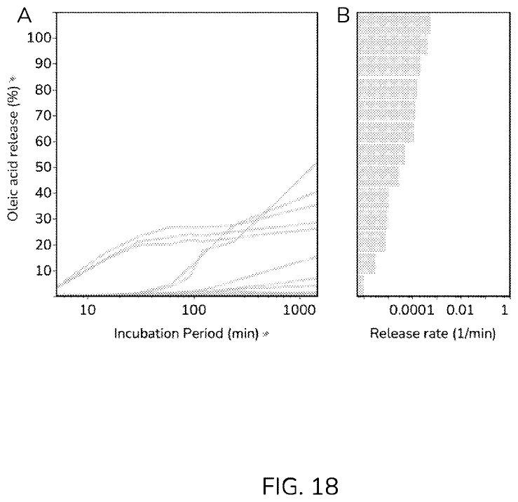

In some non-limiting instances, one or more taste composition(s) comprising lipid(s) further characterized as core-shell preparation(s) and/or matrix preparation(s) provide a means of controlling lipid release. In certain embodiments, the selection of one or more core component(s), shell component(s), and/or matrix component(s) and their relative concentration(s) provide a means of controlling release of lipid(s). In one non-limiting embodiment (FIG. 9), the average release profiles (n=3) of an exemplary lipid encapsulated within taste composition(s) comprising distinct core component(s), shell component(s), and/or matrix component(s) within a release environment comprising phosphate buffered saline, pH 7.4 at 37° C. are depicted. In this example, exemplary release profile(s) are provided by taste composition(s) further characterized as matrix preparation(s), core-shell preparation(s), and/or combinations of matrix and core-shell preparation(s). In some instances, the release profile(s) provided by one or more taste composition(s) changes in different release environment(s). In some instances, the release profile(s) provided by one or more taste composition(s) remains constant in different release environment(s). In certain preferred embodiments, the release profile(s) provided by one or more taste composition(s) illustrated in FIG. 18 enable the selection of taste composition(s) conferring desirable release profile(s) upon one or more carbohydrates, for example, to reduce meal frequency in one or more mammal(s).

In some non-limiting instances, one or more taste composition(s) providing for 20% release of encapsulated lipid within 20 minutes is or may be advantageous. In some non-limiting embodiments, release of 20% of encapsulated lipid tastant(s) within 20 minutes is or may be beneficial for applications where immediate oily flavor is desired. In some non-limiting instances, one or more taste composition(s) providing for 20% release of encapsulated lipid within 200 minutes is or may be advantageous. In some non-limiting embodiments, release of 20% of encapsulated lipid tastant(s) within 200 minutes is or may be beneficial for applications where evolving tastant texture is desired. In some non-limiting instances, one or more taste composition(s) providing for 20% release of encapsulated lipid within 1000 minutes is or may be advantageous. In some non-limiting embodiments, release of 20% of encapsulated lipid tastant(s) within 1000 minutes is or may be beneficial for applications where oil-masking is desired.

As shown in FIG. 18, the time required to reach 20% (w/w) release of encapsulated lipid(s) can vary from ˜30 minutes to >1000 min depending on the concentration(s) and/or identity of one or more core component(s), shell component(s), and/or matrix component(s) comprising one or more taste composition(s). A complete list of exemplary taste composition(s), their associated core component(s), shell component(s) and/or matrix component(s), their respective concentration(s), and release rates are provided in Appendix 1. In some cases, the exemplary release profiles provided in FIG. 18 aid in the selection of desirable taste composition structure (e.g., core-shell preparation, matrix preparation, particle preparation). In some cases, the exemplary release profiles provided in FIG. 18 aid in the selection and relative concentration(s) of one or more core component(s), shell component(s), and/or matrix component(s).

As shown in FIG. 18, the release rate of lipid from one or more exemplary taste composition(s) characterized as matrix preparation(s) varies depending on selected matrix component(s). Exemplary matrix preparation(s) comprising ethyl cellulose confer a release rate of ˜0.001 min⁻¹, while matrix preparation(s) comprising sitosterol confer a release rate of ˜0.000001 min⁻¹.

### W. Example 15: Encapsulation and Release of Taste Component(s)

In certain embodiments, one or more taste component(s) characterized as a lipid is or are encapsulated in one or more core-shell preparations and/or matrix preparations. In certain embodiments, the encapsulation of one or more lipid(s) in one or more matrix and/or core-shell preparation(s) is further characterized by the release of encapsulated lipid(s) in one or more release environment(s). In some instances, the release profile(s), as provided herein, of lipid(s) encapsulated in one or more matrix and/or core-shell preparation(s) illustrate controlled release of lipid(s). As illustrated in FIG. 15 and FIG. 18, an exemplary lipid encapsulated in provided taste composition(s) may be oleic acid. Additionally, in some embodiments, linoleic acid, docosahexaenoic acid, and/or eicosapentaenoic acid may be encapsulated and exhibit controlled release within and from provided taste composition(s), respectively.

In certain embodiments, one or more taste component(s) characterized as a protein is or are encapsulated in one or more core-shell preparations and/or matrix preparations. In certain embodiments, the encapsulation of one or more protein(s) in one or more matrix and/or core-shell preparation(s) is further characterized by the release of encapsulated protein(s) in one or more release environment(s). In some instances, the release profile(s), as provided herein, of protein(s) encapsulated in one or more matrix and/or core-shell preparation(s) illustrate controlled release of protein(s). As illustrated in FIG. 14 and FIG. 17, an exemplary protein encapsulated in provided taste composition(s) may be whey protein. Additionally, in some embodiments, gelatin, collagen, casein, oat protein isolate, soy protein isolate, and/or pea protein isolate may be encapsulated and exhibit controlled release within and from provided taste composition(s), respectively.

In certain embodiments, one or more taste component(s) characterized as a polyphenol is or are encapsulated in one or more core-shell preparations and/or matrix preparations. In certain embodiments, the encapsulation of one or more polyphenol(s) in one or more matrix and/or core-shell preparation(s) is further characterized by the release of encapsulated polyphenol(s) in one or more release environment(s). In some instances, the release profile(s), as provided herein, of polyphenol(s) encapsulated in one or more matrix and/or core-shell preparation(s) illustrate controlled release of polyphenol(s).

For example, in one non-limiting instance, a taste composition comprised of a polyphenol (e.g., a solute component) is embedded within a protein (e.g., a shell component), demonstrating exemplary encapsulation of a polyphenol.

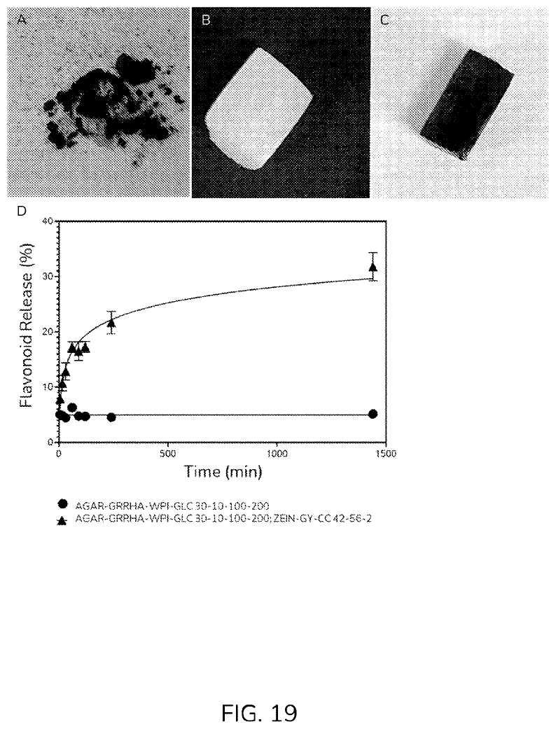

FIG. 19 illustrates a comparison between gross morphologies of unencapsulated (FIG. 19A, cyanidin chloride) and encapsulated (FIG. 19C, encapsulated) polyphenol. For example, an ethanol solution (90% (w/v)) of zein is prepared with the addition of 1% (w/w) cyanidin chloride to form a purple solution, the purple solution then applied to a matrix preparation comprising agarose and glucose (FIG. 19B) via paint coating. Unlike the loose powder depicted in FIG. 19A, the formulations generated using the methods of manufacture outlined are solid, cohesive particle preparation(s) with a smooth coating, indicating successful encapsulation.

In one non-limiting example, encapsulated polyphenol taste composition(s) demonstrate controlled release. For example, FIG. 19D illustrates a comparison in flavonoid release from a formulation containing encapsulated cyanidin chloride (3% (w/w) agarose, 1% (w/w) glycyrrhetinic acid, 10% (w/w) whey protein isolate, and 20% (w/w) glucose in the core, 42% (w/w) Zein, 56% (w/w) glycerol, and 2% (w/w) cyanidin chloride in the shell) (black triangles) and a formulation containing no cyanidin chloride (3% (w/w) agarose, 1% (w/w) glycyrrhetinic acid, 10% (w/w) whey protein isolate, and 20% (w/w) glucose in the core) (black circles). In this example, flavonoid releases from the exemplary taste composition(s), reaching 30% release by 24 hours in phosphate buffered saline, pH 7.4.

In certain embodiments, one or more taste component(s) characterized as a carbohydrate is or are encapsulated in one or more core-shell preparations and/or matrix preparations. In certain embodiments, the encapsulation of one or more carbohydrate(s) in one or more matrix and/or core-shell preparation(s) is further characterized by the release of encapsulated carbohydrate(s) in one or more release environment(s). In some instances, the release profile(s), as provided herein, of carbohydrate(s) encapsulated in one or more matrix and/or core-shell preparation(s) illustrate controlled release of carbohydrate(s). As illustrated in FIG. 13 and FIG. 16, an exemplary carbohydrate encapsulated in provided taste composition(s) may be glucose. Additionally, in some embodiments, sucrose, tagatose, psicose, and/or isomaltulose may be encapsulated and exhibit controlled release within and from provided taste composition(s), respectively.

For example, in one non-limiting instance, a taste composition comprised of inulin (e.g., a solute component) is embedded within a carbohydrate (e.g., a matrix component), demonstrating exemplary encapsulation of a carbohydrate.

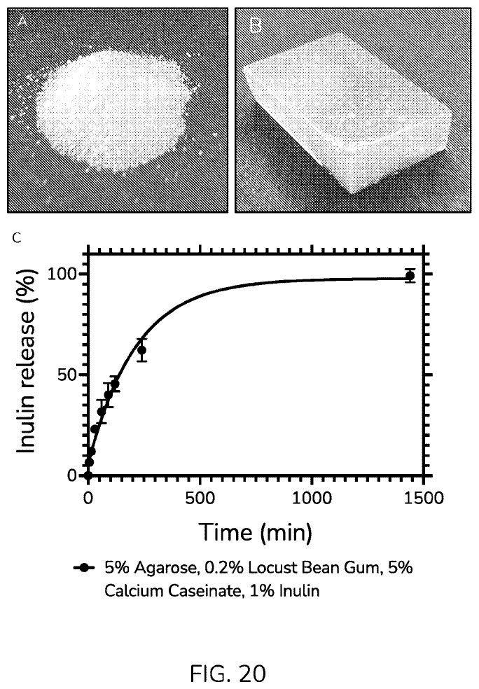

FIG. 20 illustrates a comparison between gross morphologies of unencapsulated (FIG. 20A, inulin) and encapsulated (FIG. 20B, encapsulated) carbohydrate. For example, an aqueous solution of 10% (w/w) inulin and 20% (w/w) glucose is prepared, followed by the addition of 3% (w/w) agarose powder. The mixture is heated to 75° C. to dissolve the agarose, which, upon cooling, forms a solid matrix preparation. Unlike the loose powder depicted in FIG. 20A, the formulations generated using the methods of manufacture outlined are solid, cohesive particle preparation(s) (FIG. 20B), indicating successful encapsulation.

In one non-limiting example, encapsulated carbohydrate taste composition(s) demonstrate controlled release. For example, FIG. 20C illustrates a carbohydrate release from a formulation containing encapsulated inulin. In this example, inulin releases from the exemplary taste composition(s) (5% (w/w) agarose, 0.2% (w/w) locust bean gum, 5% (w/w) calcium caseinate, and 1% (w/w) inulin), reaching 100% release by 24 hours in phosphate buffered saline, pH 7.4.

In certain embodiments, one or more taste component(s) characterized as a ketone is or are encapsulated in one or more core-shell preparations and/or matrix preparations. In certain embodiments, the encapsulation of one or more ketone(s) in one or more matrix and/or core-shell preparation(s) is further characterized by the release of encapsulated ketone(s) in one or more release environment(s). In some instances, the release profile(s), as provided herein, of ketone(s) encapsulated in one or more matrix and/or core-shell preparation(s) illustrate controlled release of ketone(s). In some embodiments, 3-hydroxybutyrate, acetoacetic acid, and/or 3-hydroxybutyl-3-hydroxybutyrate may be encapsulated and exhibit controlled release within and from provided taste composition(s), respectively.

### K. Example 16: Exemplary Formulations

Non-limiting exemplary embodiments in accordance with the present disclosure (e.g., exemplary formulations, e.g., exemplary compositions) are presented in Table 1 and Table 2.

TABLE 1
Components of Exemplary Formulations

| Formulation_ID | Analyte 1 | Analyte 2 | Excipient 1 | Excipient 2 | Excipient 3 | Excipient 4 | Coating |
|---|---|---|---|---|---|---|---|
| 27STE-EC:100- | Whey | • | 27 Stearine | • | Ethyl cellulose | • | • |
| WPI_850-50-100 | | | | | 100 cP | | |
| 27STE-EC:100- | Whey | • | 27 Stearine | • | Ethyl cellulose | • | • |
| WPI_900-50-50 | | | | | 100 cP | | |
| 27STE-LEC- | Whey | • | 27 Stearine | Lecithin | • | • | • |
| WPI_800-150-50 | | | | | | | |
| 27STE-LEC- | Whey | • | 27 Stearine | Lecithin | • | • | • |
| WPI_850-50-100 | | | | | | | |
| 27STE-LEC- | Whey | • | 27 Stearine | Lecithin | • | • | • |
| WPI_900-50-50 | | | | | | | |
| 27STE-SITO- | Whey | • | 27 Stearine | Sitosterol | Oryzanol | • | • |
| ORY-WPI_600- | | | | | | | |
| 150-150-100 | | | | | | | |
| 27STE-SITO- | Whey | • | 27 Stearine | Sitosterol | Oryzanol | • | • |
| ORY-WPI_650- | | | | | | | |
| 15-285-50 | | | | | | | |
| 27STE-SITO- | Whey | • | 27 Stearine | Sitosterol | Oryzanol | • | • |
| ORY-WPI_650- | | | | | | | |
| 60-240-50 | | | | | | | |
| 27STE-SITO- | Whey | • | 27 Stearine | Sitosterol | Oryzanol | • | • |
| ORY-WPI_700- | | | | | | | |
| 125-125-50 | | | | | | | |
| 27STE-SITO- | Whey | • | 27 Stearine | Sitosterol | Oryzanol | • | • |
| ORY-WPI_750- | | | | | | | |
| 100-100-50 | | | | | | | |
| 27STE-SITO- | Whey | • | 27 Stearine | Sitosterol | • | • | • |
| WPI_700-125- | | | | | | | |
| 125 | | | | | | | |
| 27STE-SITO- | Whey | • | 27 Stearine | Sitosterol | • | • | • |
| WPI_700-200- | | | | | | | |
| 100 | | | | | | | |
| 27STE-SITO- | Whey | • | 27 Stearine | Sitosterol | • | • | • |
| WPI_750-125- | | | | | | | |
| 125 | | | | | | | |
| 27STE-T85- | Whey | • | 27 Stearine | Tween 85 | Ethyl cellulose | • | • |
| EC:100- | | | | | 100 cP | | |
| WPI_800-50-50- | | | | | | | |
| 100 | | | | | | | |
| 27STE-T85- | Whey | • | 27 Stearine | Tween 85 | • | • | • |
| WPI_850-50-100 | | | | | | | |
| 27STE-WPI_900- | Whey | • | 27 Stearine | • | • | • | • |
| 100 | | | | | | | |
| 27STE-WPI- | Whey | Oleic Acid | 27 Stearine | • | • | • | • |
| OLEA_150-100- | | | | | | | |
| 750 | | | | | | | |
| 27STE-WPI- | Whey | Oleic Acid | 27 Stearine | • | • | • | • |
| OLEA_200-100- | | | | | | | |
| 700 | | | | | | | |
| 27STE-WPI- | Whey | Oleic Acid | 27 Stearine | • | • | • | • |
| OLEA_200-200- | | | | | | | |
| 600 | | | | | | | |
| 27STE-WPI- | Whey | Oleic Acid | 27 Stearine | • | • | • | • |
| OLEA_400-200- | | | | | | | |
| 400 | | | | | | | |
| AGAR-C10- | Whey | • | Agarose | Sodium | • | • | • |
| WPI_30-3-100 | | | | caprate | | | |
| AGAR-C10- | Whey | • | Agarose | Sodium | • | • | • |
| WPI_30-30-100 | | | | caprate | | | |
| AGAR-C10- | Whey | • | Agarose | Sodium | • | • | • |
| WPI_30-40-100 | | | | caprate | | | |
| AGAR-C10- | Whey | • | Agarose | Sodium | • | • | • |
| WPI_30-100-100 | | | | caprate | | | |
| AGAR-C10-WPI- | Whey | Glucose | Agarose | Sodium | • | • | • |
| GLC_30-1-100- | | | | caprate | | | |
| 100 | | | | | | | |
| AGAR-C10-WPI- | Whey | Glucose | Agarose | Sodium | • | • | • |
| GLC_30-10-100- | | | | caprate | | | |
| 100 | | | | | | | |
| AGAR-C18-WPI- | Whey | Glucose | Agarose | Stearic Acid | • | • | • |
| GLC_30-1-100- | | | | | | | |
| 100 | | | | | | | |
| AGAR-C18-WPI- | Whey | Glucose | Agarose | Stearic Acid | • | • | • |
| GLC_30-10-100- | | | | | | | |
| 100 | | | | | | | |
| AGAR-CAP- | Whey | Glucose | Agarose | Cellulose | • | • | • |
| WPI-GLC_30-1- | | | | Acetate | | | |
| 100-100 | | | | Phthalate | | | |
| AGAR-CAP- | Whey | Glucose | Agarose | Cellulose | • | • | • |
| WPI-GLC_30-10- | | | | Acetate | | | |
| 100-100 | | | | Phthalate | | | |
| AGAR-CHIHI- | Whey | Glucose | Agarose | Chitosan | • | • | • |
| WPI-GLC_30-1- | | | | | | | |
| 100-100 | | | | | | | |
| AGAR-CHIHI- | Whey | Glucose | Agarose | Chitosan | • | • | • |
| WPI-GLC_30-10- | | | | | | | |
| 100-100 | | | | | | | |
| AGAR-CHILO- | Whey | • | Agarose | Chitosan | • | • | • |
| WPI_30-1-100 | | | | | | | |
| AGAR-CHILO- | Whey | • | Agarose | Chitosan | • | • | • |
| WPI_30-30-100 | | | | | | | |
| AGAR-CHILO- | Whey | • | Agarose | Chitosan | • | • | • |
| WPI_30-100-100 | | | | | | | |
| AGAR-CHILO- | Whey | • | Agarose | • | Chitosan | • | • |
| WPI_50-5-100 | | | | | | | |
| AGAR-CMC:90- | Whey | • | Agarose | • | Sodium | • | • |
| WPI_50-20-100 | | | | | carboxymethylellulose | | |
| | | | | | c 90 kDa | | |
| AGAR-CMC:90- | Whey | Glucose | Agarose | Sodium | • | • | • |
| WPI-GLC_30-1- | | | | carboxymethylcellulose | | | |
| 100-200 | | | | 90 kDa | | | |
| AGAR-CMC:90- | Whey | Glucose | Agarose | Sodium | • | • | • |
| WPI-GLC_30-10- | | | | carboxymethylcellulose | | | |
| 100-200 | | | | 90 kDa | | | |
| AGAR- | Whey | Glucose | Agarose | Sodium | • | • | • |
| CMC:250-WPI- | | | | carboxymethylcellulose | | | |
| GLC_30-1-100- | | | | 90 kDa | | | |
| 200 | | | | | | | |
| AGAR- | Whey | Glucose | Agarose | Sodium | • | • | • |
| CMC:250-WPI- | | | | carboxymethylcellulose | | | |
| GLC_30-10-100- | | | | 90 kDa | | | |
| 200 | | | | | | | |
| AGAR-CSCRM- | Whey | Glucose | Agarose | Croscarmellose | • | • | • |
| WPI-GLC_30-1- | | | | sodium | | | |
| 100-200 | | | | | | | |
| AGAR-CSCRM- | Whey | Glucose | Agarose | Croscarmellose | • | • | • |
| WPI-GLC_30-10- | | | | sodium | | | |
| 100-200 | | | | | | | |
| AGAR-EPO- | Whey | • | Agarose | Eudragit E | • | • | • |
| WPI_30-1-100 | | | | PO | | | |
| AGAR-EPO- | Whey | • | Agarose | Eudragit E | • | • | • |
| WPI_30-10-100 | | | | PO | | | |
| AGAR-EPO- | Whey | • | Agarose | Eudragit E | • | • | • |
| WPI_30-100-100 | | | | PO | | | |
| AGAR-EPO- | Whey | Glucose | Agarose | Eudragit E | • | • | • |
| WPI-GLC_30-1- | | | | PO | | | |
| 100-100 | | | | | | | |
| AGAR-ETGALT- | Whey | Glucose | Agarose | Ethyl gallate | • | • | • |
| WPI-GLC_30-1- | | | | | | | |
| 100-100 | | | | | | | |
| AGAR-FRUC- | Whey | • | Agarose | • | Fructose | • | • |
| WPI_50-200-100 | | | | | | | |
| AGAR-G4414- | Whey | Glucose | Agarose | Gelucire | • | • | • |
| WPI-GLC_30-1- | | | | 44/14 | | | |
| 100-100 | | | | | | | |
| AGAR-G4414- | Whey | Glucose | Agarose | Gelucire | • | • | • |
| WPI-GLC_30-10- | | | | 44/14 | | | |
| 100-100 | | | | | | | |
| AGAR-G5013- | Whey | Glucose | Agarose | Gelucire | • | • | • |
| WPI-GLC_30-5- | | | | 50/13 | | | |
| 100-200 | | | | | | | |
| AGAR-G5013- | Whey | Glucose | Agarose | Gelucire | • | • | • |
| WPI-GLC_30-50- | | | | 50/13 | | | |
| 100-200 | | | | | | | |
| AGAR-G5914- | Whey | Glucose | Agarose | Gelucire | • | • | • |
| WPI-GLC_30-5- | | | | 59/14 | | | |
| 100-200 | | | | | | | |
| AGAR-G5914- | Whey | Glucose | Agarose | Gelucire | • | • | • |
| WPI-GLC_30-50- | | | | 59/14 | | | |
| 100-200 | | | | | | | |
| AGAR-GELLG- | Whey | Glucose | Agarose | Gellan Gum | • | • | • |
| WPI-GLC_30-1- | | | | | | | |
| 100-100 | | | | | | | |
| AGAR-GELLG- | Whey | Glucose | Agarose | Gellan Gum | • | • | • |
| WPI-GLC_30-10- | | | | | | | |
| 100-100 | | | | | | | |
| AGAR-GHATG- | Whey | Glucose | Agarose | Ghatti Gum | • | • | • |
| WPI-GLC_30-1- | | | | | | | |
| 100-100 | | | | | | | |
| AGAR-GHATG- | Whey | Glucose | Agarose | • | Ghatti Gum | • | • |
| WPI-GLC_30-10- | | | | Ghatti Gum | • | • | • |
| 100-100 | | | | | | | |
| AGAR-GHATG- | Whey | Glucose | Agarose | • | Ghatti Gum | • | Chitosan, |
| WPI-GLC_30-10- | | | | | | | methylcellulose, |
| 100-100; CT-MC- | | | | | | | glycerol |
| GY_9-23-63 | | | | | | | |
| AGAR-GHATG- | Whey | Glucose | Agarose | • | Ghatti Gum | • | Chitosan, |
| WPI-GLC_30-10- | | | | | | | methylcellulose, |
| 100-100; CT-MC- | | | | | | | poly(ethylene |
| PEG_9-23-63 | | | | | | | glycol) |
| AGAR-GHATG- | Whey | Glucose | Agarose | • | Ghatti Gum | • | Poly(vinyl |
| WPI-GLC_30-10- | | | | | | | acetate), |
| 100-100; PVAC- | | | | | | | Propylene |
| PG-SA_40-40-20 | | | | | | | glycol, |
| | | | | | | | Stearic acid |
| AGAR-GHATG- | Whey | Glucose | Agarose | • | Ghatti Gum | • | poly(vinyl |
| WPI-GLC_30-10- | | | | | | | acetate), |
| 100-100; PVAC- | | | | | | | propylene |
| PG-SA_44-44-12 | | | | | | | glycol, |
| | | | | | | | stearic acid |
| AGAR-GRRHA- | Whey | Glucose | Agarose | Glycyrrhetinic | • | • | • |
| WPI-GLC_30-1- | | | | Acid | | | |
| 100-200 | | | | | | | |
| AGAR-GRRHA- | Whey | Glucose | Agarosc | Glycyrrhetinic | • | • | • |
| WPI-GLC_30-10- | | | | Acid | | | |
| 100-200 | | | | | | | |
| AGAR-HAP:5U- | Whey | Glucose | Agarose | Hydroxyapatite | Ghatti Gum | • | • |
| GHATG-WPI- | | | | | | | |
| GLC_30-1-3-100- | | | | | | | |
| 200 | | | | | | | |
| AGAR-HAP:5U- | Whey | Glucose | Agarose | Hydroxyapatite | Ghatti Gum | • | • |
| GHATG-WPI- | | | | | | | |
| GLC_30-10-3- | | | | | | | |
| 100-200 | | | | | | | |
| AGAR-HAP:5U- | Whey | • | Agarosc | Hydroxyapatite | • | • | • |
| WPI_30-10-100 | | | | | | | |
| AGAR-HAP:5U- | Whey | • | Agarose | Hydroxyapatite | • | • | • |
| WPI_30-30-100 | | | | | | | |
| AGAR-HAP:5U- | Whey | • | Agarose | Hydroxyapatite | • | • | • |
| WPI_30-100-100 | | | | | | | |
| AGAR-HPMC- | Whey | • | Agarose | Hydroxypropyl | • | • | • |
| WPI_50-10-100 | | | | methylcellulose | | | |
| AGAR-HPMC- | Whey | Glucose | Agarose | Hydroxypropyl | • | • | • |
| WPI-GLC_30-1- | | | | methylcellulose | | | |
| 100-100 | | | | | | | |
| AGAR-HPMC- | Whey | Glucose | Agarose | Hydroxypropyl | • | • | • |
| WPI-GLC_30-10- | | | | methylcellulose | | | |
| 100-100 | | | | | | | |
| AGAR-ICARR- | Whey | Glucose | Agarose | Iota | • | • | • |
| WPI-GLC_30-1- | | | | Carrageenan | | | |
| 100-100 | | | | | | | |
| AGAR-ICARR- | Whey | Glucose | Agarose | Iota | • | • | • |
| WPI-GLC_30-10- | | | | Carrageenan | | | |
| 100-100 | | | | | | | |
| AGAR-KARG- | Whey | • | Agarose | • | Karaya gum | • | • |
| WPI_50-10-100 | | | | | | | |
| AGAR-KARG- | Whey | Glucose | Agarose | Karaya | • | • | • |
| WPI-GLC_30-1- | | | | Gum | | | |
| 100-100 | | | | | | | |
| AGAR-KARG- | Whey | Glucose | Agarose | Karaya | • | • | • |
| WPI-GLC_30-10- | | | | Gum | | | |
| 100-100 | | | | | | | |
| AGAR-KCARR- | Whey | Glucose | Agarose | Kappa | Gum | Cellulose | • |
| LBG-CAP-WPI- | | | | Carrageenan | Locust Bean | Acetate | |
| GLC_30-1-1-150- | | | | | | Phthalate | |
| 100 | | | | | | | |
| AGAR-KCARR- | Whey | Glucose | Agarose | Kappa | Gum | Eudragit E | • |
| LBG-E_PO-WPI- | | | | Carrageenan | Locust Bean | PO | |
| GLC_30-1-1-150- | | | | | | | |
| 100 | | | | | | | |
| AGAR-KCARR- | Whey | Glucose | Agarose | Kappa | • | • | • |
| WPI-GLC_30-1- | | | | Carrageenan | | | |
| 100-100 | | | | | | | |
| AGAR-KCARR- | Whey | Glucose | Agarose | Kappa | • | • | • |
| WPI-GLC_30-10- | | | | Carrageenan | | | |
| 100-100 | | | | | | | |
| AGAR-LBG- | Whey | Glucose | Agarose | Locust Bean | • | • | • |
| WPI-GLC_30-1- | | | | Gum | | | |
| 100-100 | | | | | | | |
| AGAR-LBG- | Whey | Glucose | Agarose | Locust Bean | • | • | • |
| WPI-GLC_30-10- | | | | Gum | | | |
| 100-100 | | | | | | | |
| AGAR-MC:15- | Whey | Glucose | Agarose | Methyl | Ghatti Gum | • | • |
| GHATG-WPI- | | | | cellulose 15 cP | | | |
| GLC_30-5-3-100- | | | | | | | |
| 200 | | | | | | | |
| AGAR-MC:15- | Whey | Glucose | Agarose | Methyl | Ghatti Gum | • | • |
| GHATG-WPI- | | | | cellulose 15 cP | | | |
| GLC_30-50-3- | | | | | | | |
| 100-200 | | | | | | | |
| AGAR-PAA:450- | Whey | • | Agarose | Poly (acrylic | • | • | • |
| WPI_30-3-100 | | | | acid) 450 kDa | | | |
| AGAR-PAA:450- | Whey | • | Agarose | Poly (acrylic | • | • | • |
| WPI_30-20-100 | | | | acid) 450 kDa | | | |
| AGAR-PAA:450- | Whey | • | Agarose | Poly (acrylic | • | • | • |
| WPI_30-100-100 | | | | acid) 450 kDa | | | |
| AGAR-PAA:450- | Whey | • | Agarose | Poly(acrylic | • | • | • |
| WPI_50-20-100 | | | | acid) 450 kDa | | | |
| AGAR-PAA:450- | Whey | Glucose | Agarose | Poly (acrylic | • | • | • |
| WPI-GLC_30-1- | | | | acid) 450 kDa | | | |
| 100-100 | | | | | | | |
| AGAR-PAA:450- | Whey | Glucose | Agarose | Poly(acrylic | • | • | Poly (vinyl |
| WPI-GLC_30-1- | | | | acid) 450 kDa | | | acetate), |
| 100-100; PVAC- | | | | | | | propylene |
| PG-SA_44-11-44 | | | | | | | glycol, |
| | | | | | | | stearic acid |
| AGAR-PAA:450- | Whey | Glucose | Agarose | Poly(acrylic | • | • | Zein, |
| WPI-GLC_30-1- | | | | acid) 450 kDa | | | glycerol |
| 100-100; ZEIN- | | | | | | | |
| GY_60-40 | | | | | | | |
| AGAR-PAA:450- | Whey | Glucose | Agarose | Poly (acrylic | • | • | • |
| WPI-GLC_30-1- | | | | acid) 450 kDa | | | |
| 100-200 | | | | | | | |
| AGAR-PAA:450- | Whey | Glucose | Agarose | Poly (acrylic | • | • | • |
| WPI-GLC_30-10- | | | | acid) 450 kDa | | | |
| 100-200 | | | | | | | |
| AGAR-PGA- | Whey | Glucose | Agarose | Propylene | Gellan Gum | • | • |
| GELLG-WPI- | | | | glycol | | | |
| GLC_30-10-3- | | | | alginate | | | |
| 100-200 | | | | | | | |
| AGAR-PGA- | Whey | Glucose | Agarose | Propylene | Ghatti Gum | • | • |
| GHATG-WPI- | | | | glycol | | | |
| GLC_30-10-3- | | | | alginate | | | |
| 100-200 | | | | | | | |
| AGAR-PGA- | Whey | Glucose | Agarose | Propylene | • | • | • |
| WPI-GLC_30-1- | | | | glycol | | | |
| 100-200 | | | | alginate | | | |
| AGAR-PGA- | Whey | Glucose | Agarose | Propylene | • | • | • |
| WPI-GLC_30-10- | | | | glycol | | | |
| 100-200 | | | | alginate | | | |
| AGAR-PGA- | Whey | Glucose | Agarose | Propylene | Xanthan gum | • | • |
| XGUM-WPI- | | | | glycol | | | |
| GLC_30-10-3- | | | | alginate | | | |
| 100-200 | | | | | | | |
| AGAR-PHYTG- | Whey | Glucose | Agarose | Phytagel | • | • | • |
| WPI-GLC_30-1- | | | | | | | |
| 100-200 | | | | | | | |
| AGAR-PHYTG- | Whey | Glucose | Agarose | Phytagel | • | • | Zein, citric |
| WPI-GLC_30-1- | | | | | | | acid esters |
| 100-200; ZEIN- | | | | | | | of |
| CITREM-GY_44- | | | | | | | diglycerides, |
| 28-28 | | | | | | | Glycerol |
| AGAR-PHYTG- | Whey | Glucose | Agarose | Phytagel | • | • | Zein, citric |
| WPI-GLC_30-1- | | | | | | | acid esters |
| 100-200; ZEIN- | | | | | | | of |
| CITREM-GY_52- | | | | | | | diglycerides, |
| 32-16 | | | | | | | glycerol |
| AGAR-PHYTG- | Whey | Glucose | Agarose | Phytagel | • | • | • |
| WPI-GLC_30-10- | | | | | | | |
| 100-200 | | | | | | | |
| AGAR- | Whey | Glucose | Agarose | Poly(vinylpyrrolidone) | Ghatti Gum | • | • |
| PVP:1.3M- | | | | 1.3 MDa | | | |
| GHATG-WPI- | | | | | | | |
| GLC_30-1-3-100- | | | | | | | |
| 200 | | | | | | | |
| AGAR- | Whey | Glucose | Agarose | Poly(vinylpyrrolidone) | Ghatti Gum | • | • |
| PVP:1.3M- | | | | 1.3 MDa | | | |
| GHATG-WPI- | | | | | | | |
| GLC_30-10-3- | | | | | | | |
| 100-200 | | | | | | | |
| AGAR-PVP:10- | Whey | Glucose | Agarose | Poly(vinylpyrrolidone) | Ghatti Gum | • | • |
| GHATG-WPI- | | | | 10 kDa | | | |
| GLC_30-1-3-100- | | | | | | | |
| 200 | | | | | | | |
| AGAR-PVP:10- | Whey | Glucose | Agarose | Poly(vinylpyrrolidone) | Ghatti Gum | • | • |
| GHATG-WPI- | | | | 10 kDa | | | |
| GLC_30-10-3- | | | | | | | |
| 100-200 | | | | | | | |
| AGAR-PVP:40- | Whey | • | Agarose | Poly(vinylpyrrolidone) | • | • | • |
| WPI_30-30-100 | | | | 40 kDa | | | |
| AGAR- | Whey | • | Agarose | • | Poly(vinylpyrrolidone) | • | • |
| PVP:1300- | | | | | 1.3 Mda | | |
| WPI_50-10-100 | | | | | | | |
| AGAR-QUILL- | Whey | • | Agarose | Quillaia | • | • | • |
| WPI_30-10-100 | | | | extract | | | |
| AGAR-RICO- | Whey | Glucose | Agarose | Soidum | • | • | • |
| WPI-GLC_30-50- | | | | ricinoleate | | | |
| 100-200 | | | | | | | |
| AGAR-SP60- | Whey | Glucose | Agarose | Span 60 | Tween 60 | • | • |
| T60-WPI- | | | | | | | |
| GLC_30-3.3-1.6- | | | | | | | |
| 100-200 | | | | | | | |
| AGAR-SP60- | Whey | Glucose | Agarose | Span 60 | Tween 60 | • | • |
| T60-WPI- | | | | | | | |
| GLC_30-33-16- | | | | | | | |
| 100-200 | | | | | | | |
| AGAR-SP60- | Whey | Glucose | Agarose | Span 60 | Tween 60. | • | • |
| TW60-WPI- | | | | | | | |
| GLC_30-33-16- | | | | | | | |
| 100-200 | | | | | | | |
| AGAR-SP60- | Whey | Glucose | Agarose | Span 60 | Tween 60. | • | Zein, citric |
| TW60-WPI- | | | | | | | acid esters |
| GLC_30-33-16- | | | | | | | of |
| 100-200; ZEIN- | | | | | | | diglycerides, |
| CIT-LA_26-8-66 | | | | | | | linoleic acid |
| AGAR-SP60- | Whey | Glucose | Agarose | Span 60 | Tween 60. | • | Zein, Citric |
| TW60-WPI- | | | | | | | acid esters |
| GLC_30-33-16- | | | | | | | of |
| 100-200; ZEIN- | | | | | | | diglycerides, |
| CIT-LA_28-18-54 | | | | | | | linoleic acid |
| AGAR-SP60- | Whey | Glucose | Agarose | Span 60 | Tween 60. | • | Zein, citric |
| TW60-WPI- | | | | | | | acid esters |
| GLC_30-33-16- | | | | | | | of |
| 100-200; ZEIN- | | | | | | | diglycercides, |
| CIT-LA_34-21-46 | | | | | | | Linoleic acid |
| AGAR-SP60- | Whey | Glucose | Agarose | Span 60 | Tween 60. | • | Zein, Citric |
| TW60-WPI- | | | | | | | acid esters |
| GLC_30-33-16- | | | | | | | of |
| 100-200; ZEIN- | | | | | | | diglycerides, |
| CIT-LA_40-12-48 | | | | | | | Linoleic acid |
| AGAR-T60- | Whey | • | Agarose | Tween 60 | • | • | • |
| WPI_50-10-100 | | | | | | | |
| AGAR-TRAGG- | Whey | Glucose | Agarose | Tragacanth | • | • | • |
| WPI-GLC_30-1- | | | | Gum | | | |
| 100-200 | | | | | | | |
| AGAR-TRAGG- | Whey | Glucose | Agarose | Tragacanth | • | • | • |
| WPI-GLC_30-10- | | | | Gum | | | |
| 100-200 | | | | | | | |
| AGAR-TSTE- | Whey | Glucose | Agarose | Tristearin | • | • | • |
| WPI-GLC_30-1- | | | | | | | |
| 100-100 | | | | | | | |
| AGAR-TSTE- | Whey | Glucose | Agarose | Tristearin | • | • | • |
| WPI-GLC_30-10- | | | | | | | |
| 100-100 | | | | | | | |
| AGAR-VC18- | Whey | • | Agarose | • | Ascorbyl | • | • |
| WPI_50-20-100 | | | | | palmitate | | |
| AGAR-WPI_20- | Whey | • | Agarose | • | • | • | • |
| 100 | | | | | | | |
| AGAR-WPI_50- | Whey | • | Agarose | • | • | • | • |
| 100 | | | | | | | |
| AGAR-WPI- | Whey | Glucose | Agarose | • | • | • | • |
| GLC_30-100-200 | | | | | | | |
| ALG-CHILO- | • | Glucose | Alginate | Chitosa | • | • | • |
| GLC-INLN_16- | | | | | | | |
| 10-200-50 | | | | | | | |
| ALG-GLC- | • | Glucose | Alginate | • | • | • | • |
| INLN_16-200-50 | | | | | | | |
| ALG-HAP:5U- | • | Glucose | Alginate | Hydroxyapatite | • | • | • |
| GLC-INLN_16- | | | | | | | |
| 40-150-35 | | | | | | | |
| ALG-HPMC- | | Glucose | Alginate | Hydroxypropyl | • | • | • |
| GLC-INLN_16-4_{—} | • | | | methylcellulose | | | |
| 150-35 | | | | | | | |
| ALG-MC-GLC- | • | Glucose | Alginate | Methyl | • | • | • |
| INLN_16-32-150- | | | | cellulose 15 cP | | | |
| 35 | | | | | | | |
| ALG-T85-GLC- | • | Glucose | Alginate | Tween 85 | • | • | • |
| INLN_16-40-150- | | | | | | | |
| 35 | | | | | | | |
| BSWX-EC:100- | Whey | Oleic Acid | Beeswax | • | Ethyl cellulose | • | • |
| WPI-OLEA_150- | | | | | 100 cP | | |
| 50-100-700 | | | | | | | |
| BSWX-LEC- | Whey | • | Beeswax | Lecithin | • | • | • |
| WPI_750-150- | | | | | | | |
| 100 | | | | | | | |
| BSWX-LEC- | Whey | • | Beeswax | Lecithin | • | • | • |
| WPI_800-150-50 | | | | | | | |
| BSWX-T85- | Whey | • | Beeswax | Tween 85 | Ethyl cellulose | • | • |
| EC:100- | | | | | 100 cP | | |
| WPI_800-50-50- | | | | | | | |
| 100 | | | | | | | |
| BSWX-T85- | Whey | • | Beeswax | Tween 85 | • | • | • |
| WPI_750-150- | | | | | | | |
| 100 | | | | | | | |
| BSWX-T85- | Whey | • | Beeswax | Tween 85 | • | • | • |
| WPI_800-150-50 | | | | | | | |
| BSWX-T85- | Whey | • | Beeswax | Tween 85 | • | • | • |
| WPI_850-50-100 | | | | | | | |
| BSWX-T85- | Whey | • | Beeswax | Tween 85 | • | • | • |
| WPI_900-50-50 | | | | | | | |
| BSWX-WPI_900- | Whey | • | Beeswax | • | • | • | • |
| 100 | | | | | | | |
| BSWX-WPI- | Whey | Oleic Acid | Beeswax | • | • | • | • |
| OLEA_150-100- | | | | | | | |
| 750 | | | | | | | |
| BSWX-WPI- | Whey | Oleic Acid | Beeswax | • | • | • | • |
| OLEA_200-100- | | | | | | | |
| 700 | | | | | | | |
| BSWX-WPI- | Whey | Triolein | Beeswax | • | • | • | • |
| TOLE_200-100- | | | | | | | |
| 700 | | | | | | | |
| CANDW- | Whey | • | Candelilla | • | Ethyl cellulose | • | • |
| EC:100- | | | Wax | | 100 cP | | |
| WPI_850-50-100 | | | | | | | |
| CANDW-GEL50- | Whey | • | Candelilla | Gelucire | • | • | • |
| WPI_750-150- | | | Wax | 50/14 | | | |
| 100 | | | | | | | |
| CANDW-GEL50- | Whey | • | Candelilla | Gelucire | • | • | • |
| WPI_800-150-50 | | | Wax | 50/14 | | | |
| CANDW-GEL50- | Whey | • | Candelilla | Gelucire | • | • | • |
| WPI_850-50-100 | | | Wax | 50/14 | | | |
| CANDW-WPI- | Whey | Oleic Acid | Candelilla | • | • | • | • |
| OLEA_150-100- | | | Wax | | | | |
| 750 | | | | | | | |
| CANDW-WPI- | Whey | Oleic Acid | Candelilla | • | • | • | • |
| OLEA_200-150- | | | Wax | | | | |
| 650 | | | | | | | |
| CANDW-WPI- | Whey | Triolein | Candelilla | • | • | • | • |
| TOLE_200-100- | | | Wax | | | | |
| 700 | | | | | | | |
| CARNW-EC- | Whey | Oleic Acid | Carnauba | • | Ethyl cellulose | • | Cellulose |
| WPI-OLEA_100- | | | Wax | | 100 cP | | Acetate |
| 150-100-650; CAP | | | | | | | Phthalate |
| CARNW-EC- | Whey | Oleic Acid | Carnauba | • | Ethyl cellulose | • | Eudragit E |
| WPI-OLEA_100- | | | Wax | | 100 cP | | PO |
| 150-100-650; EPO | | | | | | | |
| CARNW-EC:100- | Whey | Oleic Acid | Carnauba | • | Ethyl cellulose | • | • |
| WPI-OLEA_100- | | | Wax | | 100 cP | | |
| 150-100-650 | | | | | | | |
| CARNW-LEC- | Whey | • | Carnauba | Lecithin | • | • | • |
| WPI_750-150- | | | Wax | | | | |
| 100 | | | | | | | |
| CARNW-LEC- | Whey | • | Carnauba | Lecithin | • | • | • |
| WPI_800-150-50 | | | Wax | | | | |
| CARNW-LEC- | Whey | • | Carnauba | Lecithin | • | • | • |
| WPI_850-50-100 | | | Wax | | | | |
| CARNW-WPI- | Whey | Oleic Acid | Carnauba | • | • | • | • |
| OLEA_150-100- | | | Wax | | | | |
| 750 | | | | | | | |
| CARNW-WPI- | Whey | Oleic Acid | Carnauba | • | • | • | • |
| OLEA_200-100- | | | Wax | | | | |
| 700 | | | | | | | |
| CEW-EC:100- | Whey | • | Cetyl Ester | • | Ethyl cellulose | • | • |
| WPI_750-150- | | | Wax | | 100 cP | | |
| 100 | | | | | | | |
| CEW-EC:100- | Whey | • | Cetyl Ester | • | Ethyl cellulose | • | • |
| WPI_800-150-50 | | | Wax | | 100 cP | | |
| CEW-EC:100- | Whey | • | Cetyl Ester | • | Ethyl cellulose | • | • |
| WPI_850-50-100 | | | Wax | | 100 cP | | |
| CEW-EC:100- | Whey | • | Cetyl Ester | • | Ethyl cellulose | • | • |
| WPI_900-50-50 | | | Wax | | 100 cP | | |
| CEW-GEL50- | Whey | • | Cetyl Ester | Gelucire | • | • | • |
| WPI_750-150- | | | Wax | 50/14 | | | |
| 100 | | | | | | | |
| CEW-GEL50- | Whey | • | Cetyl Ester | Gelucire | • | • | • |
| WPI_800-150-50 | | | Wax | 50/14 | | | |
| CEW-GEL50- | Whey | • | Cetyl Ester | Gelucire | • | • | • |
| WPI_850-50-100 | | | Wax | 50/14 | | | |
| CEW-GEL50- | Whey | • | Cetyl Ester | Gelucire | • | • | • |
| WPI_900-50-50 | | | Wax | 50/14 | | | |
| CEW-KARG- | Whey | • | Cetyl Ester | • | Karaya gum | • | • |
| WPI_800-150-50 | | | Wax | | | | |
| CEW-KARG- | Whey | • | Cetyl Ester | • | Karaya gum | • | • |
| WPI_900-50-50 | | | Wax | | | | |
| CEW-LEC- | Whey | • | Cetyl Ester | Lecithin | • | • | • |
| WPI_750-150- | | | Wax | | | | |
| 100 | | | | | | | |
| CEW-LEC- | Whey | • | Cetyl Ester | Lecithin | • | • | • |
| WPI_900-50-50 | | | Wax | | | | |
| CEW-S40- | Whey | • | Cetyl Ester | Span 40 | • | • | • |
| WPI_750-150- | | | Wax | | | | |
| 100 | | | | | | | |
| CEW-S40- | Whey | • | Cetyl Ester | Span 40 | • | • | • |
| WPI_900-50-50 | | | Wax | | | | |
| CEW-S80- | Whey | • | Cetyl Ester | Span 80 | • | • | • |
| WPI_750-150- | | | Wax | | | | |
| 100 | | | | | | | |
| CEW-S80- | Whey | • | Cetyl Ester | Span 80 | • | • | • |
| WPI_900-50-50 | | | Wax | | | | |
| CEW-SESO- | Whey | • | Cetyl Ester | Sesame Oil | • | • | • |
| WPI_750-150- | | | Wax | | | | |
| 100 | | | | | | | |
| CEW-SESO- | Whey | • | Cetyl Ester | Sesame Oil | • | • | • |
| WPI_800-150-50 | | | Wax | | | | |
| CEW-SESO- | Whey | • | Cetyl Ester | Sesame Oil | • | • | • |
| WPI_850-50-100 | | | Wax | | | | |
| CEW-SESO- | Whey | • | Cetyl Ester | Sesame Oil | • | • | • |
| WPI_900-50-50 | | | Wax | | | | |
| CEW-SITO- | Whey | • | Cetyl Ester | Sitosterol | • | • | • |
| WPI_700-200- | | | Wax | | | | |
| 100 | | | | | | | |
| CEW-T85- | Whey | • | Cetyl Ester | Tween 85 | • | • | • |
| WPI_750-150- | | | Wax | | | | |
| 100 | | | | | | | |
| CEW-WPI- | Whey | Triolein | Cetyl Ester | • | • | • | • |
| TOLE_200-100- | | | Wax | | | | |
| 700 | | | | | | | |
| CHILO-GENI- | Whey | • | Chitosan | Genipin | • | • | • |
| WPI_18-2-100 | | | | | | | |
| CHILO-WPI_12- | Whey | • | Chitosan | • | • | • | • |
| 100 | | | | | | | |
| CITREM- | Whey | • | Citric Acid | Carnauba | • | • | • |
| CARNW- | | | Esters of | Wax | | | |
| WPI_750-150- | | | Diglycerides | | | | |
| 100 | | | | | | | |
| COCOW-EC:100- | Whey | • | Hydrogenated | • | Ethyl cellulose | • | • |
| WPI_750-150- | | | Coconut Oil | | 100 cP | | |
| 100 | | | | | | | |
| COCOW-EC:100- | Whey | • | Hydrogenated | • | Ethyl cellulose | • | • |
| WPI_800-150-50 | | | Coconut Oil | | 100 cP | | |
| COCOW-EC:100- | Whey | • | Hydrogenated | • | Ethyl cellulose | • | • |
| WPI_850-50-100 | | | Coconut Oil | | 100 cP | | |
| COCOW-EC:100- | Whey | • | Hydrogenated | • | Ethyl cellulose | • | • |
| WPI_900-50-50 | | | Coconut Oil | | 100 cP | | |
| COCOW-SESO- | Whey | • | Hydrogenated | Sesame Oil | • | • | • |
| WPI_850-50-100 | | | Coconut Oil | | | | |
| COCOW-SESO- | Whey | • | Hydrogenated | Sesame Oil | • | • | • |
| WPI_900-50-50 | | | Coconut Oil | | | | |
| DTPS-T85- | Whey | • | Dritex Palm | Tween 85 | • | • | • |
| WPI_800-20-100 | | | Shortening | | | | |
| EC:22-WPI- | Whey | Oleic Acid | • | • | Ethyl cellulose | • | • |
| OLEA_200-100- | | | | | 22 cP | | |
| 700 | | | | | | | |
| EC:100-SIO2- | Whey | Oleic Acid | • | • | Ethyl cellulose | Silica | • |
| WPI-OLEA_150- | | | | | 100 cP | | |
| 50-200-60 | | | | | | | |
| EC:100-WPI- | Whey | Glyceryl | • | • | Ethyl cellulose | • | • |
| GMO_200-100- | | monooleate | | | 100 cP | | |
| 700 | | | | | | | |
| EC:100-WPI- | Whey | Oleic Acid | • | • | Ethyl cellulose | • | • |
| OLEA_100-100- | | | | | 100 cP | | |
| 800 | | | | | | | |
| EC:100-WPI- | Whey | Oleic Acid | • | • | Ethyl cellulose | • | • |
| OLEA_150-100- | | | | | 100 cP | | |
| 750 | | | | | | | |
| EC:100-WPI- | Whey | Oleic Acid | • | • | Ethyl cellulose | • | • |
| OLEA_200-100- | | | | | 100 cP | | |
| 700 | | | | | | | |
| EC:100-WPI- | Whey | Oleic Acid | • | • | Ethyl cellulose | • | • |
| OLEA_200-200- | | | | | 100 cP | | |
| 600 | | | | | | | |
| EC:100-WPI- | Whey | Oleic Acid | • | • | Ethyl cellulose | • | • |
| OLEA_200-250- | | | | | 100 cP | | |
| 550 | | | | | | | |
| EC:100-WPI- | Whey | Oleic Acid | • | • | Ethyl cellulose | • | • |
| OLEA_200-300- | | | | | 100 cP | | |
| 500 | | | | | | | |
| EC:100-WPI- | Whey | Oleic Acid | • | • | Ethyl cellulose | • | • |
| OLEA_250-100- | | | | | 100 cP | | |
| 650 | | | | | | | |
| EC:100-WPI- | Whey | Triolein | • | • | Ethyl cellulose | • | • |
| TOLE_200-100- | | | | | 100 cP | | |
| 700 | | | | | | | |
| EC:300-WPI- | Whey | Oleic Acid | • | • | Ethyl cellulose | • | • |
| OLEA_200-100- | | | | | 300 cP | | |
| 700 | | | | | | | |
| GMO-EC:100- | Whey | Oleic Acid | • | Glyceryl | Ethyl cellulose | • | • |
| WPI-OLEA_50- | | | | monooleate | 100 cP | | |
| 150-100-700 | | | | | | | |
| GMS-EC:100- | Whey | Oleic Acid | • | Glyceryl | Ethyl cellulose | • | • |
| WPI-OLEA_50- | | | | monostearate | 100 cP | | |
| 150-100-700 | | | | | | | |
| K188-WPI- | Whey | Oleic Acid | Kolliphor | • | • | • | • |
| OLEA_250-100- | | | P188 | | | | |
| 650 | | | | | | | |
| PEG:PPG-WPI- | Whey | Oleic Acid | Poly(ethylene | • | • | • | • |
| OLEA_250-100- | | | glycol)-co- | | | | |
| 650 | | | Poly(propylene | • | • | • | • |
| | | | glycol) | | | | |
| PEG:PPG-WPI- | Whey | Oleic Acid | Poly(ethylene | • | • | • | • |
| OLEA_300-100- | | | glycol)-co- | | | | |
| 600 | | | Poly(propylene | | | | |
| | | | glycol) | | | | |
| RBW-EC:100- | Whey | Oleic Acid | Rice Bran | • | Ethyl cellulose | • | • |
| WPI-OLEA_50- | | | Wax | | 100 cP | | |
| 150-100-700 | | | | | | | |
| RBW-WPI- | Whey | Oleic Acid | Rice Bran | • | • | • | • |
| OLEA_100-100- | | | Wax | | | | |
| 800 | | | | | | | |
| RBW-WPI- | Whey | Oleic Acid | Rice Bran | • | • | • | • |
| OLEA_200-100- | | | Wax | | | | |
| 700 | | | | | | | |
| RBW-WPI- | Whey | Oleic Acid | Rice Bran | • | • | • | • |
| OLEA_200-200- | | | Wax | | | | |
| 600 | | | | | | | |
| RBW-WPI- | Whey | Oleic Acid | Rice Bran | • | • | • | • |
| OLEA_200-300- | | | Wax | | | | |
| 500 | | | | | | | |
| RBW-WPI- | Whey | Oleic Acid | Rice Bran | • | • | • | • |
| OLEA_250-100- | | | Wax | | | | |
| 650 | | | | | | | |
| SESO-LEC- | Whey | • | Sesame Oil | Lecithin | Ethyl cellulose | • | • |
| EC:100- | | | | | 100 cP | | |
| WPI_750-150-50- | | | | | | | |
| 50 | | | | | | | |
| SIO2-WPI- | Whey | Oleic Acid | • | • | • | Silica | • |
| OLEA_50-100- | | | | | | | |
| 850 | | | | | | | |
| SiO2-WPI- | Whey | Oleic Acid | Silica | • | • | • | • |
| OLEA_75-100- | | | | | | | |
| 825 | | | | | | | |
| SITO-ORY- | Whey | Oleic Acid | Sitosterol | Oryzanol | Ethyl cellulose | • | • |
| EC:100-WPI- | | | | | 100 cP | | |
| OLEA_60-40- | | | | | | | |
| 100-100-700 | | | | | | | |
| SITO-ORY-WPI- | Whey | Oleic Acid | Sitosterol | Oryzanol | • | • | • |
| OLEA_40-60- | | | | | | | |
| 100-800 | | | | | | | |
| SITO-ORY-WPI- | Whey | Oleic Acid | Sitosterol | Oryzanol | • | • | • |
| OLEA_60-40- | | | | | | | |
| 100-800 | | | | | | | |
| SITO-ORY-WPI- | Whey | Oleic Acid | Sitosterol | Oryzanol | • | • | • |
| OLEA_80-120- | | | | | | | |
| 100-700 | | | | | | | |
| SITO-ORY-WPI- | Whey | Oleic Acid | Sitosterol | Oryzanol | • | • | • |
| OLEA_90-60- | | | | | | | |
| 100-750 | | | | | | | |
| SITO-ORY-WPI- | Whey | Oleic Acid | Sitosterol | Oryzanol | • | • | • |
| OLEA_120-80- | | | | | | | |
| 100-700 | | | | | | | |
| SOYW-GEL50- | Whey | • | Hydrogenated | Gelucire | • | • | • |
| WPI_750-150- | | | Soy Oil | 50/14 | | | |
| 100 | | | | | | | |
| SOYW-LEC- | Whey | • | Hydrogenated | Lecithin | • | • | • |
| WPI_800-150-50 | | | Soy Oil | | | | |
| SOYW-LEC- | Whey | • | Hydrogenated | Lecithin | • | • | • |
| WPI_900-50-50 | | | Soy Oil | | | | |
| SOYW-SESO- | Whey | • | Hydrogenated | Sesame Oil | • | • | • |
| WPI_900-50-50 | | | Soy Oil | | | | |
| SOYW-T85- | Whey | • | Hydrogenated | Tween 85 | Ethyl cellulose | • | • |
| EC:100- | | | Soy Oil | | 100 cP | | |
| WPI_800-50-50- | | | | | | | |
| 100 | | | | | | | |
| SOYW-T85- | Whey | • | Hydrogenated | Tween 85 | • | • | • |
| WPI_850-50-100 | | | Soy Oil | | | | |
| SOYW-WPI- | Whey | Oleic Acid | Hydrogenated | • | • | • | • |
| OLEA_150-100- | | | Soy Oil | | | | |
| 750 | | | | | | | |
| SP60-EC:100- | Whey | Oleic Acid | • | Span 60 | Ethyl cellulose | • | • |
| WPI-OLEA_50- | | | | | 100 cP | | |
| 150-100-700 | | | | | | | |
| SP60-WPI- | Whey | Oleic Acid | • | Span 60 | • | • | • |
| OLEA_200-100- | | | • | Span 60 | • | • | • |
| 700 | | | | | | | |
| TSTE-EC:100- | Whey | • | Tristearin | • | Ethyl cellulose | • | • |
| WPI_850-50-100 | | | Span 60 | | 100 cP | | |
| WPI_1000 | Whey | • | • | • | • | • | • |

TABLE 2
Compositions of Exemplary Formulations

| | Analyte 1 | Analyte 2 | Excipient 1 | Excipient 2 | Excipient 3 | Excipient 4 | Water | K-value | K-Value |
|---|---|---|---|---|---|---|---|---|---|
| Formulation ID | %(w/w) | %(w/w) | %(w/w) | %(w/w) | %(w/w) | %(w/w) | %(w/w) | Analyte 1 | Analyte 2 |
| 27STE-EC:100- | 10 | 0 | 85 | 0 | 5 | 0 | 0 | 0.0006929 | |
| WPI_850-50-100 | | | | | | | | | |
| 27STE-EC:100- | 5 | 0 | 90 | 0 | 5 | 0 | 0 | 0.01083 | |
| WPI_900-50-50 | | | | | | | | | |
| 27STE-LEC- | 5 | 0 | 80 | 15 | 15 | 0 | 0 | | |
| WPI_800-150-50 | | | | | | | | | |
| 27STE-LEC- | 10 | 0 | 85 | 5 | 5 | 0 | 0 | | |
| WPI_850-50-100 | | | | | | | | | |
| 27STE-LEC- | 5 | 0 | 90 | 5 | 0 | 0 | 0 | 0.02036 | |
| WPI_900-50-50 | | | | | | | | | |
| 27STE-SITO- | 10 | 0 | 60 | 15 | 15 | 0 | 0 | 0.004512 | |
| ORY-WPI_600- | | | | | | | | | |
| 150-150-100 | | | | | | | | | |
| 27STE-SITO- | 5 | 0 | 65 | 2 | 29 | 0 | 0 | 0.0003874 | |
| ORY-WPI_650- | | | | | | | | | |
| 15-285-50 | | | | | | | | | |
| 27STE-SITO- | 5 | 0 | 65 | 6 | 24 | 0 | 0 | 0.001438 | |
| ORY-WPI_650- | | | | | | | | | |
| 60-240-50 | | | | | | | | | |
| 27STE-SITO- | 5 | 0 | 70 | 13 | 13 | 0 | 0 | | |
| ORY-WPI_700- | | | | | | | | | |
| 125-125-50 | | | | | | | | | |
| 27STE-SITO- | 5 | 0 | 75 | 10 | 10 | 0 | 0 | 0.004769 | |
| ORY-WPI_750- | | | | | | | | | |
| 100-100-50 | | | | | | | | | |
| 27STE-SITO- | 13 | 0 | 70 | 13 | 0 | 0 | 0 | 0.008695 | |
| WPI_700-125-125 | | | | | | | | | |
| 27STE-SITO- | 10 | 0 | 70 | 0 | 20 | 0 | 0 | 0.1063 | |
| WPI_700-200-100 | | | | | | | | | |
| 27STE-SITO- | 13 | 0 | 75 | 13 | 0 | 0 | 0 | 0.001754 | |
| WPI_750-125-125 | | | | | | | | | |
| 27STE-T85- | 10 | 0 | 80 | 5 | 5 | 0 | 0 | 0.007037 | |
| EC:100-WPI_800- | | | | | | | | | |
| 50-50-100 | | | | | | | | | |
| 27STE-T85- | 10 | 0 | 85 | 5 | 0 | 0 | 0 | 0.01379 | |
| WPI_850-50-100 | | | | | | | | | |
| 27STE-WPI_900- | 10 | 0 | 90 | 0 | 0 | 0 | 0 | 0.002242 | |
| 100 | | | | | | | | | |
| 27STE-WPI- | 10 | 75 | 15 | 0 | 0 | 0 | 0 | 0.003952 | |
| OLEA_150-100- | | | | | | | | | |
| 750 | | | | | | | | | |
| 27STE-WPI- | 10 | 70 | 20 | 0 | 0 | 0 | 0 | 0.0002138 | 0.0001148 |
| OLEA_200-100- | | | | | | | | | |
| 700 | | | | | | | | | |
| 27STE-WPI- | 20 | 60 | 20 | 0 | 0 | 0 | 0 | 0.0002495 | |
| OLEA_200-200- | | | | | | | | | |
| 600 | | | | | | | | | |
| 27STE-WPI- | 20 | 40 | 40 | 0 | 0 | 0 | 0 | 0.01075 | |
| OLEA_400-200- | | | | | | | | | |
| 400 | | | | | | | | | |
| AGAR-C10- | 10 | 0 | 3 | 0 | 0 | 0 | 87 | 0.375872 | |
| WPI_30-3-100 | | | | | | | | | |
| AGAR-C10- | 10 | 0 | 3 | 3 | 0 | 0 | 84 | 0.199205 | |
| WPI_30-30-100 | | | | | | | | | |
| AGAR-C10- | 10 | 0 | 3 | 4 | 0 | 0 | 83 | 0.172681 | |
| WPI_30-40-100 | | | | | | | | | |
| AGAR-C10- | 10 | 0 | 3 | 10 | 0 | 0 | 77 | 0.0262123 | |
| WPI_30-100-100 | | | | | | | | | |
| AGAR-C10-WPI- | 10 | 10 | 3 | 0 | 0 | 0 | 77 | 0.01483 | 0.09681 |
| GLC_30-1-100- | | | | | | | | | |
| 100 | | | | | | | | | |
| AGAR-C10-WPI- | 10 | 10 | 3 | 1 | 0 | 0 | 76 | 0.08807 | |
| GLC_30-10-100- | | | | | | | | | |
| 100 | | | | | | | | | |
| AGAR-C18-WPI- | 10 | 10 | 3 | 0 | 0 | 0 | 77 | 0.01283 | 0.06172 |
| GLC_30-1-100- | | | | | | | | | |
| 100 | | | | | | | | | |
| AGAR-C18-WPI- | 10 | 10 | 3 | 1 | 0 | 0 | 76 | 0.01487 | 0.04847 |
| GLC_30-10-100- | | | | | | | | | |
| 100 | | | | | | | | | |
| AGAR-CAP-WPI- | 10 | 10 | 3 | 0 | 0 | 0 | 77 | 0.02558 | 0.2554 |
| GLC_30-1-100- | | | | | | | | | |
| 100 | | | | | | | | | |
| AGAR-CAP-WPI- | 10 | 10 | 3 | 1 | 0 | 0 | 76 | 0.009587 | 0.09474 |
| GLC_30-10-100- | | | | | | | | | |
| 100 | | | | | | | | | |
| AGAR-CHIHI- | 10 | 10 | 3 | 0 | 0 | 0 | 77 | 0.00765 | |
| WPI-GLC_30-1- | | | | | | | | | |
| 100-100 | | | | | | | | | |
| AGAR-CHIHI- | 10 | 10 | 3 | 1 | 0 | 0 | 76 | 0.1544 | |
| WPI-GLC_30-10- | | | | | | | | | |
| 100-100 | | | | | | | | | |
| AGAR-CHILO- | 10 | 0 | 3 | 0 | 0 | 0 | 87 | 0.010076 | |
| WPI_30-1-100 | | | | | | | | | |
| AGAR-CHILO- | 10 | 0 | 3 | 3 | 0 | 0 | 84 | 0.032788 | |
| WPI_30-30-100 | | | | | | | | | |
| AGAR-CHILO- | 10 | 0 | 3 | 10 | 0 | 0 | 77 | 0.0128367 | |
| WPI_30-100-100 | | | | | | | | | |
| AGAR-CHILO- | 10 | 0 | 5 | 0 | 1 | 0 | 85 | 0.05856 | |
| WPI_50-5-100 | | | | | | | | | |
| AGAR-CMC:90- | 10 | 0 | 5 | 0 | 2 | 0 | 83 | 0.01874 | |
| WPI_50-20-100 | | | | | | | | | |
| AGAR-CMC:90- | 10 | 20 | 3 | 0 | 0 | 0 | 67 | 0.01355 | 0.2331 |
| WPI-GLC_30-1- | | | | | | | | | |
| 100-200 | | | | | | | | | |
| AGAR-CMC:90- | 10 | 20 | 3 | 1 | 0 | 0 | 66 | 0.009649 | 0.1518 |
| WPI-GLC_30-10- | | | | | | | | | |
| 100-200 | | | | | | | | | |
| AGAR-CMC:250- | 10 | 20 | 3 | 0 | 0 | 0 | 67 | 0.009799 | 0.06413 |
| WPI-GLC_30-1- | | | | | | | | | |
| 100-200 | | | | | | | | | |
| AGAR-CMC:250- | 10 | 20 | 3 | 1 | 0 | 0 | 66 | 0.00848 | 0.1581 |
| WPI-GLC_30-10- | | | | | | | | | |
| 100-200 | | | | | | | | | |
| AGAR-CSCRM- | 10 | 20 | 3 | 0 | 0 | 0 | 67 | 0.01146 | 0.05442 |
| WPI-GLC_30-1- | | | | | | | | | |
| 100-200 | | | | | | | | | |
| AGAR-CSCRM- | 10 | 20 | 3 | 1 | 0 | 0 | 66 | 0.01069 | 0.05758 |
| WPI-GLC_30-10- | | | | | | | | | |
| 100-200 | | | | | | | | | |
| AGAR-EPO- | 10 | 0 | 3 | 0 | 0 | 0 | 87 | 0.448637 | |
| WPI_30-1-100 | | | | | | | | | |
| AGAR-EPO- | 10 | 0 | 3 | 1 | 0 | 0 | 86 | 0.0411863 | |
| WPI_30-10-100 | | | | | | | | | |
| AGAR-EPO- | 10 | 0 | 3 | 10 | 0 | 0 | 77 | 0.037227 | |
| WPI_30-100-100 | | | | | | | | | |
| AGAR-EPO-WPI- | 10 | 10 | 3 | 0 | 0 | 0 | 77 | 0.007869 | 0.05421 |
| GLC_30-1-100- | | | | | | | | | |
| 100 | | | | | | | | | |
| AGAR-ETGALT- | 10 | 10 | 3 | 0 | 0 | 0 | 77 | 0.03514 | 0.07622 |
| WPI-GLC_30-1- | | | | | | | | | |
| 100-100 | | | | | | | | | |
| AGAR-FRUC- | 10 | 0 | 5 | 0 | 20 | 0 | 65 | 0.03218 | |
| WPI_50-200-100 | | | | | | | | | |
| AGAR-G4414- | 10 | 10 | 3 | 0 | 0 | 0 | 77 | 0.01423 | 0.07799 |
| WPI-GLC_30-1- | | | | | | | | | |
| 100-100 | | | | | | | | | |
| AGAR-G4414- | 10 | 10 | 3 | 1 | 0 | 0 | 76 | 0.01386 | 0.08108 |
| WPI-GLC_30-10- | | | | | | | | | |
| 100-100 | | | | | | | | | |
| AGAR-G5013- | 10 | 20 | 3 | 1 | 0 | 0 | 67 | 0.0101 | 0.04971 |
| WPI-GLC_30-5- | | | | | | | | | |
| 100-200 | | | | | | | | | |
| AGAR-G5013- | 10 | 20 | 3 | 5 | 0 | 0 | 62 | 0.01219 | 0.07255 |
| WPI-GLC_30-50- | | | | | | | | | |
| 100-200 | | | | | | | | | |
| AGAR-G5914- | 10 | 20 | 3 | 1 | 0 | 0 | 67 | 0.008405 | 0.06745 |
| WPI-GLC_30-5- | | | | | | | | | |
| 100-200 | | | | | | | | | |
| AGAR-G5914- | 10 | 20 | 3 | 5 | 0 | 0 | 62 | 0.01513 | 0.09196 |
| WPI-GLC_30-50- | | | | | | | | | |
| 100-200 | | | | | | | | | |
| AGAR-GELLG- | 10 | 10 | 3 | 0 | 0 | 0 | 77 | 0.02084 | 0.08033 |
| WPI-GLC_30-1- | | | | | | | | | |
| 100-100 | | | | | | | | | |
| AGAR-GELLG- | 10 | 10 | 3 | 1 | 0 | 0 | 76 | 0.01825 | 0.1613 |
| WPI-GLC_30-10- | | | | | | | | | |
| 100-100 | | | | | | | | | |
| AGAR-GHATG- | 10 | 10 | 3 | 0 | 0 | 0 | 77 | 0.01568 | 0.06868 |
| WPI-GLC_30-1- | | | | | | | | | |
| 100-100 | | | | | | | | | |
| AGAR-GHATG- | 10 | 10 | 3 | 0 | 1 | 0 | 76 | 0.03317 | 0.2493 |
| WPI-GLC_30-10- | 10 | 10 | 3 | 1 | 0 | 0 | 76 | 0.01647 | 0.01013 |
| 100-100 | | | | | | | | | |
| AGAR-GHATG- | 10 | 10 | 3 | 0 | 1 | 0 | 76 | 0.002823 | 0.01909 |
| WPI-GLC_30-10- | | | | | | | | | |
| 100-100; CT-MC- | | | | | | | | | |
| GY_9-23-63 | | | | | | | | | |
| AGAR-GHATG- | 10 | 10 | 3 | 0 | 1 | 0 | 76 | 0.003684 | 0.01984 |
| WPI-GLC_30-10- | | | | | | | | | |
| 100-100; CT-MC- | | | | | | | | | |
| PEG_9-23-63 | | | | | | | | | |
| AGAR-GHATG- | 10 | 10 | 3 | 0 | 1 | 0 | 76 | 0.00297 | 0.006496 |
| WPI-GLC_30-10- | | | | | | | | | |
| 100-100; PVAC- | | | | | | | | | |
| PG-SA_40-40-20 | | | | | | | | | |
| AGAR-GHATG- | 10 | 10 | 3 | 0 | 1 | 0 | 76 | 0.002667 | 0.005892 |
| WPI-GLC_30-10- | | | | | | | | | |
| 100-100; PVAC- | | | | | | | | | |
| PG-SA_44-44-12 | | | | | | | | | |
| AGAR-GRRHA- | 10 | 20 | 3 | 0 | 0 | 0 | 67 | 0.01049 | 0.05238 |
| WPI-GLC_30-1- | | | | | | | | | |
| 100-200 | | | | | | | | | |
| AGAR-GRRHA- | 10 | 20 | 3 | 1 | 0 | 0 | 66 | 0.008465 | 0.05361 |
| WPI-GLC_30-10- | | | | | | | | | |
| 100-200 | | | | | | | | | |
| AGAR-HAP:5U- | 10 | 20 | 3 | 0 | 0 | 0 | 67 | 0.01091 | 0.04267 |
| GHATG-WPI- | | | | | | | | | |
| GLC_30-1-3-100- | | | | | | | | | |
| 200 | | | | | | | | | |
| AGAR-HAP:5U- | 10 | 20 | 3 | 1 | 0 | 0 | 66 | 0.01423 | 0.06465 |
| GHATG-WPI- | | | | | | | | | |
| GLC_30-10-3-100- | | | | | | | | | |
| 200 | | | | | | | | | |
| AGAR-HAP:5U- | 10 | 0 | 3 | 1 | 0 | 0 | 86 | 0.329519 | |
| WPI_30-10-100 | | | | | | | | | |
| AGAR-HAP:5U- | 10 | 0 | 3 | 3 | 0 | 0 | 84 | 0.198105 | |
| WPI_30-30-100 | | | | | | | | | |
| AGAR-HAP:5U- | 10 | 0 | 3 | 10 | 0 | 0 | 77 | 0.365471 | |
| WPI_30-100-100 | | | | | | | | | |
| AGAR-HPMC- | 10 | 0 | 5 | 0 | 1 | 0 | 84 | 0.06992 | |
| WPI_50-10-100 | | | | | | | | | |
| AGAR-HPMC- | 10 | 10 | 3 | 0 | 0 | 0 | 77 | 0.01006 | 0.02914 |
| WPI-GLC_30-1- | | | | | | | | | |
| 100-100 | | | | | | | | | |
| AGAR-HPMC- | 10 | 10 | 3 | 1 | 0 | 0 | 76 | 0.0141 | 0.05511 |
| WPI-GLC_30-10- | | | | | | | | | |
| 100-100 | | | | | | | | | |
| AGAR-ICARR- | 10 | 10 | 3 | 0 | 0 | 0 | 77 | 0.01164 | |
| WPI-GLC_30-1- | | | | | | | | | |
| 100-100 | | | | | | | | | |
| AGAR-ICARR- | 10 | 10 | 3 | 1 | 0 | 0 | 76 | 0.01886 | |
| WPI-GLC_30-10- | | | | | | | | | |
| 100-100 | | | | | | | | | |
| AGAR-KARG- | 10 | 0 | 5 | 0 | 1 | 0 | 84 | 0.271 | |
| WPI_50-10-100 | | | | | | | | | |
| AGAR-KARG- | 10 | 10 | 3 | 0 | 0 | 0 | 77 | 0.005788 | 0.02387 |
| WPI-GLC_30-1- | | | | | | | | | |
| 100-100 | | | | | | | | | |
| AGAR-KARG- | 10 | 10 | 3 | 1 | 0 | 0 | 76 | 0.003353 | 0.05983 |
| WPI-GLC_30-10- | | | | | | | | | |
| 100-100 | | | | | | | | | |
| AGAR-KCARR- | 15 | 10 | 3 | 0 | 0 | 0 | 72 | 0.0230076 | |
| LBG-CAP-WPI- | | | | | | | | | |
| GLC_30-1-1-150- | | | | | | | | | |
| 100 | | | | | | | | | |
| AGAR-KCARR- | 15 | 10 | 3 | 0 | 0 | 0 | 72 | 0.054176 | |
| LBG-E_PO-WPI- | | | | | | | | | |
| GLC_30-1-1-150- | | | | | | | | | |
| 100 | | | | | | | | | |
| AGAR-KCARR- | 10 | 10 | 3 | 0 | 0 | 0 | 77 | 0.01123 | 0.06378 |
| WPI-GLC_30-1- | | | | | | | | | |
| 100-100 | | | | | | | | | |
| AGAR-KCARR- | 10 | 10 | 3 | 1 | 0 | 0 | 76 | 0.04661 | 0.08143 |
| WPI-GLC_30-10- | | | | | | | | | |
| 100-100 | | | | | | | | | |
| AGAR-LBG-WPI- | 10 | 10 | 3 | 0 | 0 | 0 | 77 | 0.301 | 0.208 |
| GLC_30-1-100- | | | | | | | | | |
| 100 | | | | | | | | | |
| AGAR-LBG-WPI- | 10 | 10 | 3 | 1 | 0 | 0 | 76 | 0.1892 | |
| GLC_30-10-100- | | | | | | | | | |
| 100 | | | | | | | | | |
| AGAR-MC:15- | 10 | 20 | 3 | 1 | 0 | 0 | 66 | 0.0114 | 0.03902 |
| GHATG-WPI- | | | | | | | | | |
| GLC_30-5-3-100- | | | | | | | | | |
| 200 | | | | | | | | | |
| AGAR-MC:15- | 10 | 20 | 3 | 5 | 0 | 0 | 62 | 0.01024 | 0.05064 |
| GHATG-WPI- | | | | | | | | | |
| GLC_30-50-3-100- | | | | | | | | | |
| 200 | | | | | | | | | |
| AGAR-PAA:450- | 10 | 0 | 3 | 0 | 0 | 0 | 87 | 0.0375111 | |
| WPI_30-3-100 | | | | | | | | | |
| AGAR-PAA:450- | 10 | 0 | 3 | 2 | 0 | 0 | 85 | 0.0413748 | |
| WPI_30-20-100 | | | | | | | | | |
| AGAR-PAA:450- | 10 | 0 | 3 | 10 | 0 | 0 | 77 | 0.0509346 | |
| WPI_30-100-100 | | | | | | | | | |
| AGAR-PAA:450- | 10 | 0 | 5 | 0 | 2 | 0 | 83 | 0.00359 | |
| WPI_50-20-100 | | | | | | | | | |
| AGAR-PAA:450- | 10 | 10 | 3 | 0 | 0 | 0 | 77 | 0.0113 | 0.02782 |
| WPI-GLC_30-1- | | | | | | | | | |
| 100-100 | | | | | | | | | |
| AGAR-PAA:450- | 10 | 10 | 3 | 0 | 0 | 0 | 77 | 0.00275 | 0.005724 |
| WPI-GLC_30-1- | | | | | | | | | |
| 100-100; PVAC- | | | | | | | | | |
| PG-SA_44-11-44 | | | | | | | | | |
| AGAR-PAA:450- | 10 | 10 | 3 | 0 | 0 | 0 | 77 | 0.003031 | 0.006915 |
| WPI-GLC_30-1- | | | | | | | | | |
| 100-100; ZEIN- | | | | | | | | | |
| GY_60-40 | | | | | | | | | |
| AGAR-PAA:450- | 10 | 20 | 3 | 0 | 0 | 0 | 67 | 0.01604 | 0.06404 |
| WPI-GLC_30-1- | | | | | | | | | |
| 100-200 | | | | | | | | | |
| AGAR-PAA:450- | 10 | 20 | 3 | 1 | 0 | 0 | 66 | 0.01121 | 0.05835 |
| WPI-GLC_30-10- | | | | | | | | | |
| 100-200 | | | | | | | | | |
| AGAR-PGA- | 10 | 20 | 3 | 1 | 0 | 0 | 66 | 0.01919 | 0.1255 |
| GELLG-WPI- | | | | | | | | | |
| GLC_30-10-3-100- | | | | | | | | | |
| 200 | | | | | | | | | |
| AGAR-PGA- | 10 | 20 | 3 | 1 | 0 | 0 | 66 | 0.02001 | 0.04648 |
| GHATG-WPI- | | | | | | | | | |
| GLC_30-10-3-100- | | | | | | | | | |
| 200 | | | | | | | | | |
| AGAR-PGA-WPI- | 10 | 20 | 3 | 0 | 0 | 0 | 67 | 0.02269 | 0.08364 |
| GLC_30-1-100- | | | | | | | | | |
| 200 | | | | | | | | | |
| AGAR-PGA-WPI- | 10 | 20 | 3 | 1 | 0 | 0 | 66 | 0.01993 | 0.0779 |
| GLC_30-10-100- | | | | | | | | | |
| 200 | | | | | | | | | |
| AGAR-PGA- | 10 | 20 | 3 | 1 | 0 | 0 | 66 | 1 | 1 |
| XGUM-WPI- | | | | | | | | | |
| GLC_30-10-3-100- | | | | | | | | | |
| 200 | | | | | | | | | |
| AGAR-PHYTG- | 10 | 20 | 3 | 0 | 0 | 0 | 67 | | |
| WPI-GLC_30-1- | | | | | | | | | |
| 100-200 | | | | | | | | | |
| AGAR-PHYTG- | 10 | 20 | 3 | 0 | 0 | 0 | 67 | 0.009682 | 0.02801 |
| WPI-GLC_30-1- | | | | | | | | | |
| 100-200; ZEIN- | | | | | | | | | |
| CITREM-GY_44- | | | | | | | | | |
| 28-28 | | | | | | | | | |
| AGAR-PHYTG- | 10 | 20 | 3 | 0 | 0 | 0 | 67 | 0.01557 | 0.02214 |
| WPI-GLC_30-1- | | | | | | | | | |
| 100-200; ZEIN- | | | | | | | | | |
| CITREM-GY_52- | | | | | | | | | |
| 32-16 | | | | | | | | | |
| AGAR-PHYTG- | 10 | 20 | 3 | 1 | 0 | 0 | 66 | 0.009641 | 0.04462 |
| WPI-GLC_30-10- | | | | | | | | | |
| 100-200 | | | | | | | | | |
| AGAR-PVP:1.3M- | 10 | 20 | 3 | 0 | 0 | 0 | 67 | 0.005467 | 0.09756 |
| GHATG-WPI- | | | | | | | | | |
| GLC_30-1-3-100- | | | | | | | | | |
| 200 | | | | | | | | | |
| AGAR-PVP:1.3M- | 10 | 20 | 3 | 1 | 0 | 0 | 66 | 0.008397 | 0.0496 |
| GHATG-WPI- | | | | | | | | | |
| GLC_30-10-3-100- | | | | | | | | | |
| 200 | | | | | | | | | |
| AGAR-PVP:10- | 10 | 20 | 3 | 0 | 0 | 0 | 67 | 0.0101 | 0.05606 |
| GHATG-WPI- | | | | | | | | | |
| GLC_30-1-3-100- | | | | | | | | | |
| 200 | | | | | | | | | |
| AGAR-PVP:10- | 10 | 20 | 3 | 1 | 0 | 0 | 66 | 0.01123 | 0.06823 |
| GHATG-WPI- | | | | | | | | | |
| GLC_30-10-3-100- | | | | | | | | | |
| 200 | | | | | | | | | |
| AGAR-PVP:40- | 10 | 0 | 3 | 3 | 0 | 0 | 84 | 0.0361016 | |
| WPI_30-30-100 | | | | | | | | | |
| AGAR-PVP:1300- | 10 | 0 | 5 | 0 | 1 | 0 | 84 | 0.08688 | |
| WPI_50-10-100 | | | | | | | | | |
| AGAR-QUILL- | 10 | 0 | 3 | 1 | 0 | 0 | 86 | 0.00833695 | |
| WPI_30-10-100 | | | | | | | | | |
| AGAR-RICO- | 10 | 20 | 3 | 5 | 0 | 0 | 62 | 0.2624 | 0.4936 |
| WPI-GLC_30-50- | | | | | | | | | |
| 100-200 | | | | | | | | | |
| AGAR-SP60-T60- | 10 | 20 | 3 | 0 | 0 | 0 | 67 | 0.01399 | 0.05291 |
| WPI-GLC_30-3.3- | | | | | | | | | |
| 1.6-100-200 | | | | | | | | | |
| AGAR-SP60-T60- | 10 | 20 | 3 | 3 | 2 | 0 | 62 | 0.01979 | 0.1578 |
| WPI-GLC_30-33- | | | | | | | | | |
| 16-100-200 | | | | | | | | | |
| AGAR-SP60- | 10 | 20 | 3 | 3 | 2 | 0 | 62 | | 0.02466 |
| TW60-WPI- | | | | | | | | | |
| GLC_30-33-16- | | | | | | | | | |
| 100-200 | | | | | | | | | |
| AGAR-SP60- | 10 | 20 | 3 | 3 | 2 | 0 | 62 | | 0.008864 |
| TW60-WPI- | | | | | | | | | |
| GLC_30-33-16- | | | | | | | | | |
| 100-200; ZEIN- | | | | | | | | | |
| CIT-LA_26-8-66 | | | | | | | | | |
| AGAR-SP60- | 10 | 20 | 3 | 3 | 2 | 0 | 62 | | 0.005005 |
| TW60-WPI- | | | | | | | | | |
| GLC_30-33-16- | | | | | | | | | |
| 100-200; ZEIN- | | | | | | | | | |
| CIT-LA_28-18-54 | | | | | | | | | |
| AGAR-SP60- | 10 | 20 | 3 | 3 | 2 | 0 | 62 | | 0.007772 |
| TW60-WPI- | | | | | | | | | |
| GLC_30-33-16- | | | | | | | | | |
| 100-200; ZEIN- | | | | | | | | | |
| CIT-LA_34-21-46 | | | | | | | | | |
| AGAR-SP60- | 10 | 20 | 3 | 3 | 2 | 0 | 62 | | 0.008459 |
| TW60-WPI- | | | | | | | | | |
| GLC_30-33-16- | | | | | | | | | |
| 100-200; ZEIN- | | | | | | | | | |
| CIT-LA_40-12-48 | | | | | | | | | |
| AGAR-T60- | 10 | 0 | 5 | 1 | 0 | 0 | 84 | 0.007242 | |
| WPI_50-10-100 | | | | | | | | | |
| AGAR-TRAGG- | 10 | 20 | 3 | 0 | 0 | 0 | 67 | 0.01794 | 0.08229 |
| WPI-GLC_30-1- | | | | | | | | | |
| 100-200 | | | | | | | | | |
| AGAR-TRAGG- | 10 | 20 | 3 | 1 | 0 | 0 | 66 | 0.02402 | 0.1016 |
| WPI-GLC_30-10- | | | | | | | | | |
| 100-200 | | | | | | | | | |
| AGAR-TSTE- | 10 | 10 | 3 | 0 | 0 | 0 | 77 | 0.0899 | 0.1057 |
| WPI-GLC_30-1- | | | | | | | | | |
| 100-100 | | | | | | | | | |
| AGAR-TSTE- | 10 | 10 | 3 | 1 | 0 | 0 | 76 | 0.1664 | 0.1102 |
| WPI-GLC_30-10- | | | | | | | | | |
| 100-100 | | | | | | | | | |
| AGAR-VC18- | 10 | 0 | 5 | 0 | 2 | 0 | 83 | 0.02671 | |
| WPI_50-20-100 | | | | | | | | | |
| AGAR-WPI_20- | 10 | 0 | 2 | 0 | 0 | 0 | 88 | 0.01673 | |
| 100 | | | | | | | | | |
| AGAR-WPI_50- | 10 | 0 | 5 | 0 | 0 | 0 | 85 | 0.006709 | |
| 100 | | | | | | | | | |
| AGAR-WPI- | 10 | 20 | 3 | 0 | 0 | 0 | 67 | 0.01157 | 0.06561 |
| GLC_30-100-200 | | | | | | | | | |
| ALG-CHILO- | 0 | 20 | 2 | 1 | 0 | 0 | 77 | | 0.2518 |
| GLC-INLN_16-10-0 | | | | | | | | | |
| 200-50 | | | | | | | | | |
| ALG-GLC- | 0 | 20 | 2 | 0 | 0 | 0 | 78 | | 0.4862 |
| INLN_16-200-50 | | | | | | | | | |
| ALG-HAP:5U- | 0 | 15 | 2 | 4 | 0 | 0 | 79 | | 0.07952 |
| GLC-INLN_16-40-0 | | | | | | | | | |
| 150-35 | | | | | | | | | |
| ALG-HPMC-GLC- | 0 | 15 | 2 | 0 | 0 | 0 | 83 | | 0.09225 |
| INLN_16-4-150-35 | | | | | | | | | |
| ALG-MC-GLC- | 0 | 15 | 2 | 3 | 0 | 0 | 80 | | 0.1913 |
| INLN_16-32-150- | | | | | | | | | |
| 35 | | | | | | | | | |
| ALG-T85-GLC- | 0 | 15 | 2 | 4 | 0 | 0 | 79 | | 0.1199 |
| INLN_16-40-150- | | | | | | | | | |
| 35 | | | | | | | | | |
| BSWX-EC:100- | 10 | 70 | 15 | 0 | 5 | 0 | 0 | 0.0004784 | 0.000009128 |
| WPI-OLEA_150- | | | | | | | | | |
| 50-100-700 | | | | | | | | | |
| BSWX-LEC- | 10 | 0 | 75 | 15 | 0 | 0 | 0 | 0.004747 | |
| WPI_750-150-100 | | | | | | | | | |
| BSWX-LEC- | 5 | 0 | 80 | 15 | 0 | 0 | 0 | 0.00356 | |
| WPI_800-150-50 | | | | | | | | | |
| BSWX-T85- | 10 | 0 | 80 | 5 | 5 | 0 | 0 | 0.0027 | |
| EC:100-WPI_800- | | | | | | | | | |
| 50-50-100 | | | | | | | | | |
| BSWX-T85- | 10 | 0 | 75 | 15 | 0 | 0 | 0 | 0.003024 | |
| WPI_750-150-100 | | | | | | | | | |
| BSWX-T85- | 5 | 0 | 80 | 15 | 0 | 0 | 0 | 0.003309 | |
| WPI_800-150-50 | | | | | | | | | |
| BSWX-T85- | 10 | 0 | 85 | 5 | 0 | 0 | 0 | 0.005213 | |
| WPI_850-50-100 | | | | | | | | | |
| BSWX-T85- | 5 | 0 | 90 | 5 | 0 | 0 | 0 | 0.001274 | |
| WPI_900-50-50 | | | | | | | | | |
| BSWX-WPI_900- | 10 | 0 | 90 | 0 | 0 | 0 | 0 | 0.003661 | |
| 100 | | | | | | | | | |
| BSWX-WPI- | 10 | 75 | 15 | 0 | 0 | 0 | 0 | 0.003922 | |
| OLEA_150-100- | | | | | | | | | |
| 750 | | | | | | | | | |
| BSWX-WPI- | 10 | 70 | 20 | 0 | 0 | 0 | 0 | | |
| OLEA_200-100- | | | | | | | | | |
| 700 | | | | | | | | | |
| BSWX-WPI- | 10 | 70 | 20 | 0 | 0 | 0 | 0 | | |
| TOLE_200-100- | | | | | | | | | |
| 700 | | | | | | | | | |
| CANDW-EC:100- | 10 | 0 | 85 | 0 | 5 | 0 | 0 | | |
| WPI_850-50-100 | | | | | | | | | |
| CANDW-GEL50- | 10 | 0 | 75 | 15 | 0 | 0 | 0 | 0.004734 | |
| WPI_750-150-100 | | | | | | | | | |
| CANDW-GEL50- | 5 | 0 | 80 | 15 | 0 | 0 | 0 | 0.00002082 | |
| WPI_800-150-50 | | | | | | | | | |
| CANDW-GEL50- | 10 | 0 | 85 | 5 | 0 | 0 | 0 | 0.0003986 | |
| WPI_850-50-100 | | | | | | | | | |
| CANDW-WPI- | 10 | 75 | 15 | 0 | 0 | 0 | 0 | 0.0005495 | |
| OLEA_150-100- | | | | | | | | | |
| 750 | | | | | | | | | |
| CANDW-WPI- | 15 | 65 | 20 | 0 | 0 | 0 | 0 | 0.0009048 | |
| OLEA_200-150- | | | | | | | | | |
| 650 | | | | | | | | | |
| CANDW-WPI- | 10 | 70 | 20 | 0 | 0 | 0 | 0 | 0.0005591 | |
| TOLE_200-100- | | | | | | | | | |
| 700 | | | | | | | | | |
| CARNW-EC-WPI- | 10 | 65 | 10 | 0 | 15 | 0 | 0 | | |
| OLEA_100-150- | | | | | | | | | |
| 100-650; CAP | | | | | | | | | |
| CARNW-EC-WPI- | 10 | 65 | 10 | 0 | 15 | 0 | 0 | | |
| OLEA_100-150- | | | | | | | | | |
| 100-650; EPO | | | | | | | | | |
| CARNW-EC:100- | 10 | 65 | 10 | 0 | 15 | 0 | 0 | | |
| WPI-OLEA_100- | | | | | | | | | |
| 150-100-650 | | | | | | | | | |
| CARNW-LEC- | 10 | 0 | 75 | 0 | 15 | 0 | 0 | | |
| WPI_750-150-100 | | | | | | | | | |
| CARNW-LEC- | 5 | 0 | 80 | 15 | 0 | 0 | 0 | 0.00001213 | |
| WPI_800-150-50 | | | | | | | | | |
| CARNW-LEC- | 10 | 0 | 85 | 5 | 0 | 0 | 0 | 0.1405 | |
| WPI_850-50-100 | | | | | | | | | |
| CARNW-WPI- | 10 | 75 | 15 | 0 | 0 | 0 | 0 | 0.002074 | |
| OLEA_150-100- | | | | | | | | | |
| 750 | | | | | | | | | |
| CARNW-WPI- | 10 | 70 | 20 | 0 | 0 | 0 | 0 | 0.0005332 | |
| OLEA_200-100- | | | | | | | | | |
| 700 | | | | | | | | | |
| CEW-EC:100- | 10 | 0 | 75 | 0 | 15 | 0 | 0 | 0.03451 | |
| WPI_750-150-100 | | | | | | | | | |
| CEW-EC:100- | 5 | 0 | 80 | 0 | 15 | 0 | 0 | 0.00001372 | |
| WPI_800-150-50 | | | | | | | | | |
| CEW-EC:100- | 10 | 0 | 85 | 0 | 5 | 0 | 0 | 0.007073 | |
| WPI_850-50-100 | | | | | | | | | |
| CEW-EC:100- | 5 | 0 | 90 | 0 | 5 | 0 | 0 | 0.01618 | |
| WPI_900-50-50 | | | | | | | | | |
| CEW-GEL50- | 10 | 0 | 75 | 15 | 0 | 0 | 0 | 0.01036 | |
| WPI_750-150-100 | | | | | | | | | |
| CEW-GEL50- | 5 | 0 | 80 | 15 | 0 | 0 | 0 | 0.01098 | |
| WPI_800-150-50 | | | | | | | | | |
| CEW-GEL50- | 10 | 0 | 85 | 5 | 0 | 0 | 0 | 7.452E−07 | |
| WPI_850-50-100 | | | | | | | | | |
| CEW-GEL50- | 5 | 0 | 90 | 5 | 0 | 0 | 0 | 0.000001001 | |
| WPI_900-50-50 | | | | | | | | | |
| CEW-KARG- | 5 | 0 | 80 | 0 | 15 | 0 | 0 | 0.001463 | |
| WPI_800-150-50 | | | | | | | | | |
| CEW-KARG- | 5 | 0 | 90 | 5 | 0 | 0 | 0 | 0.01872 | |
| WPI_900-50-50 | | | | | | | | | |
| CEW-LEC- | 10 | 0 | 75 | 15 | 0 | 0 | 0 | 0.008048 | |
| WPI_750-150-100 | | | | | | | | | |
| CEW-LEC- | 5 | 0 | 90 | 5 | 0 | 0 | 0 | 0.008102 | |
| WPI_900-50-50 | | | | | | | | | |
| CEW-S40- | 10 | 0 | 75 | 15 | 0 | 0 | 0 | | |
| WPI_750-150-100 | | | | | | | | | |
| CEW-S40- | 5 | 0 | 90 | 5 | 0 | 0 | 0 | 0.0002294 | |
| WPI_900-50-50 | | | | | | | | | |
| CEW-S80- | 10 | 0 | 75 | 15 | 0 | 0 | 0 | 0.005248 | |
| WPI_750-150-100 | | | | | | | | | |
| CEW-S80- | 5 | 0 | 90 | 5 | 0 | 0 | 0 | | |
| WPI_900-50-50 | | | | | | | | | |
| CEW-SESO- | 10 | 0 | 75 | 15 | 0 | 0 | 0 | 0.007158 | |
| WPI_750-150-100 | | | | | | | | | |
| CEW-SESO- | 5 | 0 | 80 | 15 | 0 | 0 | 0 | 0.001934 | |
| WPI_800-150-50 | | | | | | | | | |
| CEW-SESO- | 10 | 0 | 85 | 5 | 0 | 0 | 0 | 0.004032 | |
| WPI_850-50-100 | | | | | | | | | |
| CEW-SESO- | 5 | 0 | 90 | 5 | 0 | 0 | 0 | 0.005689 | |
| WPI_900-50-50 | | | | | | | | | |
| CEW-SITO- | 10 | 0 | 70 | 20 | 0 | 0 | 0 | 0.005242 | |
| WPI_700-200-100 | | | | | | | | | |
| CEW-T85- | 10 | 0 | 75 | 15 | 0 | 0 | 0 | 0.01291 | |
| WPI_750-150-100 | | | | | | | | | |
| CEW-WPI- | 10 | 70 | 20 | 0 | 0 | 0 | 0 | | |
| TOLE_200-100- | | | | | | | | | |
| 700 | | | | | | | | | |
| CHILO-GENI- | 10 | 0 | 2 | 0 | 0 | 0 | 88 | | |
| WPI_18-2-100 | | | | | | | | | |
| CHILO-WPI_12- | 10 | 0 | 1 | 0 | 0 | 0 | 89 | | |
| 100 | | | | | | | | | |
| CITREM- | 10 | 0 | 75 | 0 | 15 | 0 | 0 | | |
| CARNW- | | | | | | | | | |
| WPI_750-150-100 | | | | | | | | | |
| COCOW-EC:100- | 10 | 0 | 75 | 0 | 15 | 0 | 0 | 0.005566 | |
| WPI_750-150-100 | | | | | | | | | |
| COCOW-EC:100- | 5 | 0 | 80 | 0 | 15 | 0 | 0 | 0.00449 | |
| WPI_800-150-50 | | | | | | | | | |
| COCOW-EC:100- | 10 | 0 | 85 | 0 | 5 | 0 | 0 | 0.00823 | |
| WPI_850-50-100 | | | | | | | | | |
| COCOW-EC:100- | 5 | 0 | 90 | 5 | 0 | 0 | 0 | 0.02678 | |
| WPI_900-50-50 | | | | | | | | | |
| COCOW-SESO- | 10 | 0 | 85 | 5 | 0 | 0 | 0 | | |
| WPI_850-50-100 | | | | | | | | | |
| COCOW-SESO- | 5 | 0 | 90 | 5 | 0 | 0 | 0 | 0.06061 | |
| WPI_900-50-50 | | | | | | | | | |
| DTPS-T85- | 10 | 0 | 80 | 2 | 0 | 0 | 0 | 0.01874 | |
| WPI_800-20-100 | | | | | | | | | |
| EC:22-WPI- | 10 | 70 | 0 | 0 | 20 | 0 | 0 | 0.003922 | |
| OLEA_200-100- | | | | | | | | | |
| 700 | | | | | | | | | |
| EC:100-SIO2- | 20 | 6 | 0 | 0 | 15 | 5 | 0 | 0.00002603 | |
| WPI-OLEA_150- | | | | | | | | | |
| 50-200-60 | | | | | | | | | |
| EC:100-WPI- | 10 | 70 | 20 | 0 | 0 | 0 | 0 | | |
| GMO_200-100- | | | | | | | | | |
| 700 | | | | | | | | | |
| EC:100-WPI- | 10 | 80 | 0 | 0 | 10 | 0 | 0 | 0.00373 | |
| OLEA_100-100- | | | | | | | | | |
| 800 | | | | | | | | | |
| EC:100-WPI- | 10 | 75 | 0 | 0 | 15 | 0 | 0 | 0.000363 | |
| OLEA_150-100- | | | | | | | | | |
| 750 | | | | | | | | | |
| EC:100-WPI- | 10 | 70 | 20 | 0 | 0 | 0 | 0 | | |
| OLEA_200-100- | | | | | | | | | |
| 700 | | | | | | | | | |
| EC:100-WPI- | 20 | 60 | 0 | 0 | 20 | 0 | 0 | 0.000001753 | 0.0001269 |
| OLEA_200-200- | | | | | | | | | |
| 600 | | | | | | | | | |
| EC:100-WPI- | 25 | 55 | 0 | 0 | 20 | 0 | 0 | 0.000001917 | 0.0001477 |
| OLEA_200-250- | | | | | | | | | |
| 550 | | | | | | | | | |
| EC:100-WPI- | 30 | 50 | 0 | 0 | 20 | 0 | 0 | 0.000002954 | 0.0002068 |
| OLEA_200-300- | | | | | | | | | |
| 500 | | | | | | | | | |
| EC:100-WPI- | 10 | 65 | 0 | 0 | 25 | 0 | 0 | 0.000001192 | |
| OLEA_250-100- | | | | | | | | | |
| 650 | | | | | | | | | |
| EC:100-WPI- | 10 | 70 | 20 | 0 | 0 | 0 | 0 | | |
| TOLE_200-100- | | | | | | | | | |
| 700 | | | | | | | | | |
| EC:300-WPI- | 10 | 70 | 0 | 0 | 20 | 0 | 0 | | |
| OLEA_200-100- | | | | | | | | | |
| 700 | | | | | | | | | |
| GMO-EC:100- | 10 | 70 | 0 | 5 | 15 | 0 | 0 | 0.02903 | 0.00001047 |
| WPI-OLEA_50- | | | | | | | | | |
| 150-100-700 | | | | | | | | | |
| GMS-EC:100- | 10 | 70 | 0 | 5 | 15 | 0 | 0 | 0.00004461 | 0.00004832 |
| WPI-OLEA_50- | | | | | | | | | |
| 150-100-700 | | | | | | | | | |
| K188-WPI- | 10 | 65 | 25 | 0 | 0 | 0 | 0 | 0.01931 | |
| OLEA_250-100- | | | | | | | | | |
| 650 | | | | | | | | | |
| PEG:PPG-WPI- | 10 | 65 | 25 | 0 | 0 | 0 | 0 | 0.03245 | 0.000387 |
| OLEA_250-100- | | | | | | | | | |
| 650 | | | | | | | | | |
| PEG:PPG-WPI- | 10 | 60 | 30 | 0 | 0 | 0 | 0 | 0.02357 | 0.0005404 |
| OLEA_300-100- | | | | | | | | | |
| 600 | | | | | | | | | |
| RBW-EC:100- | 10 | 70 | 5 | 0 | 15 | 0 | 0 | 0.0002656 | |
| WPI-OLEA_50- | | | | | | | | | |
| 150-100-700 | | | | | | | | | |
| RBW-WPI- | 10 | 80 | 10 | 0 | 0 | 0 | 0 | 0.0001842 | |
| OLEA_100-100- | | | | | | | | | |
| 800 | | | | | | | | | |
| RBW-WPI- | 10 | 70 | 20 | 0 | 0 | 0 | 0 | | |
| OLEA_200-100- | | | | | | | | | |
| 700 | | | | | | | | | |
| RBW-WPI- | 20 | 60 | 20 | 0 | 0 | 0 | 0 | 0.0001799 | |
| OLEA_200-200- | | | | | | | | | |
| 600 | | | | | | | | | |
| RBW-WPI- | 30 | 50 | 20 | 0 | 0 | 0 | 0 | 0.0002597 | |
| OLEA_200-300- | | | | | | | | | |
| 500 | | | | | | | | | |
| RBW-WPI- | 10 | 65 | 25 | 0 | 0 | 0 | 0 | 0.002921 | |
| OLEA_250-100- | | | | | | | | | |
| 650 | | | | | | | | | |
| SESO-LEC- | 5 | 0 | 75 | 15 | 5 | 0 | 0 | 0.003104 | |
| EC:100-WPI_750- | | | | | | | | | |
| 150-50-50 | | | | | | | | | |
| SIO2-WPI- | 10 | 85 | 0 | 0 | 0 | 5 | 0 | 7.769E−07 | |
| OLEA_50-100-850 | | | | | | | | | |
| SiO2-WPI- | 10 | 83 | 8 | 0 | 0 | 0 | 0 | 0.06679 | |
| OLEA_75-100-825 | | | | | | | | | |
| SITO-ORY- | 10 | 70 | 6 | 4 | 10 | 0 | 0 | 0.0004163 | 0.000007759 |
| EC:100-WPI- | | | | | | | | | |
| OLEA_60-40-100- | | | | | | | | | |
| 100-700 | | | | | | | | | |
| SITO-ORY-WPI- | 10 | 80 | 4 | 6 | 0 | 0 | 0 | 0.03781 | |
| OLEA_40-60-100- | | | | | | | | | |
| 800 | | | | | | | | | |
| SITO-ORY-WPI- | 10 | 80 | 6 | 4 | 0 | 0 | 0 | 0.00333 | |
| OLEA_60-40-100- | | | | | | | | | |
| 800 | | | | | | | | | |
| SITO-ORY-WPI- | 10 | 70 | 8 | 12 | 0 | 0 | 0 | 0.00005237 | |
| OLEA_80-120- | | | | | | | | | |
| 100-700 | | | | | | | | | |
| SITO-ORY-WPI- | 10 | 75 | 9 | 6 | 0 | 0 | 0 | 0.003053 | |
| OLEA_90-60-100- | | | | | | | | | |
| 750 | | | | | | | | | |
| SITO-ORY-WPI- | 10 | 70 | 12 | 8 | 0 | 0 | 0 | | 0.000002916 |
| OLEA_120-80- | | | | | | | | | |
| 100-700 | | | | | | | | | |
| SOYW-GEL50- | 10 | 0 | 75 | 15 | 0 | 0 | 0 | 0.03505 | |
| WPI_750-150-100 | | | | | | | | | |
| SOYW-LEC- | 5 | 0 | 80 | 15 | 0 | 0 | 0 | 0.01152 | |
| WPI_800-150-50 | | | | | | | | | |
| SOYW-LEC- | 5 | 0 | 90 | 5 | 0 | 0 | 0 | 0.02226 | |
| WPI_900-50-50 | | | | | | | | | |
| SOYW-SESO- | 5 | 0 | 90 | 5 | 0 | 0 | 0 | 0.00208 | |
| WPI_900-50-50 | | | | | | | | | |
| SOYW-T85- | 10 | 0 | 80 | 5 | 5 | 0 | 0 | 0.02188 | |
| EC:100-WPI_800- | | | | | | | | | |
| 50-50-100 | | | | | | | | | |
| SOYW-T85- | 10 | 0 | 85 | 5 | 0 | 0 | 0 | 0.003392 | |
| WPI_850-50-100 | | | | | | | | | |
| SOYW-WPI- | 10 | 75 | 15 | 0 | 0 | 0 | 0 | 0.1666 | |
| OLEA_150-100- | | | | | | | | | |
| 750 | | | | | | | | | |
| SP60-EC:100- | 10 | 70 | 0 | 5 | 15 | 0 | 0 | 0.00009632 | 0.00002699 |
| WPI-OLEA_50- | | | | | | | | | |
| 150-100-700 | | | | | | | | | |
| SP60-WPI- | 10 | 70 | 0 | 20 | 0 | 0 | 0 | | |
| OLEA_200-100- | 10 | 70 | 20 | 0 | 0 | 0 | 0 | 0.02005 | |
| 700 | | | | | | | | | |
| TSTE-EC:100- | 10 | 0 | 85 | 0 | 5 | 0 | 0 | 0.01078 | |
| WPI_850-50-100 | | | | | | | | | |
| WPI_1000 | 100 | 0 | 0 | 0 | 0 | 0 | 0 | 0.5559 | |

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

1. A formulated tastant composition comprising:
a carrier component; and
a payload component comprising at least one taste modulator,
wherein the payload component is encapsulated in the carrier component, and
wherein the at least one taste modulator is Clostridium perfringens, verapamil, EGTA, EDTA, sodium caprate, salcaprozate sodium, collagenase, dispase, elastase, heparitinase, chondroitinase, hyaluronidase, lysozyme, or a combination thereof.

2. The composition of claim 1, wherein the at least one taste modulator confers at least one nutritional benefit when the composition is ingested by an animal.

3. The composition of claim 2, wherein the at least one taste modulator enhances a taste experienced by the animal.

4. The composition of claim 1, wherein the at least one taste modulator reduces an amount of salt, sugar, fat, or a combination thereof, in a food product or beverage product in which the composition is embedded or incorporated.

5. The composition of claim 1, wherein the at least one taste modulator reduces an amount of food and/or beverage ingested by an animal following ingestion of the composition.

6. The composition of claim 2, wherein the at least one nutritional benefit comprises enhancing passage of the payload component through a selective barrier in the animal.

7. The composition of claim 6, wherein the selective barrier comprises an enzymatic component, a physical component, a molecular component, or a combination thereof.

8. The composition of claim 6, wherein the selective barrier comprises ATPases, zonula occludens, chondroitin, heparan sulfates, glycosaminoglycans, proteoglycans, or a combination thereof.

9. The composition of claim 1, wherein the at least one taste modulator promotes binding of the payload component to one or more taste receptors.

10. The composition of claim 1, wherein the at least one taste modulator:
(i) extends a retention time of the payload component in an animal following ingestion of the composition;
(ii) modulates a release rate of the payload component in the animal following ingestion of the composition;
(iii) modulates an adsorption rate of the payload component in the animal following ingestion of the composition;
(iv) modulates an absorption rate of the payload component in the animal following ingestion of the composition;
(v) modulates interaction of the payload component with one or more of a gastrointestinal compartment, tissue, cell, and receptor, or
(vi) a combination thereof.

11. The composition of claim 1, wherein the at least one taste modulator comprises at least one mucoadhesive component.

12. The composition of claim 11, wherein the mucoadhesive component comprises a carbohydrate, a protein, a catechol, a charged polymer, or a combination thereof.

13. The composition of claim 12, wherein the carbohydrate comprises glucose, fructose, mannitol, allulose, sorbitol, xylitol, erythritol, lactitol, galactose, sucrose, maltodextrin, isomaltulose, glycogen, chitosan, guar gum, pullulan, cellulose, dextrins, amylose, amylopectin, pectin, inulin, lignin, chitin, xanthan gum, sodium alginate, potassium alginate, calcium alginate, ammonium alginate, propylene glycol alginate, sodium hyaluronate, potassium hyaluronate, calcium hyaluronate, agar, agarose, carrageenan, raffinose, cellulose acetate, methyl cellulose, ethyl cellulose, cellulose acetate propionate, cellulose acetate butyrate, cellulose acetate succinate, hydroxypropyl methylcellulose, hydroxypropyl cellulose, sodium carboxymethylcellulose, or a combination thereof.

14. The composition of claim 12, wherein the protein comprises pea protein isolate, whey protein isolate, oat protein isolate, soy protein isolate, wheat protein isolate, egg protein isolate, casein, bovine serum albumin, ovalbumin, α-lactalbumin, β-lactoglobulin, collagen, glutanin, gliadin, kefirin, avenin, zein, silk, gelatin, hordein, legumin, or a combination thereof.

15. The composition of claim 12, wherein the catechol comprises L-dopamine, poly(L-dopamine), hydroxytyrosol, catechol, caffeic acid, vanillin, veratraldehyde, eugenol, tannic acid, syringaldehyde, protocatechuic aldehyde, or a combination thereof.

16. The composition of claim 12, wherein the charged polymer comprises an anionic mucoadhesive polymer.

17. The composition of claim 16, wherein the anionic mucoadhesive polymer comprises poly(acrylic acid), poly(methacrylic acid), poly(glycerol citrate), or a combination thereof.

18. The composition of claim 12, wherein the charged polymer comprises a cationic mucoadhesive polymer.

19. The composition of claim 18, wherein the cationic mucoadhesive polymer comprises poly(ethyleneimine), trimethylchitosan, poly(L-arginine), or a combination thereof.
